(19) United States
(12) Patent Application Publication
(10) Pub. No.: US 2012/0143775 A1
(43) Pub. Date: Jun. 7, 2012

(54) METHOD FOR FACILITATING THE ORDERING, COMPLETION AND DELIVERY OF REAL ESTATE APPRAISALS

(76) Inventor: Ronald Stickelman, Fairborn, OH (US)

(21) Appl. No.: 13/152,375

(22) Filed: Jun. 3, 2011

Related U.S. Application Data
(63) Continuation of application No. 11/888,231, filed on Jul. 31, 2007, now abandoned.
(60) Provisional application No. 60/834,442, filed on Jul. 31, 2006.

(51) Int. Cl. G06Q 10/00

(52) U.S. Cl. 705/306

(57) ABSTRACT

The instant application provides a server that facilitates property valuations. The server is capable of networked communications with a plurality of users and includes program code to perform various steps. The server also includes a plurality of products, each having a respective predefined report format. The steps include accepting order-related data from a client. The order-related data is used in combination with a decision matrix to generate an order. The order a first product. The order is then submitted to the client, and in response to the client accepting the order, the order is assigned to at least one valuation expert from a database of valuation experts. The program code provides the valuation expert a user interface to populate data into a plurality of fields within a first report format that corresponds to the first product. Data from the valuation expert is accepted in accordance with the first report format to generate a first report, and the first report is submitted to the client. The data relating to the first report is stored in a portfolio database that is accessible to the client and searchable by the client.

### CROSS-REFERENCE TO RELATED APPLICATIONS

This application claims the benefit of U.S. patent application Ser. No. 11/888,231 filed Jul. 31, 2007, and of U.S. Provisional Application 60/834,442 filed on Jul. 31, 2006, the disclosures of which are both hereby incorporated by reference in their entirety.

### FIELD OF THE INVENTION

The present invention relates generally to property valuations. More particularly, the present invention discloses a method and related system for facilitating transactions between valuation experts and those who need property valuations.

### BACKGROUND OF THE INVENTION

As heavily regulated businesses, one of the major challenges facing banks in the context of real estate valuations for secured transactions is the balancing act between ensuring that the bank remains compliant with all requirements imposed by any one of several regulatory agencies, while also keeping costs and transaction times down. However, due to the varying complexities of the transactions, there is no “one size fits all” valuation product.

Existing valuation products may be selected based upon the financial institution's corporate knowledge of those products, their proper application and the perception of risk associated with the real estate transaction. The financial institution, however, typically does not have the time or expertise to properly determine the complexity or uniqueness of the real estate involved, nor the skill of the appraiser assigned to evaluate the property. Hence, the financial institution's perception of risk may be skewed. Further complicating matters is the fact that the regulatory agencies may, from time to time, change their reporting requirements, which can have the effect of relaxing or tightening the appraisal requirements.

It would therefore be highly beneficial to provide a method and related system that correctly matched an evaluation product to a secured transaction and the underlying real estate, while also ensuring, for example, regulatory compliance of the valuation.

### SUMMARY OF THE INVENTION

The present invention discloses a method and related system that facilitates the ordering, completion and delivery of property valuations, such as real estate appraisals. More particularly, various embodiments disclose a method that may be implemented on a computer-based system, and which permits a customer, such as a bank or other financial institution, to order an appraisal for real estate.

In certain aspects, a method is disclosed for obtaining property valuations. In various embodiments, the method comprises accepting order-related data from a client. The order-related data is used to generate an order, in which the order is selects at least a first product from a plurality of products having respective predefined report formats. The order is submitted to the client, and in response to the client accepting the order the order is assigned to at least one valuation expert. Valuation-related data is received from the valuation expert in accordance with a first report format that corresponds to the first product so as to generate a first report. The first report is then submitted to the client. Finally, data related to the first report is stored in a portfolio database that is accessible to the client and searchable by the client.

The first report format may comprise a plurality of fields to hold data, and in certain embodiment the method further comprises identifying at least one field of significance from the plurality of fields, comparing data in the at least one field of interest to at least one tolerance value, and setting a flag viewable by the client according to the comparison.

In preferred embodiments, each of the predefined report formats comprises a respective predefined scope of work field. In some of these embodiments, each of the predefined report formats also comprises an intended use field, and the method further comprises populating the intended use field in the first report format according to at least the order-related data.

Certain embodiments permit the client to decline the order in favor of another product. In these embodiments the method further comprises, in response to the client declining the order, presenting the client with at least a portion of the other products, and accepting as the order a second product selected by the client. In some of these embodiments, a scope of work field within the second product format is populated according to a predefined format for the second product, and an intended use field within the second product format is populated according to at least the order-related data.

Various embodiments also permit the monitoring of the status of an order. In such embodiments, the method may further include accepting status information from the valuation expert and compiling a corresponding status log for the first report. In certain embodiments, the client may be an institution comprising first users and second users, and the method may further include granting first users full read access to the status log, while denying second users read access to information in the status log that identifies the valuation expert.

In other embodiments, the method further comprises permitting the client to perform a database query of the portfolio database, permitting the client to modify decision-related data, and utilizing the order-related data and the decision-related data to generate the order.

In another aspect, as server is disclosed for facilitating property valuations. The server is capable of networked communications with a plurality of users and includes program code to perform various steps. The server also includes a plurality of products, each having a respective predefined report format. The steps include accepting order-related data from a client. The order-related data is used in combination with a decision matrix to generate an order. The order selects at least a first product. The order is then submitted to the client, and in response to the client accepting the order, the order is assigned to at least one valuation expert from a database of valuation experts. The program code provides the valuation expert a user interface to populate data into a plurality of fields within a first report format that corresponds to the first product. Data from the valuation expert is accepted in accordance with the first report format to generate a first report, and the first report is submitted to the client. Finally, the data relating to the first report is stored in a portfolio database that is accessible to the client and searchable by the client.

In certain embodiments, the server may perform an automated review of the first report. In these embodiments, the program code further identifies at least one field of significance from the plurality of fields, compares data in the at least one field of interest to at least one tolerance value, and sets a flag viewable by the client according to the comparison. In some of these embodiments, the program code provides a user interface that permits the client to change the at least one tolerance value.

In various embodiments, each of the predefined report formats comprises a respective predefined scope of work field. In certain of these embodiments, each of the predefined report formats also comprises an intended use field, and the program code further performs populates the intended use field in the first report format according to at least the order-related data.

In some embodiments, the server permits the client to decline an order in favor of another that the client prefers. In these embodiments, in response to the client declining the order, the program code presents the client with a user interface for selecting at least a portion of the other products, and accepts as the order a second product selected by the client. In some of these embodiments, the program code may populate the scope of work field within the second product format according to the predefined format for the second product, and may populate the intended use field within the second product format according to at least the order-related data.

In certain preferred embodiments, the program code further provides a user interface to change the respective predefined formats for the scope of work fields of each product. This user interface may be accessible by the manager of the server, the client or both.

In other embodiments, the server permits the client to track the status of an order. In these embodiments, the program code accepts status information from the valuation expert for the order and stores the status information in a corresponding status log for the first report. The status log may be viewed by the client. In some of these embodiments, the client may be an institution comprising first users and second users, and the program code grants first users full read access to the status log, while denying second users read access to information in the status log that identifies the valuation expert.

In certain advantageous embodiments, the client may modify the decision matrix based upon information gleaned from the portfolio database so as to provide macro-management of valuation orders. In these embodiments, the program code further provides a user interface that enables the client to perform a database query of the portfolio database, and provides a user interface that enables the client to modify the decision matrix.

In other embodiments, the server permits the valuation expert to decline an order an explain why he or she is declining the order. In these embodiments, the program code further provides a user interface enabling the valuation expert to accept or decline the order, provides a user interface enabling the valuation expert to offer at least a reason for declining the order, and, in response to the valuation expert declining the order, submits the reasons for declining the order to the client. The client may then change the order, or submit the order to a new valuation expert.

### BRIEF DESCRIPTION OF THE DRAWINGS

FIG. 1 is a flow chart of an embodiment method.

FIG. 2 is a diagram of an embodiment system.

FIG. 3 is a screen shot of a portion of an embodiment host-client interface that enables a client to submit order-related data in a predetermined format to a host.

FIG. 4 is a screen shot presented by an embodiment host system offering to a client details of a suggested product, which the client may accept or decline.

FIG. 5 shows a screen shot of an embodiment interface presented by a host system that permits a client to suggest a new product.

FIGS. 6A-6E show screen shots of an appraiser module within an embodiment host system presenting various interface pages to a valuation expert.

FIG. 7 is a flow chart of an embodiment method that permits a valuation expert and a client to negotiate between themselves details of an order.

FIG. 8 is a screen shot of a page created by an embodiment host system that is used in final product population by a valuation expert.

FIGS. 9A-9N show embodiment interactive forms a valuation expert may use to submit data required of an “Evaluation” report and lock or unlock a report.

FIGS. 10A-10B show user interface screens presented by embodiment host systems that permit a client to make a database query of reports and related data within a portfolio database.

FIG. 11 is a screen shot of hits presented by an embodiment host system to a client in response to a portfolio database query.

FIG. 12 is a block diagram of an embodiment product database.

FIGS. 13A-13E illustrate portions of an embodiment format for an Evaluation report.

FIGS. 14A-14G illustrate portions of an embodiment format for a Restricted Appraisal Product-Commercial report.

FIGS. 15A-15E illustrate portions of an embodiment format for an Evaluation-L report.

FIGS. 16A-16E illustrate portions of an embodiment format for a Restricted Evaluation Appraisal report.

FIGS. 17A-170 illustrate portions of an embodiment format for a Restricted Use Appraisal report.

FIGS. 18A-18Z illustrate portions of an embodiment format for a Summary Appraisal report.

FIGS. 19-27 are screen shots of embodiment user interfaces used to configure various intended use statements.

FIGS. 28A-28B present screen shots of a user interface used to edit the scope of work definitions for each product offered.

FIG. 29 shows an example user interface for the editing of a matrix associated with a specific parameter.

FIG. 30 shows a user interface for the selection and editing of all matrices in an embodiment host system.

FIG. 31 shows an embodiment decision matrix.

FIG. 32 shows an embodiment user interface that may be used to configure aspects of a decision matrix.

FIG. 33A-33V show another embodiment decision matrix.

### DETAILED DESCRIPTION

In the following, the term matrix is used to indicate a logical structure for generating output based upon input. A matrix may be implemented, for example, as a decision tree, in which input data is parsed at each node to determine which branch in the tree to take, and in which the final node in the tree reached contains the output data. Alternatively, a matrix may be implemented as a look-up table, in which one or more input values are used to index into the table to extract the output data. A matrix may also be implemented, for example, by a hash function, by a fuzzy logic system or by any other suitable programming means.

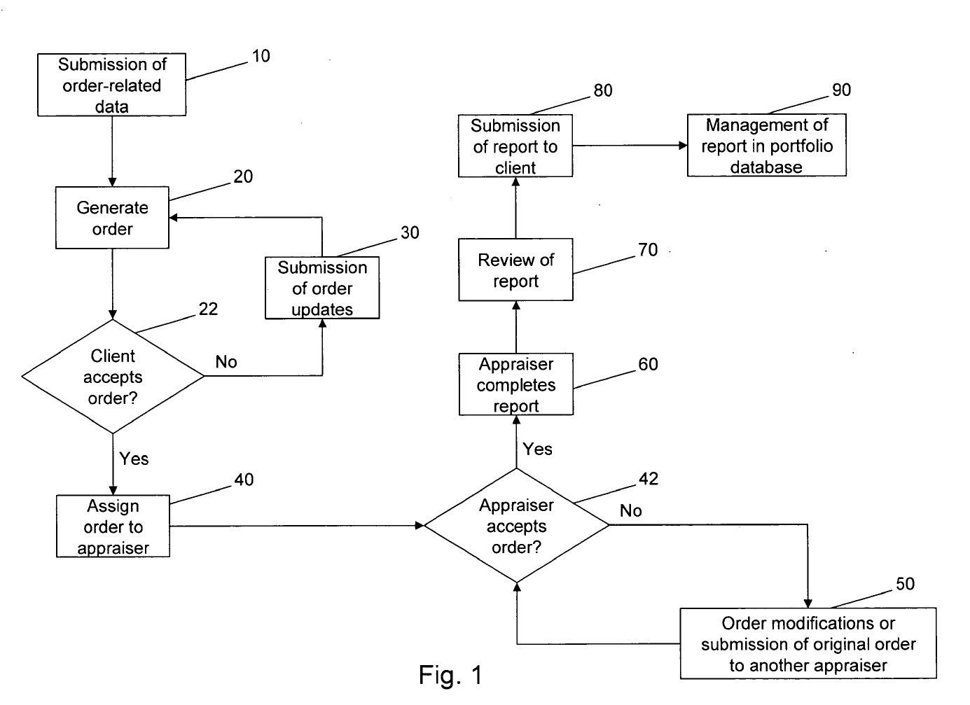

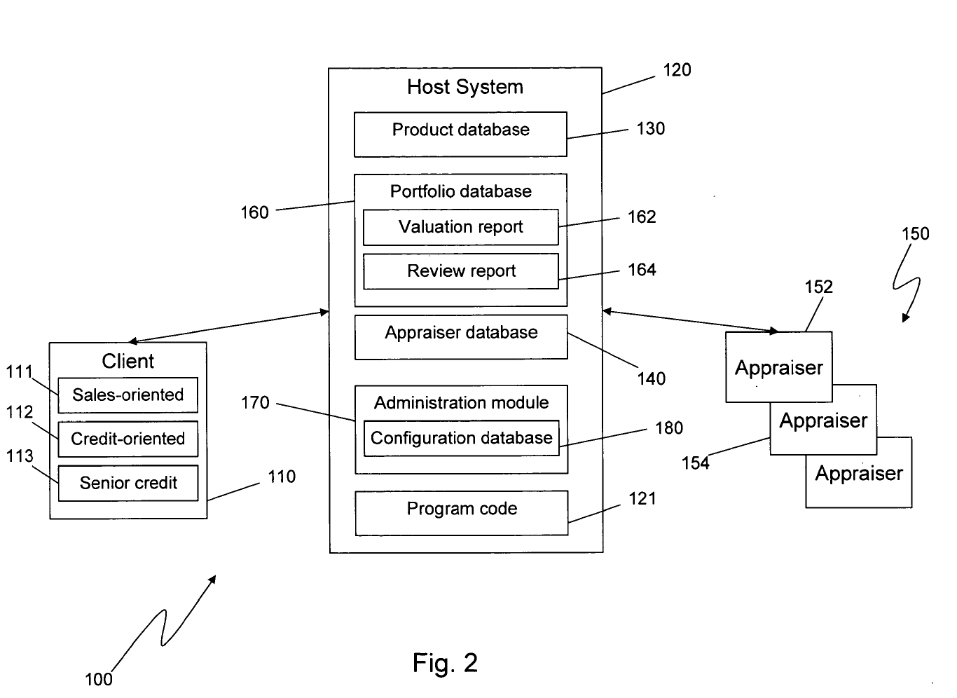

Continuing reference is drawn to FIG. 1 and FIG. 2 throughout the following Detailed Description. FIG. 1 shows a flow chart of an embodiment method. FIG. 2 illustrates an embodiment system 100 that may be used to practice the method shown in FIG. 1. The embodiment depicted in FIG. 1 provides for the selection of an appraisal order based upon information provided by a client; selection of, and subsequent submission to, an appraiser to handle the appraisal order; receipt and delivery of a resulting report from the appraiser back to the client, and the archiving of the report and any subsequently-related information into a portfolio archive. The portfolio archive may be used in the generation of subsequent orders, manage the financial institution's commercial real estate concentration, provide risk analysis and provide for stress testing along with other macro issues. Although FIGS. 1 and 2 make specific reference to but a single client and to only appraisers, it should be understood that the various embodiments are not so limited. Preferred embodiments may handle several clients simultaneously, and interface with not only appraisers but also with other valuation personnel who are competent to perform the requested valuation analysis; although this will typically be an appraiser, it need not be so limited, as will be explained in more detail later. When multiple clients are supported, the host system may be configured to support multiple corresponding databases respective to each client.

A client 110 may be, for example, a bank or other financial institution desiring a valuation document, which may be termed a report, for a piece of property, typically real property. The report will contain a valuation analysis, which may be an appraisal for example, that is used in the performance of a secured transaction. As known, financial institutions may be required by certain regulatory bodies to obtain a valuation analysis of property used to secure a loan. Additionally, for their own loan-approval processes, financial institutions may desire such valuation information. The amount and detail of these analyses and reports may depend, for example, on the requirements imposed externally by any regulatory agencies, and internally by the financial institution's perceived level of risk of the loan, with riskier loans requiring more detailed (and hence costly and time-consuming) analyses and reports.

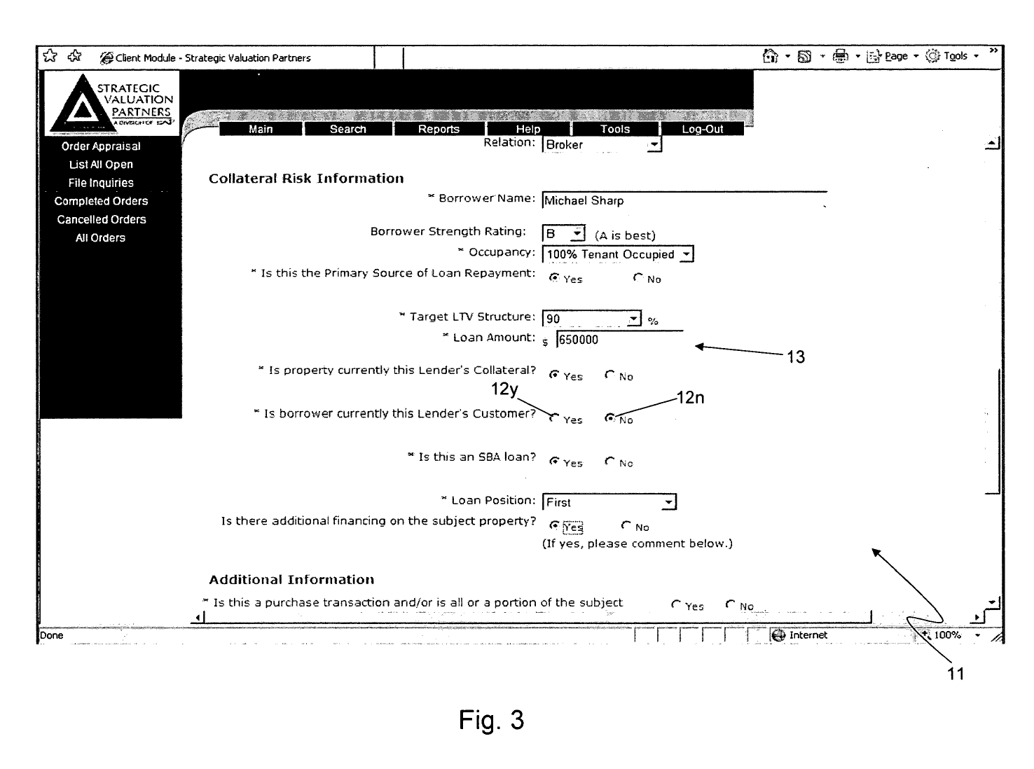

As indicated in step 10, a client 110 desiring a report provides order-related information to a host 120. The order-related data may contain information about the property as known by the client 110, as well as other information that may be useful to determine the type of analyses and reporting to be generated; such information will be discussed in greater detail later. Although submission of this information may be by any means, in certain preferred embodiments the host 120 may be a computer server, and such submission may be performed electronically employing any suitable combination of physical layer, such as Ethernet, and communications protocol, such as HTTP. The client 110 may therefore be a local computer controlled by the actual client, and may identify itself to the host system 120 by way of a logon procedure. A detailed discussion of the construction of such networked systems and applications, typically termed web applications, is beyond the scope of this disclosure, but is well-known in the art. For example, suitable use of the “.NET” programming language, as provided by the Microsoft Corp., may be used to program the host system 120, and thus provide the functionality of the host system 120. FIG. 3, for example, is a screen shot of a portion of an example host-client interface presented on the client computer 110 by the host system 120 that enables the client 110 to submit order-related data to the host system 120 in a predetermined format. The client 110 need not provide all order-related information as prompted by the host-client interface, but only as much as the client 110 then knows. In certain embodiments, so-called “required fields” may be provided, the information requested from which the client 110 must provide; in these embodiments, if the client 110 does not fill in a required field, the order may be placed on hold until the client 110 is able to obtain and provide the required information.

The host may have a plurality of valuation products that the client may select from to obtain a report. Hence, the host system 120 may include a product database 130. The product database 130 may include information about each product that, when combined with the order-related information as provided by the client 110, enables the host 120 to select one of the products from the product database 130 and offer it to the client 110, as indicated by step 20. For example, the products may be characterized by the level of depth and detail of the analysis and resultant report. The client 110, as a lender, may need more detail about the property as the amount of the loan increases. Hence, one of the order-related pieces of information may be the amount of the loan for which the property analysis and report is being generated. This value may be one parameter used to select a product within the product database 130. The selection of a product by the host system 120 will be covered in more detail later. Alternatively, the client 110 itself may specifically select one of the products from the product database 130.

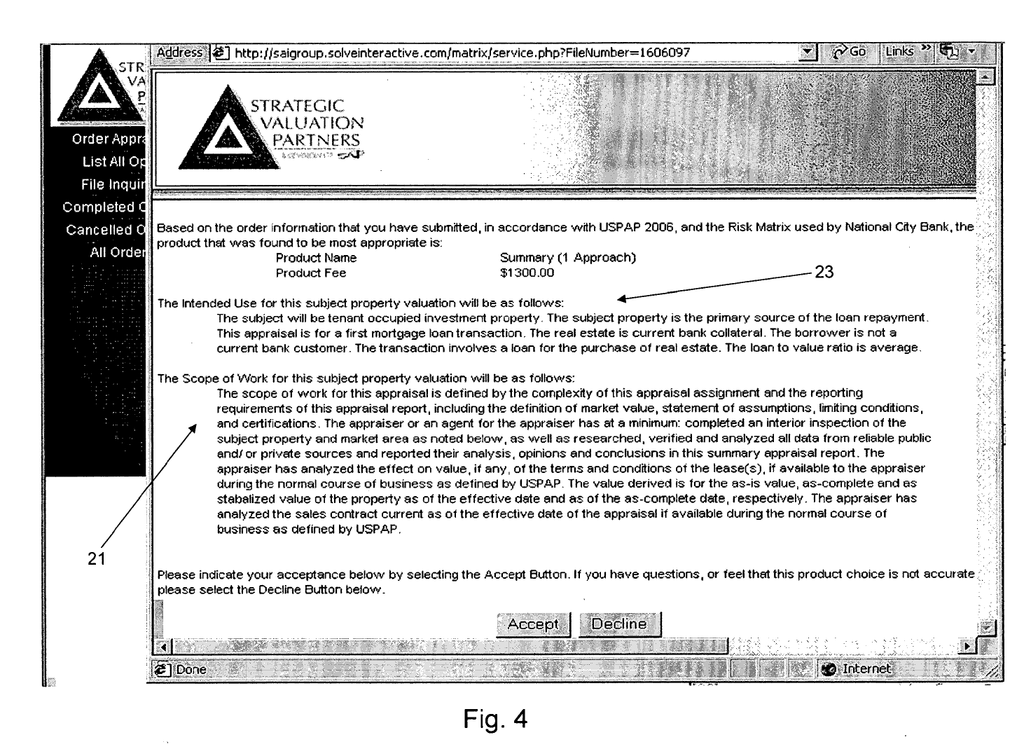

Once a product has been selected and offered to the client 110 to generate an order, then, as indicated in step 22, the client 110 may choose to accept or decline the recommended analysis and reporting type. As shown in FIG. 4, the host system 120 may present to the client 110 details of the order, such as the product name, cost, and property valuation analysis details associated with the product; the host 120 may also present buttons or the like that permit the client 110 to accept or decline the suggested order. If the client 110 declines the order, then step 30 may be performed, in which the order is changed to something that the client 110 finds more suitable. If the client 110 accepts the order, then step 40 is performed, in which the order is assigned to a property valuation expert, such as an appraiser 152. Of course, if the client 110 has manually selected a product, then these steps of accepting or declining a product may not be required, as it could be presumed that a client 110 will not decline a product they have themselves selected. In certain embodiments, the host system 120 employs a decision matrix in the selection and subsequent offering of a product. The details of this decision matrix are covered later. However, in certain preferred embodiments, the decision matrix is designed so as to offer to the client 110 the least expensive product that is regulatory-compliant given the information that the client 110 has submitted to the host system 120, while simultaneously taking into account any potential risk to the client 110.

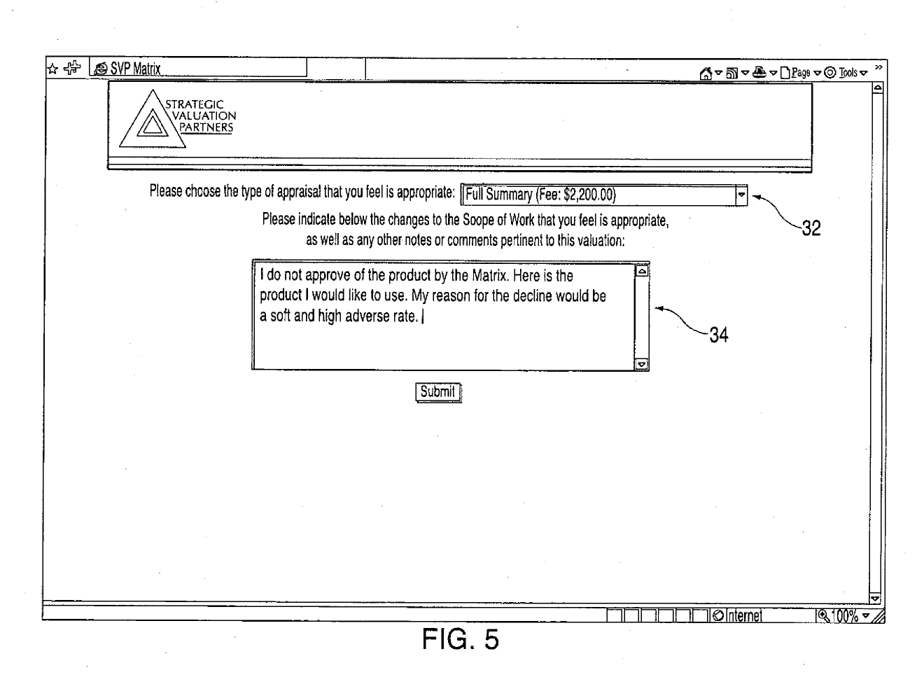

In step 30, when a client has declined an order, the host may permit the client to suggest, for example, another product that the client feels is more acceptable given the property and circumstances attendant to the property, or, in other embodiments, may permit the client to offer suggestions for amending the offered product and so provide something more suitable for the client. Based upon the criteria offered by the client, the host may then return to step 20 to generate a new order and offer this new order to the client. FIG. 5, for example, presents an example screen shot of an interface presented by the host system 120 that permits the client 110 to suggest a new product, by way of drop-down box 32, and further permits the client 110 to indicate why the originally proffered order was deemed unsuitable and provide changes the client 110 feels desirable for the final report, by way of text box 34. The data entered into text box 34 may, for example, be stored in a database related to the order for later review, which is discussed later. The products offered in drop-down box 32 may include, for example, all o-r a portion of all products present within the product database 130.

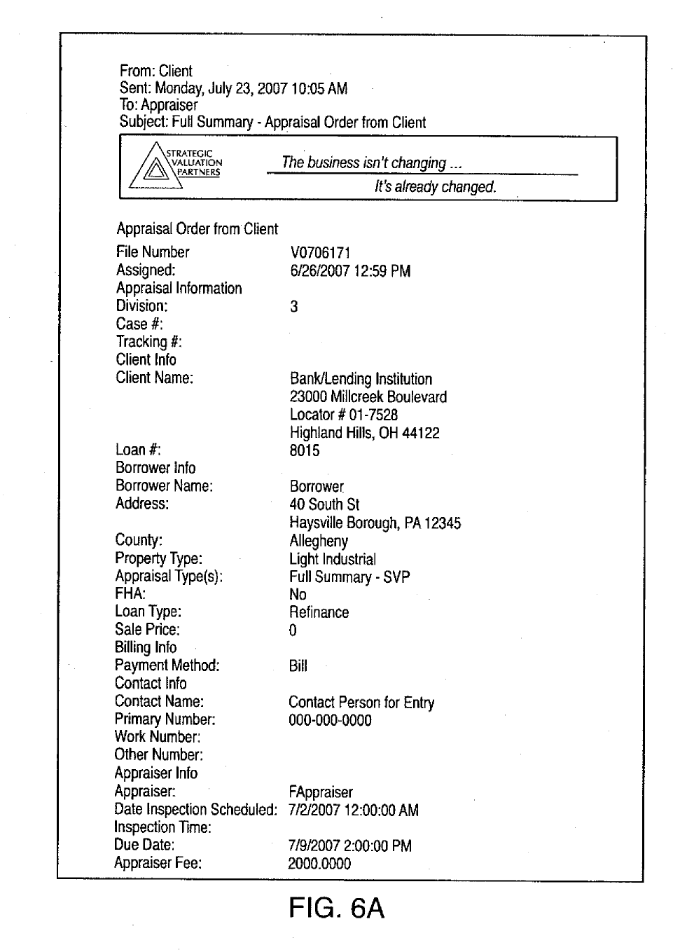

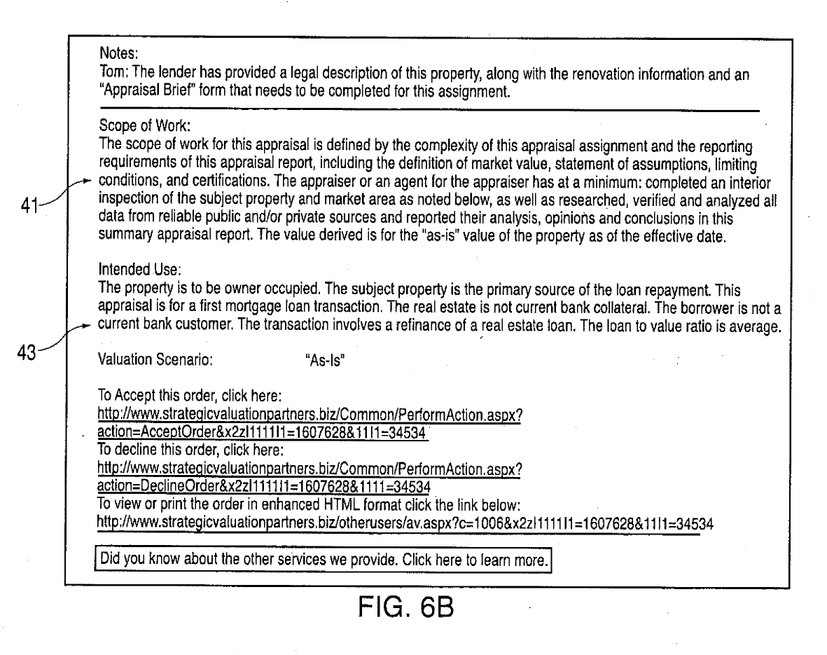

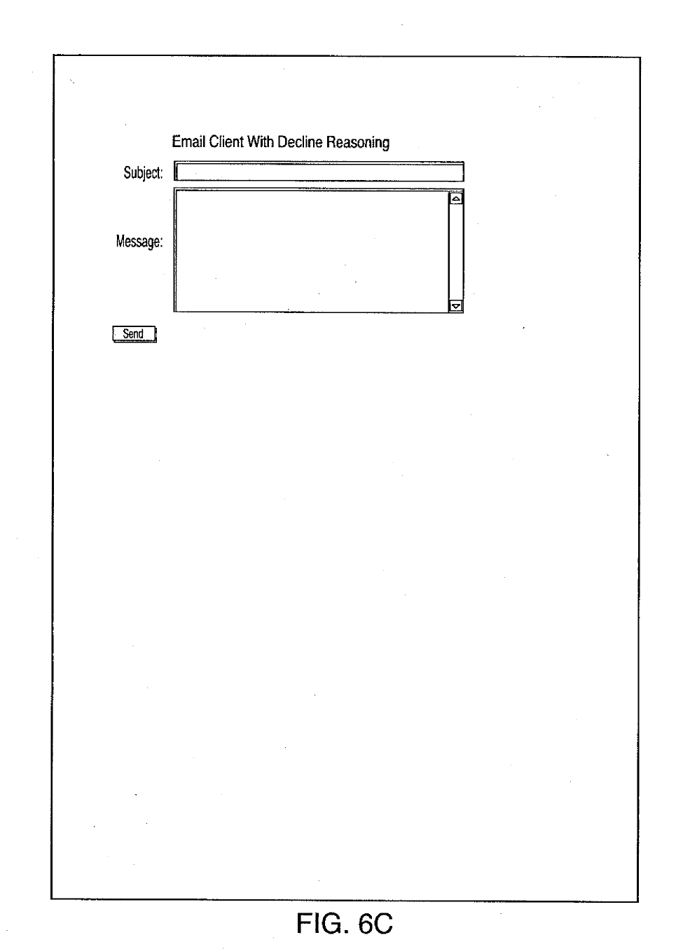

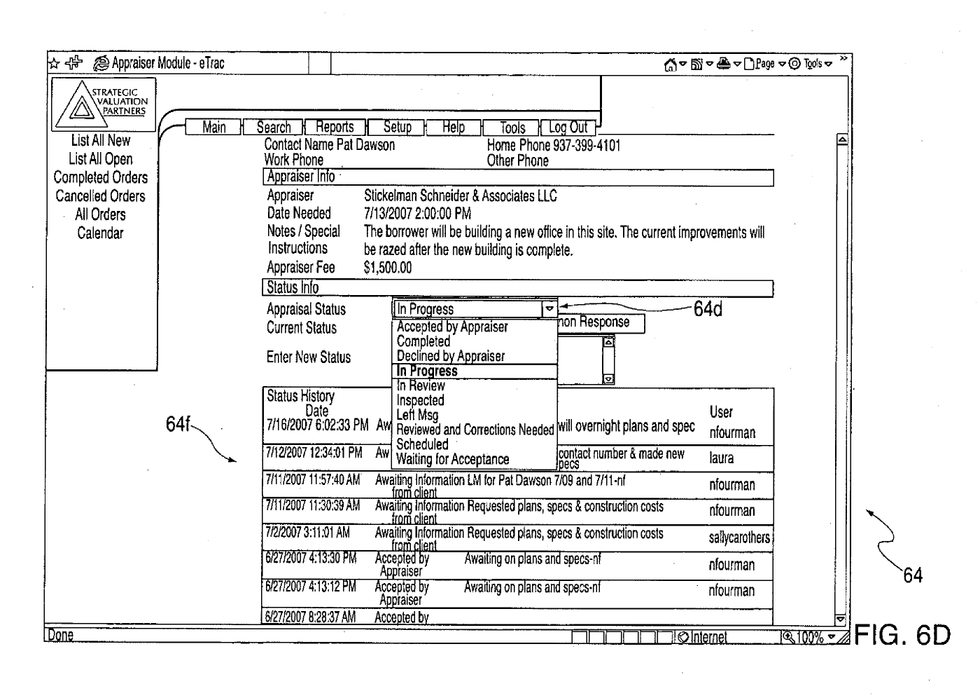

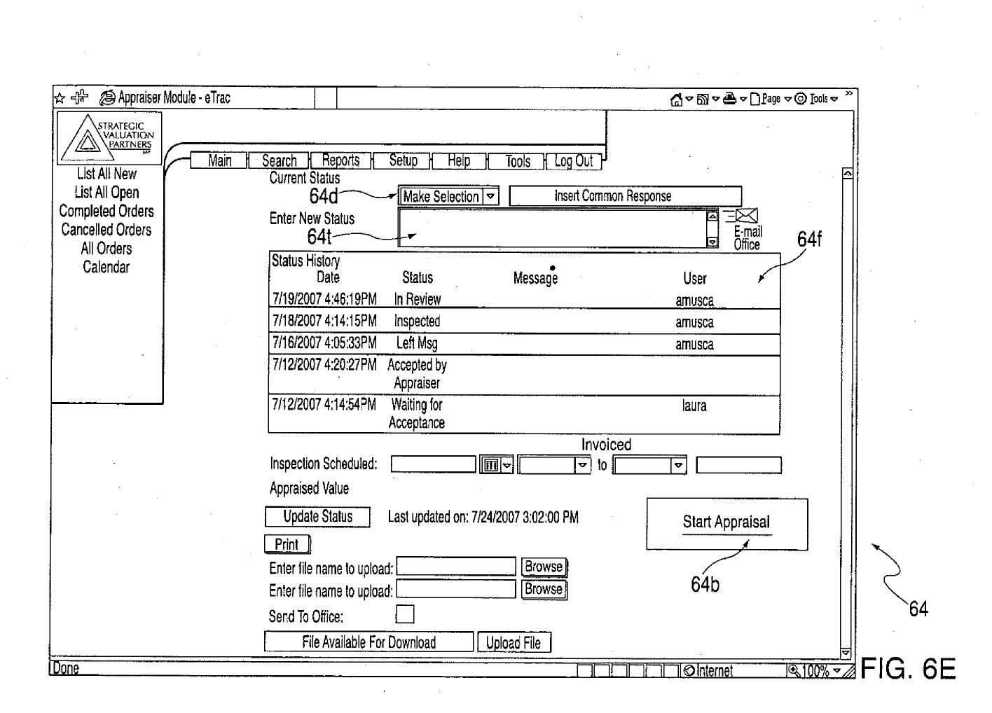

The host may keep track of a plurality of property valuation experts 150 and may assign work to any one or more of these experts 150. For example, the host system 120 may include an appraiser database 140. As previously indicated, for brevity it is appraisers that are explicitly discussed in the following. However, it should be clear that other valuation experts in addition to appraisers may be tracked within the appraiser database 140. The appraiser database 140 may include, for example, the contact and geographical information of an appraiser 152, the expertise the appraiser 152 has with each of the various products in the product database 130 and with different types of property, the years of experience the appraiser 152 has, which may be further sub-divided by the type of work performed, i.e., by property type; the amount the appraiser 152 charges for each of the products within the product database 130 that the appraiser 152 is qualified to handle; the availability of the appraiser 152, and so forth. Using the appraiser database 140 and the characteristics of the product ordered and accepted in steps 20-22, the host system 120 (optionally via the client 110) may select an appraiser 152 and forward the order to the appraiser 152, as indicated in step 40. Any suitable notification system may be employed to inform the appraiser 152 of the order. For example, in certain embodiments, the appraiser 152 is sent an email or presented a webpage with the order information and one or more buttons or links that allow the appraiser 152 to accept or decline the order, which is shown in FIGS. 6A-6B and discussed in more detail later. As with the client 110, the appraiser 152 may be a local computer under the control of an actual appraiser or valuation expert, and in networked communications with the host server 120. The appraiser 152 may identify himself or herself to the host server 120 by way, for example, of a logon procedure, may be identified by the link the appraiser 152 clicks upon, or by any other suitable means.

In various embodiments, the host system 120 may present a user interface that enables each appraiser 152,154 to edit all or a portion of their respective information within the appraiser database 140. For example, the appraiser 152,154 may update information items related to state licenses and certifications, errors and omissions of insurance, cost of services (such as the costs for each respective product in the product database 130), areas of geographic coverage, quality capabilities, availability for assignments, and specific property types that the appraiser 152,154 is unqualified to value. Of course, other information items may be tracked and updated as well. In certain specific embodiments, after the appraiser 152,154 has updated his or her respective profile within the appraiser database 140, the host system 120 sends a notification to the client 110 informing of this change; any suitable means may be used to provide such notification, such as an email message, a notification field within a homepage of the user as managed by the host system 120, or the like. In some of these embodiments, the appraiser database 140 may track certain items that the appraiser 152,154 cannot change or edit, such as average turn-around time (i.e., how long it typically takes the appraiser 152,154 to complete an order—this may be subdivided for each order type); the number of open orders the appraiser 152,154 has (i.e., orders that the appraiser 152,154 has agreed to take but has not yet completed); and the overall quality rating of the appraiser 152,154. This quality rating may be set, for example, by the client 110. Alternatively, the quality rating may be a function of various other items, such as turn-around time and client 110 perception.

In various embodiments, the appraiser database 140 may rank the appraisers 152,154. In certain preferred embodiments, the appraisers 152,154 are ranked according to the following items, which are presented in descending order of importance: 1) location of the subject property, 2) property type; 3) transaction amount; 4) appraiser 152,154 volume capacity; 5) amount of open orders with the appraiser 152,154; 6) the ratio of items 4 and 5; 7) appraiser 152,154 fee for the order type; 8) appraiser 152,154 availability; 9) appraiser 152,154 average turn-around time; 10) appraiser 152,154 overall quality rating. In some embodiments, the host system 120 then presents to the client 110 a list of appraisers 152,154, listed in order by rank, from which the client 110 may select to offer the order to. In other embodiments, the host system 120 may automatically send the order to the highest-ranked appraiser 152,154 that has not already declined the order.

It will be appreciated that the client 110 may actually represent an institutional client, such as a bank or other financial institution, which has numerous employees. Each of these employees may be given a login name and password combination to identify themselves as a representative of the client 110. However, the client 110 may be partitioned into numerous sub-categories, some of which may have access to only portions of the host system 120. For example, the client 110 may have sales-oriented personnel 111. Sales-oriented personnel 111 may include anyone working for the client 110 who is paid because a loan closes. To avoid conflicts of interest, in certain preferred embodiments, sales-oriented personnel 111 are prevented from selecting an appraiser 152,154 when submitting an order. For example, when a sales-oriented user 111 submits an order, the host system 120 may delegate selection of the appraiser 152,154 to a credit-oriented user 112 or to a senior-credit user 113; the host system 120 may send an email to the credit-oriented user 112 requesting that user to login to the host system 120 and select the appraiser 152,154 for the order. Of course, if the host system 120 automatically selects the appraiser 152,154, then this would not be necessary. However, in certain preferred embodiment, sales-oriented users 111 are prevented from any sort of access to the appraiser database 140, either to edit appraiser 152,154 profiles or even to view the appraiser 152,154 profiles. The senior credit user 113 may be considered a “super-user” of the client 110 with respect to client 110 activities on the host system 120. The senior credit user 113 may, for example, be able to change the profiles of the other users 111, 112, such as changing a sales-oriented user 111 to a credit-oriented user 112 and vice versa, or creating new users 11-113. The senior credit user 113 may also indicate to the host system 120 which credit-oriented user 112 is to have authority in the selection of appraisers 152,154, which may be performed through any suitable user interface. A senior credit user 113 may also change the various matrices, discussed later, that are used in the selection of a product, which is denied to the other users 111, 112. Any suitable means may be used within the host system 120 to correlate a user login name and password with a particular client 110, and to a particular sub-class 111-113 within that client 110; such groupings and correlations of users is well-known. Of course, other user groups for the client 110 are also possible, the three indicated 111-113 are simply exemplary.

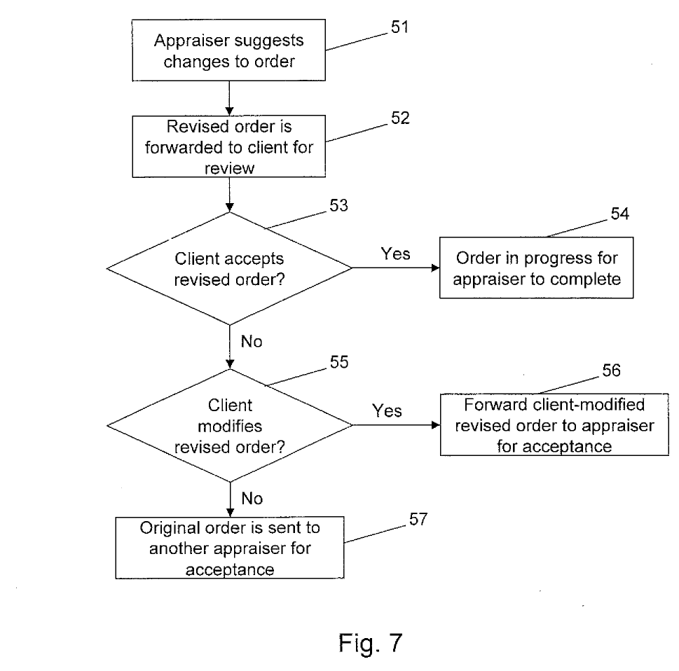

Once an appraiser 152 has been selected, the order is sent to the appraiser 152 for acceptance. An example screen shot is shown in FIGS. 6A-6C, in which the host system 120 presents to the appraiser 152 all of the specifics of the order. As will be discussed in more detail later, the order may include the scope of work 41 (which indicates the type and depth of analysis to be performed), the intended use 43, any extraordinary assumptions, hypothetical conditions, general assumptions, limiting conditions and so forth. A portion, and preferably all, of these terms, conditions and known property data are explicitly presented to the appraiser 152 for consideration, which thereby avoids any potential confusion by the appraiser 152 as to what the client 110 is requesting of the analysis and report. In step 42, the appraiser 152 has the option of accepting or declining the order. The appraiser 152 may have several reasons for declining an order. For example, the appraiser 152 may simply be too busy to accept the order. Or, the appraiser 152 may feel that the specifics of the order cannot be adhered to while still providing a reliable and creditable valuation estimate of the subject property. Hence, step 50 is provided if the appraiser 152 should initially decline the order. More detailed steps of an embodiment method for step 50 are shown in FIG. 7. When the appraiser 152 declines the order, the appraiser 152 may, as indicated in step 51, suggest changes to the order, and the reasons for making such changes, as shown in FIG. 6C. The order, as changed by the appraiser 152, may be termed a revised order. This revised order, and optionally any comments the appraiser 152 has provided, is then forwarded to the client 110 for review, as indicated in step 52. The order may be sent, for example, to the same user of the client 110 who selected the appraiser 152, or who has been delegated the authority in the selection of the appraiser 152. As previously discussed, in some embodiments this may not include, for example, sales-oriented users 111. Upon receiving this revised order and optional commentary, in step 53, the client 110 (via, for example, credit-oriented 112 or senior credit 113 personnel) may choose to accept the revised order as suggested by the appraiser 152, or may decline the appraiser's 152 revised order. If the client 110 accepts the revised order, then, in step 54, the revised order is taken up by the appraiser 152 for completion. However, if the client 110 does not accept the revised order, then the host system 120 may permit the client 110 to make changes to the revised order, as indicated by step 55. The process used by the client 110 to create a client-modified revised order may be analogous to the steps 20-30 used to generate the original order, for example. If the client 110 elects to make changes to the revised order, then, in step 56, the host system 120 forwards this client-modified revised order to the appraiser 152, and the process may return to step 42 of FIG. 1. This has the net effect of providing a platform in which, with the aid of the host system 120, the client 110 and the appraiser 152 may negotiate between themselves the specific terms of the order, or the type of product ordered. It will be appreciated that, in certain embodiments, because all conversation is routed through the host system 120, which may keep the identity of the appraiser 152 secret from, for example, a sales-oriented user 111, any conflict of interest in these transactions can be avoided. Alternatively, if the client 110 does not wish to negotiate the terms of the order with the appraiser 152, then, as indicated in step 57, the host system 120 may revert back to the original order, as originally accepted by the client in step 22, and return to step 40 to select a new appraiser 154 and offer the original order to this newly selected appraiser 154, thereby returning to step 42 with the original order but with the new appraiser 154. The new appraiser 154 may be selected manually, as by a credit-oriented user 112, or automatically by the host system 120 according to rank.

The host system 120 may include an appraiser module that generally handles the user interface between the host system 120 and the valuation experts 150, such as the user interface screens in FIGS. 6A-6C discussed above. The appraiser module may offer a status page to each respective valuation expert 150, which permits that expert 150 to handle his or her respective various reports, request information from the client 110, create a log of the progress of a report being processed, etc. An example status page 64 is shown in FIGS. 6D and 6E. The status page 64 may permit the appraiser 152,154 to select an order currently being processed, and make changes or updates to that order. Specifically, the appraiser 152,154 may make insertions into the log indicating what actions have been taken in the completion of the order, what problems have arisen, documents that have been requested, and the like; this commentary may be stored in the status log and related to the ordered report so that later the appraiser 152,154 or the client 110 may see how the order progressed, such as for quality control purposes.

By way of example, a drop down box 64d may permit the appraiser 152,154 to select from a plurality of predetermined options, which may indicate, for example, the last action the appraiser 152,154 has performed or desires to perform for the order. Text box 64t may be provided that permits the appraiser 152,154 to enter descriptive text related to a new status entry. The appraiser module may keep track of and record each new status entry entered by the appraiser 152,154, and present a log of such entries in a suitable log field 64f. The data related to such a status log may be stored in the appraiser database 140. Hence, it may be, for example, made available to a credit-oriented user 112 while denied to a sales-oriented user 111, using suitable client 110 web interfaces. Of course, this status information may be stored in any suitable database accessible to the host system 120, and is ideally correlated to the particular order with which it is associated. Additionally, it will be understood that a similar set of web pages may be configured for the client 110, enabling the client 110 to view the related status log of each order. The host system 120 may be configured so that sales-oriented personnel 111 or prevented from viewing information in the status log that would betray the identity of the related appraiser 152,154. For example, any appraiser 152,154 identifying information may be redacted from the status log when viewed by sales-oriented personnel 111. The host system 120 may thus provide a complete communications system between the appraiser 152,154 and client 110, and retain a record of all such communications and status changes on each order as a permanent log associated with that order.

Once the negotiations, if any, between the appraiser 152,154 and the client 110 have completed and the appraiser 152,154 has accepted the order, the appraiser 152,154 takes whatever steps are then necessary to determine the value of the property in accordance with the terms of the accepted order; in particular, in accordance with the scope of work 41 and intended use 43 terms of the order. The actual steps performed to generate the property valuation report may vary depending upon the specifics of the order, and the appraiser 152,154 may be required to obtain, analyze and report upon greater or lesser amounts of information depending upon the level of detail demanded within the order, as indicated by the scope of work 41. However, once the appraiser 152,154 has completed the necessary work, in various preferred embodiments the results of that work are presented in a standardized report.

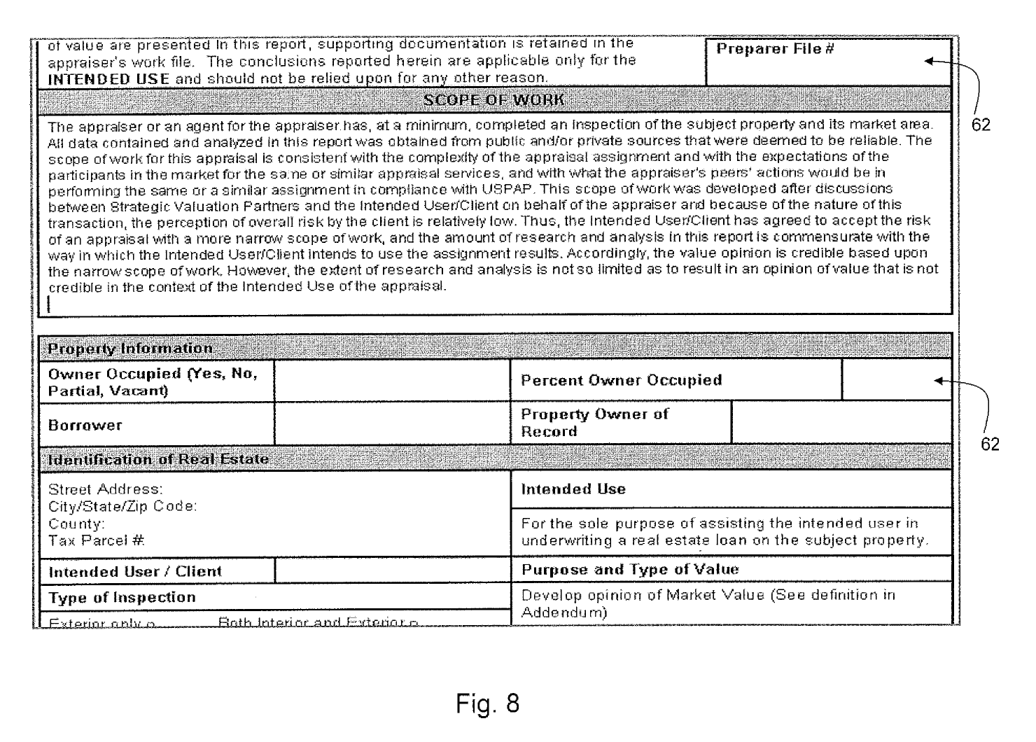

In preferred embodiments, for each product within the product database 130 there exists a corresponding report format, which will be presented in more detail later. This report format is used when generating and presenting the analysis and results corresponding to that ordered product. In this manner, regardless of which of the property valuation experts 150 performs the order, the client 110 is always provided a standardized report according to the specific product ordered. Accordingly, to perform step 60, the appraiser module of the host system 120 may present to the appraiser 152,154 a web-based interface which the appraiser 152,154 may use to enter in the data required of the appropriate standardized report. This may be termed final product population, and the final product population interface page may be entered, for example, from the status page 64 by activating a button or link 64b, as shown in FIG. 6E. This web-based interface may require the appraiser 152,154 to address and comment on required regulatory and client 110 valuation analyses and reporting, thus providing the assurance that these issues are addresses as opposed to giving the appraiser 152,154 the option of not addressing them. That is, the fields within the web-based interface may include required fields that the appraiser 152,154 must complete for the host system 120 to accept the report as completed. A screen shot presenting a portion of a page used in final product population is shown in FIG. 8. As shown in FIG. 8, the host system 120 may cause the local computer of the appraiser 152,154 to present one or several pages that have fields 62 that may be filled in by the appraiser 152,154. The host system 120 may also automatically fill in some of the fields 62 that are already known by the host system 120, either by way of the order itself, or from data within any of the databases present on the host system 120. For example, the host system 120 may fill in the fields corresponding to the scope of work, identification of property, intended use and so forth based upon the order as generated in steps 10-50. Other fields 62 are blank and the appraiser 152,154 then fills them in with the appropriate information.

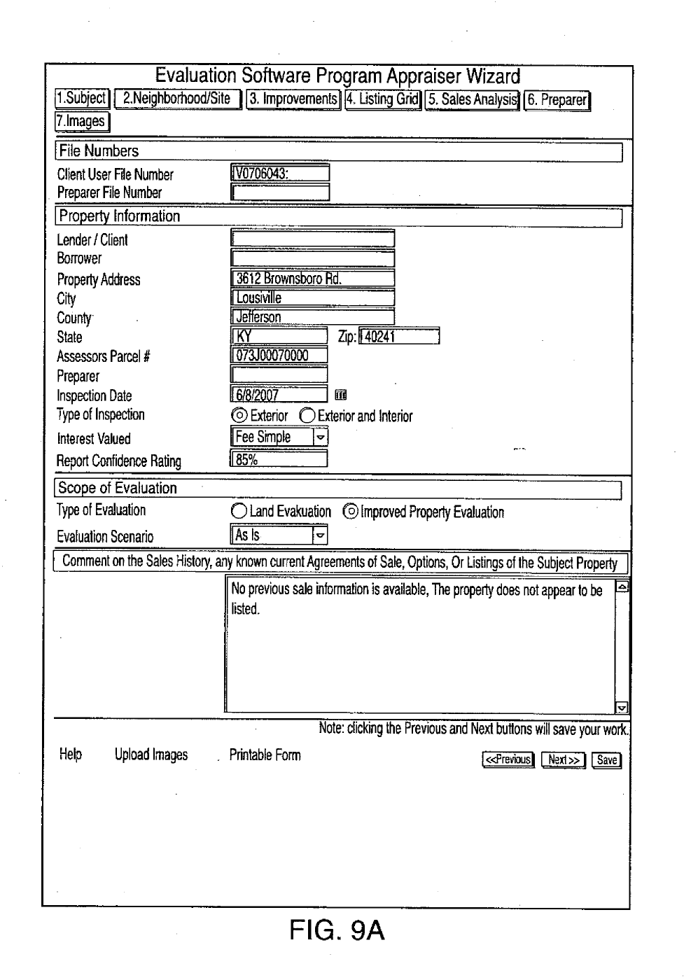

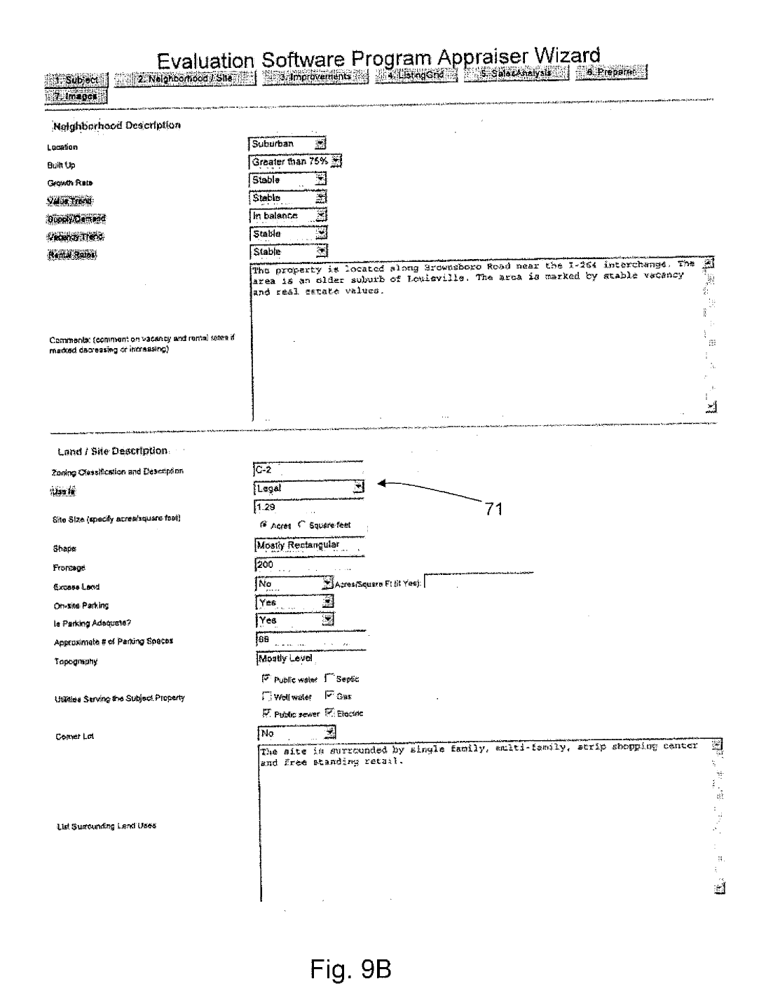

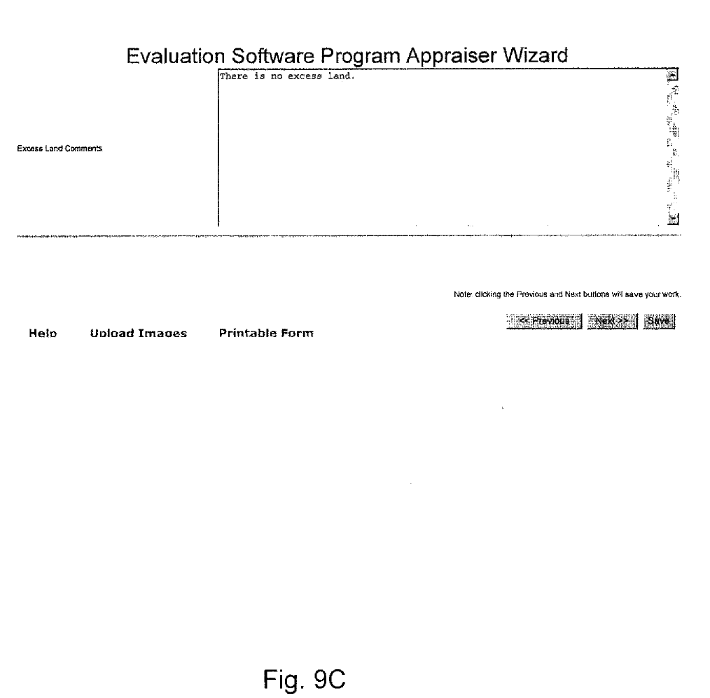

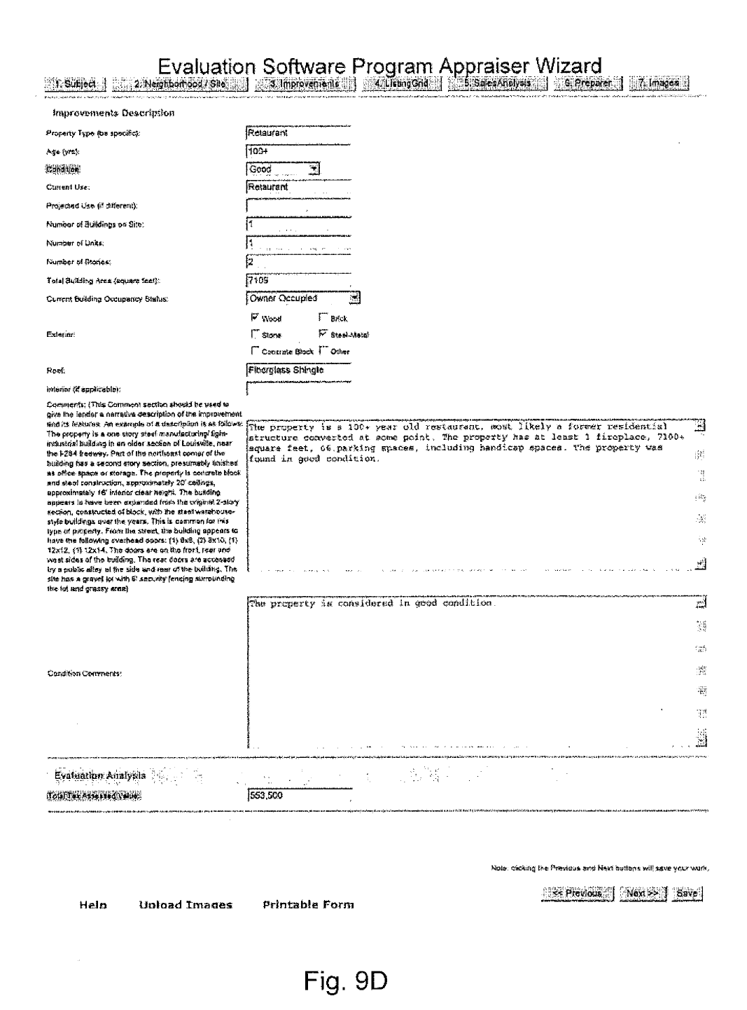

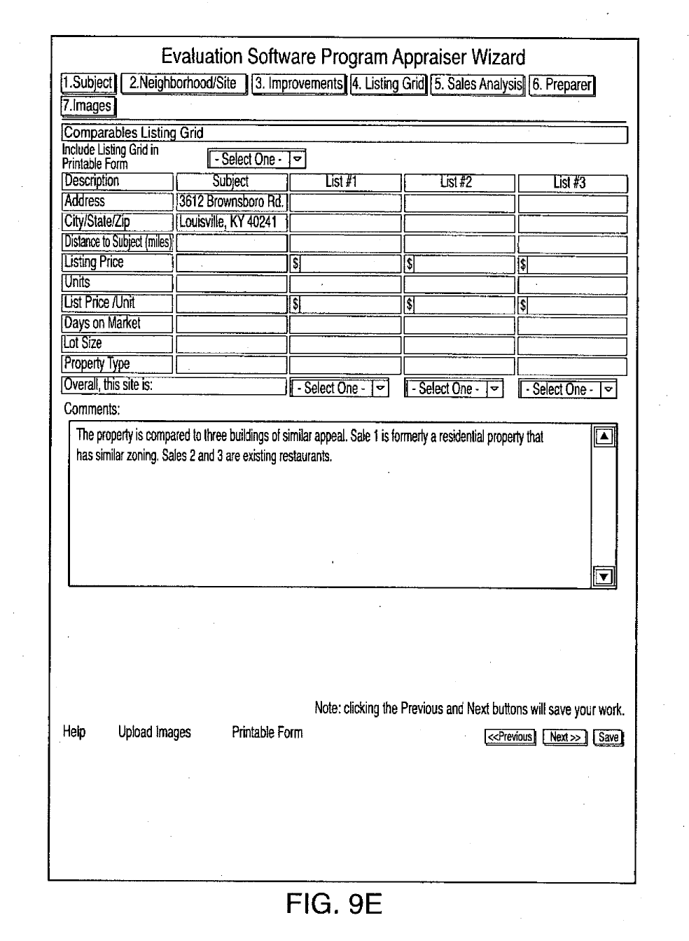

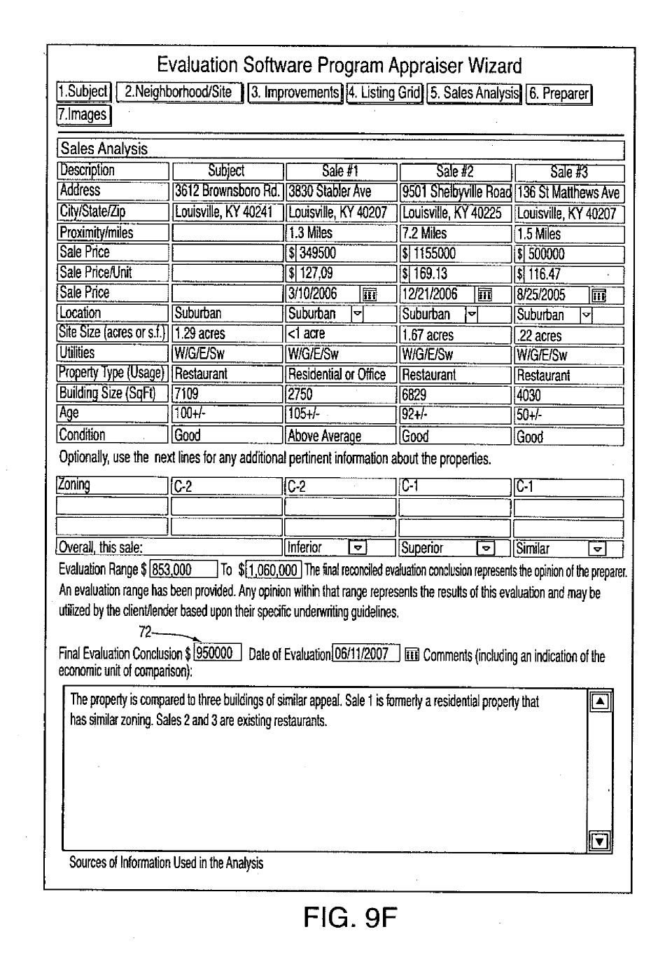

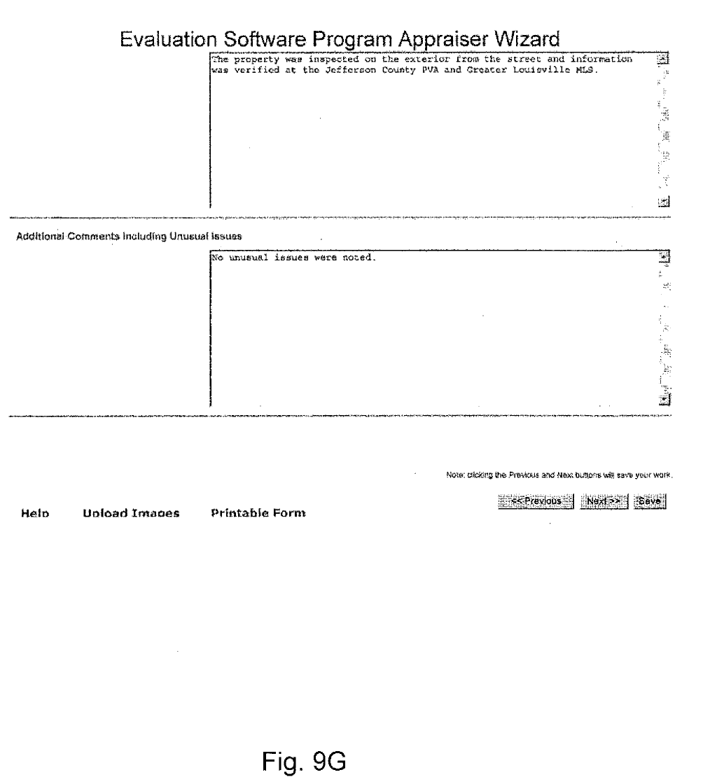

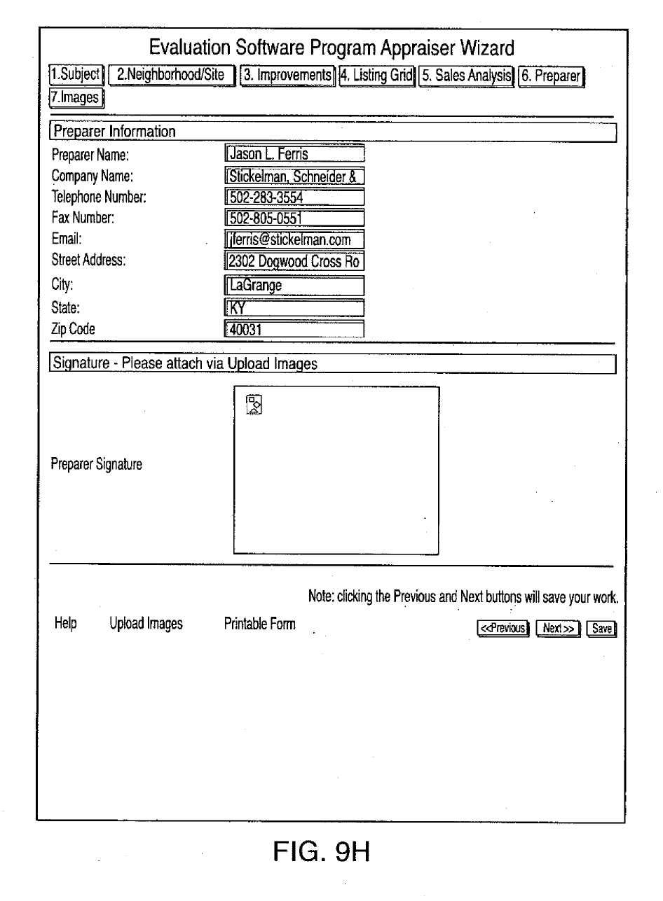

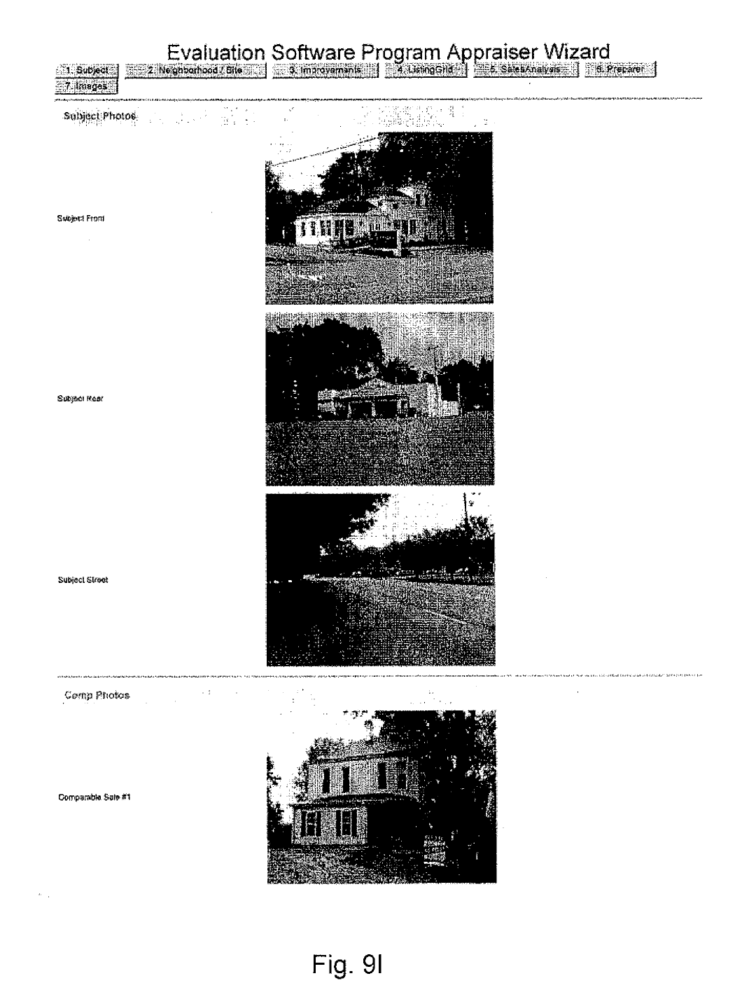

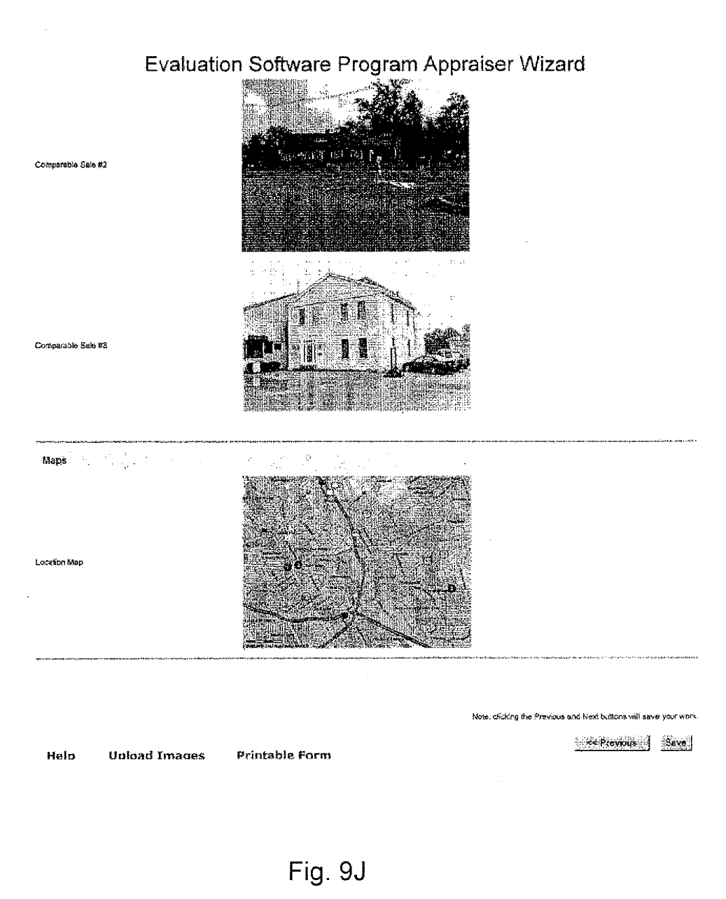

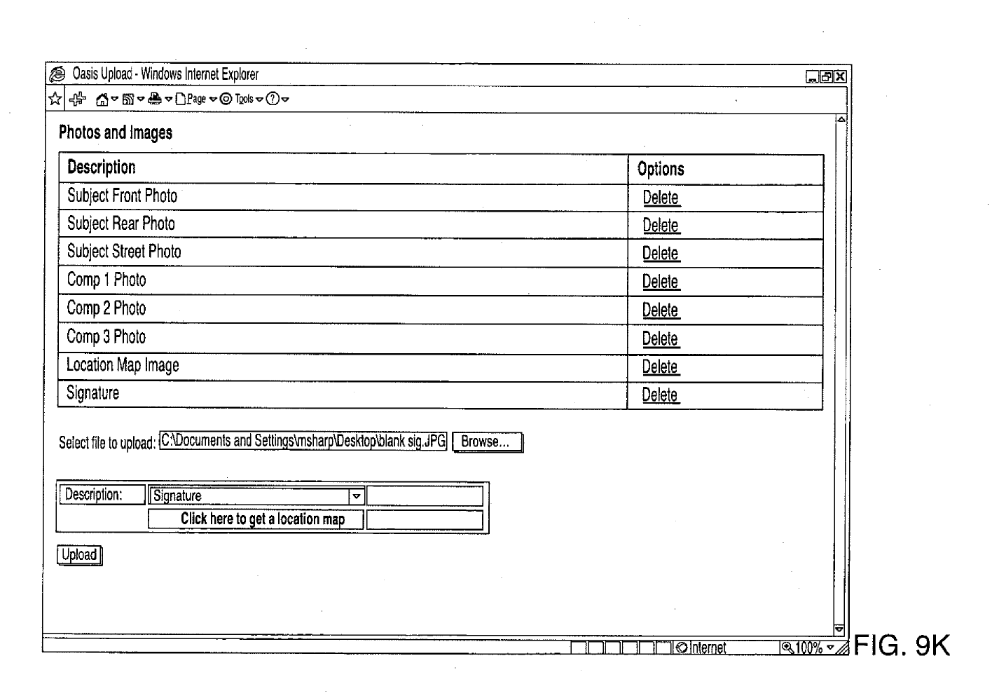

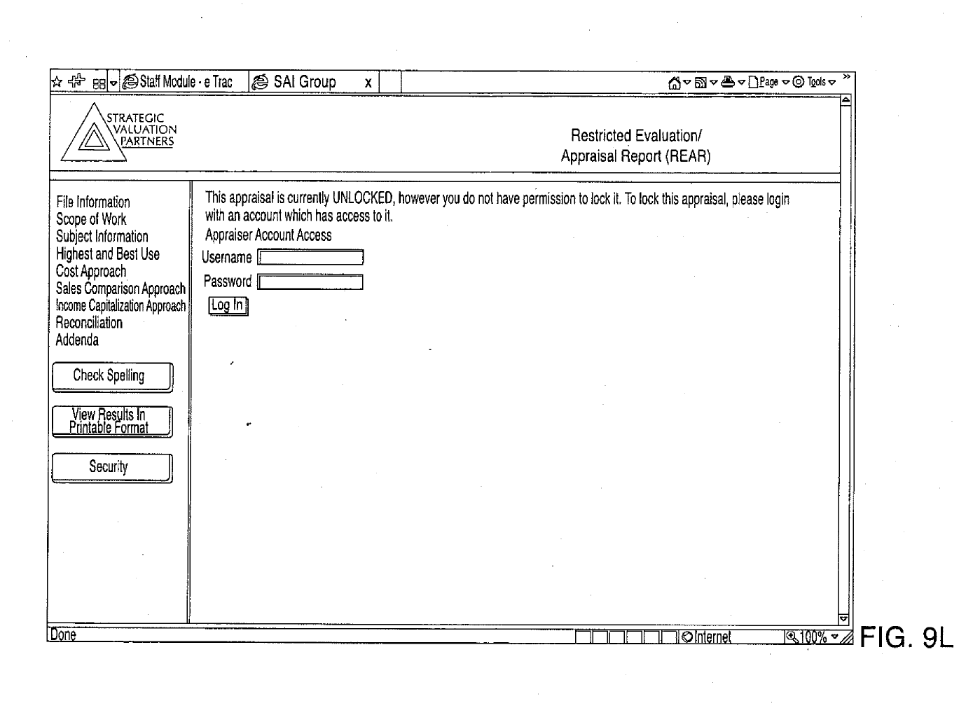

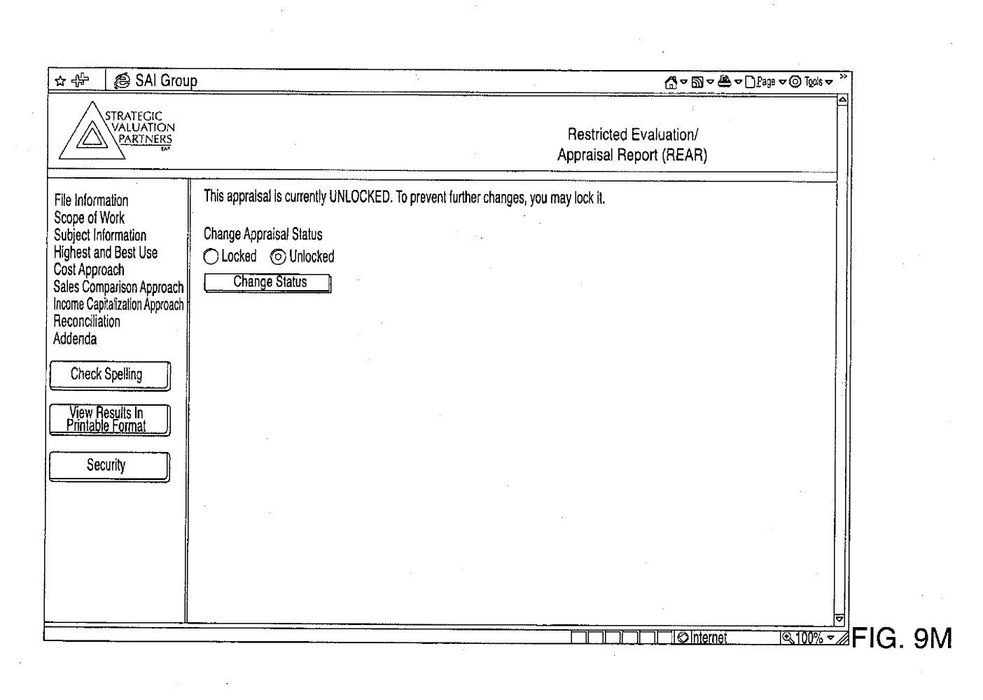

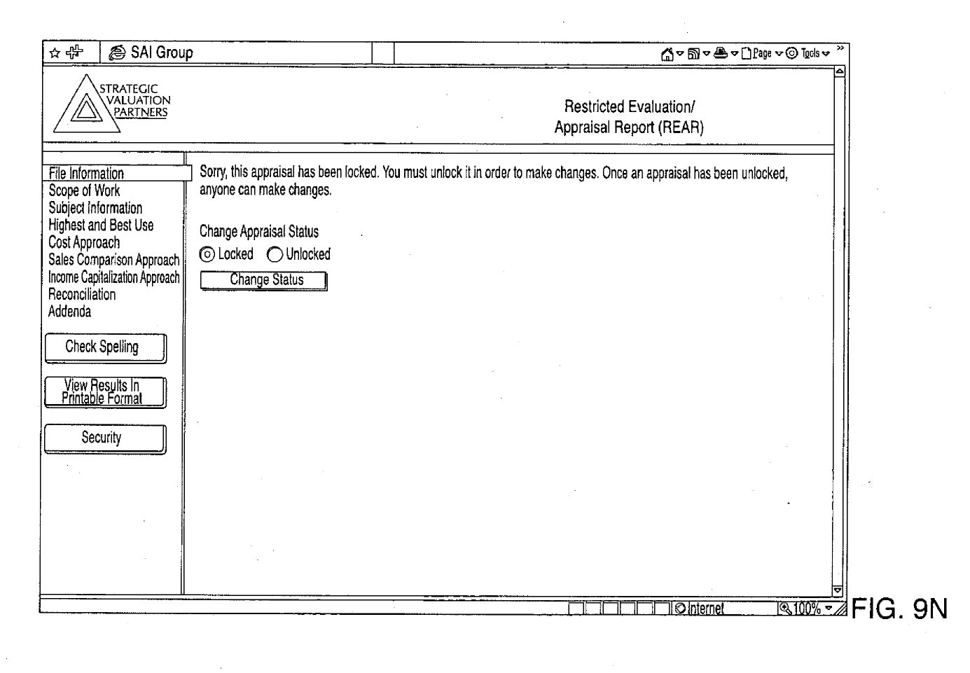

As the appraiser 152,154 enters data into the standardized report, the data so entered may be uploaded to the host system 120 for storage into a portfolio database 160 as a valuation report 162. Any suitable means may be employed to cause the information required by a standardized report 162 to be entered into the host system 120. For example, when a page of a standardized report 162 has been completed, the appraiser 152,154 may click a submit button or the like to cause the data within the fields 62 to be uploaded into the portfolio database 160 in a known manner. The appraiser 152,154 may then move on to the next page in the standardized report 162. Similarly, the appraiser 152,154 may revisit pages previously uploaded to edit information already entered. The appraiser 152,154 may also be able to upload entire files, such as graphic or pictorial files, to provide data for certain fields that may require such graphics or pictures. Such interactive user interfaces are known in the field of web programming, for example. Means and methods for correlating together clients 110, appraisers 152,154 and the data related to specific, ordered reports 162 are also known in the fields of, for example, relational databases. By way of a specific example, for final product population the host system 120 may present to the appraiser 152,154 only those fields that need to be input by the appraiser 152,154 to complete the requirements of the desired standardized report. This is shown in FIGS. 9A-9J, which show interactive forms the appraiser 152,154 may use to submit data required of an “Evaluation” report, and example data that the appraiser 152,154 may enter into such forms. As shown from the figures, the appraiser 152,154 may click forward and backward between the various forms, may upload images, save the data entered so far, and so forth. In certain preferred embodiments, the client 110 does not have write access to the portfolio database 160, or has only limited access. That is, the client 110 is denied access to the product population interfaces; these interfaces, in such embodiments, are solely for the use of the appraisers 152,154. More specifically, for each report 162 within the portfolio database 160, only the appraiser 152,154 assigned to that report 162 may have write permissions to modify the report 162. Correlating reports 162 and their attendant fields with appraisers 152,154 assigned to those reports 162, and providing appropriate security measures for read and write access of these reports 162 within the portfolio database 160, should be well within the means of a reasonably skilled programmer. In other embodiments, the client 110 may have write access to the report so long as the appraiser has not locked the report. FIGS. 9K-9N show example web pages presented by, for example, the appraiser module that permit an appraiser 152,154 to lock the report that he or she is currently working on, but has not yet completed or signed. As shown in FIG. 9L, the appraiser 152,154 may enter a login/password combination to gain access to the report being edited. As shown in the figures, the web pages may provide convenient links that permit the appraiser 152,154 to jump to certain sections within a report for final product population. In FIG. 9M, the appraiser 152,154 has unlocked the report 162, and so the client 110 may access the report (via, for example, web pages similar to those shown in FIGS. 9A-9J) and make changes to the report. A corresponding entry in the status log may also be entered, for example, by the host system 120 to indicate that such a client-related change was made to the report. As shown in FIG. 9N, the appraiser 152,154 may lock the report. When locked, neither the appraiser 152,154 nor the client 110 may make changes to the report, though they may view the report as it has been entered to that date.

In certain embodiments the host system 120 may permit the appraiser 152,154 to digitally sign the report 162 that has been uploaded to the host system 120. Any suitable method may be used to effect such a digital signature. For example, the appraiser 152,154 may click a “Sign” button or link positioned in relation to the filled-in report 162, and then enter his or her password. If the entered password is correct, then the report 162 may be recorded within the portfolio database 160 as “signed.” Alternatively, if the appraiser 152,154 has already logged into or otherwise been verified by the host system 120, then the appraiser 152,154 may be provided a field into which an image of a signature be uploaded to sign the document, as shown in FIG. 9H. As shown in FIG. 9K, a general user interface may be provided that permits the appraiser 152,154 to select the type of image file to be uploaded, such as the picture for a particular field or a signature, and then to select the pathname for that image file. Once an “Upload” button or the like is clicked, the image file is uploaded into the host server 120 and populated into the appropriate field. If the field is a signature field, then the host server 120 may assume that the report 162 has been signed. In certain embodiments, once signed, a report 162 cannot be changed by the appraiser 152,154, and ideally by no one else as well. In some of these embodiments, the host system 120 may provide a mechanism that enables the appraiser 152,154 to remove his or her digital signature; this may be done, for example, by a mechanism similar to that used to originally sign the report 162. For example, as shown in FIG. 9K, the appraiser 152,154 may click on a “Delete” link or the like for the signature field to remove his or her signature, and thus unlock the report 162. When a digital signature has been removed, the appraiser 152,154 may then again edit the report 162.

To complete step 60, the appraiser 152,154 should enter all data into the host system 120 that is needed to complete the report 162, and then so indicate this to the host system 120. This may be done, for example, by the appraiser 152,154 clicking upon a final submission button or the like. In certain embodiments, once the host system 120 has received an indication from the appraiser 152,154 that the report 162 has been completed, the host system 120 may perform an automatic review of the report 162, as indicated by step 70. The purpose of this review is to raise possible warning flags for the benefit of the client 110.

The report review step 70 begins by noting that certain fields in a report 162 may be of particular significance to the client 110. More specifically, certain values within those fields may indicate that the property may present, for example, a heightened risk exposure for the client 110. These fields are identified, and for each field so identified one or more possible entries or values that may be filled into those fields are identified to trigger a warning for the benefit of the client 110. For example, with specific reference to the Evaluation report shown in FIGS. 9A-9J, a “Use is” field 71, shown in FIG. 9B, may contain a “Legal” or “Illegal” entry. An “Illegal” entry in this field 71 may be of particular importance to a lender seeking to use the property as security for a loan. Hence, the “Use is” field 71 is tagged as being of particular significance, and the entry “Illegal” is marked as a value that triggers a warning flag for the client 110. Of course, warning flags may be triggered not only by particular values contained within certain fields, but also by comparing the values in such fields to other values, such as values present in other fields or in the order-related data. For example, another field of particular significance may be a “Final Evaluation Conclusion” field 72, which indicates the appraiser's 152,154 best estimate as to the true value of the property in question. Frequently, a standard piece of order-related data is the so-called “Loan-to-Value” (LTV) ratio; the client 110 will also typically include the value of the loan. If, for example, the client 110 indicates that the LTV is to be about 0.80 for an $80,000 loan, then the client 110 may be concerned if the final appraised value of the property were less than $100,000. The “Final Evaluation Conclusion” field 72 may thus be marked as being of particular significance, and the value contained in that field may be cross-referenced with the LTV and loan amount data originally provided by the client 110 in step 10 to determine if a related flag should be raised or not. Hence, it should be clear that, depending upon the complexity and depth of the underlying report 162, and the particular purposes of the client for requesting the report 162, numerous fields of significance may be identified, and each may have one or more related values that raise flags, either intrinsically, or because of cross-referencing to other quantities known to the host system 120.

With specific reference to certain valuation reports disclosed herein, the Evaluation report may have the least number of flags, whereas the Summary report may have the most. Certain exemplary fields may include: 1. Supply and Demand; 2. Value Trend; 3. Rental Rates; 4. Vacancy Trend; 5. Use Is; 6. Tax Assessed Value in relationship to final value of the appraiser 152,154; 7. Condition of the subject property; 8. Sale Date Tolerance of the Sales Comparables used; 9. Distance Tolerance of the Sales Comparables used; 10. Hypothetical Conditions—any value in this field other than the default value, which may be pre-populated; 11. Extraordinary Assumptions—the same as Hypothetical Conditions; 12. Personal Property has been included in the final value estimate; 13. Intangible Items have been included in the final value estimate; 14. Total of 13 and 14 is removed from the final value estimate and then checked with the host 120 to see if adequate net value satisfies the collateral value requirement of the transaction as provided by client 110; 15. Zoning Compliance; 16. Highest and Best Use as Vacant; 17. Highest and Best Use as Improved; 18. Functional Obsolescence; 19. External Obsolescence; 20. Vacancy and Rent Loss exceeding a maximum tolerance level established by the client 110; 21. Replacement Reserves below a minimum tolerance level and a maximum tolerance level established by the client 110; 22. Overall Capitalization Rate which falls outside the client 110 tolerance range; 23. All Unadjusted Sale Price per Unit of Comparison of the Improved Sales Comparables fall outside a percentage rage of differential; 24. Adjusted Sales Price per Unit of Comparison of the Improved Sales Comparables falls outside a percentage rage of differential; 25. Improved Sales Comparables—the adjusted price per unit applied to the subject units and its variance with the average adjusted and unadjusted price per unit of the comparables—the tolerance percentage may be set by the client 110; 26. The RAP-C final value differs from the previous Evaluation value; 27. The appraiser's 152,154 license/certification expiration date is past the effective date of the appraisal report—the expiration date may be auto populated from the Appraiser Database 140; 28. Total Depreciation is in excess of the client 110 tolerance level; 29. Land sales dates exceed the client 110 tolerance level; 30. Land sales Unadjusted Sale Price per Unit fall outside a percentage rage of differential set by the client 110; 31. Land sales, the adjusted price per unit applied to the subject units and its variance with the average adjusted and unadjusted price per unit of the comparables—the tolerance percentage may be set by the individual client 110; 32. Other Income in the Income Approach exceeds the client's 110 established percentage of total income; 33. Income Approach to value, if Market Rents were used and not Actual Rents; 34. If the indicated values of the approaches to value used fall outside the tolerance range of the client 110; 35. Real Property Rights Appraised, Fee Simple, Leased Fee and Lease Hold, client 110 may set the negative value; 36. Excess Land is present; 37. Land to total value ratio within client 110 set tolerance; 38. Distance from the subject of the Rental Comparables within client 110 set tolerance; 39. Excess Land Value as a percentage of the total value, then checked against the client 110 set tolerance percentage; 40. Estimated Marketing Time exceeds client 110 tolerances; 41. Estimated Exposure Time exceeds client 110 tolerances; 42. Disposition Value is provided; 43. Liquidation Value is provided; 44. Subject Image Fields are populated; 45. Subject Location Map is populated.

It will be appreciated that suitable user interfaces may be constructed that permit the client 110 to set the variance tolerance levels associated with the flags, and to indicate which flags are to be monitored for review purposes. Once an automated review has been completed in step 70, a corresponding Review Report 164 may reside with the valuation report file 162 on the host system 120, for example within the portfolio database 160. The review report 164 may indicate areas and items within the valuation report 162 that are outside the predetermined tolerance levels of the client 110. In addition, if flags that the client 110 has indicated to be monitored have a review hit (i.e., have been triggered), a report status for the valuation report 162 may be set, for example, as “Completed and Needs Review.” On the other hand, if no flags have been raised that the client 110 has requested to be monitored for review purposes, then the report status may be set, for example, as “Completed.” Both of these status types may be posted in the host system 120 and a suitable email notification may be sent to the client 110, for example.

After the optional review of the report in step 70 and the identification of any raised flags, the valuation report 162 is submitted to the client 110 in step 80, optionally along with any review report 164. Any suitable means may be employed to provide the reports 162,164 to the client 110. For example, the entire valuation report 162 may be emailed or conventionally mailed to the client 110. Or, the client 110 may be sent an email message indicating that the valuation report 162 is ready, and which identifies the report 162 without disclosing any proprietary information. The client 110 may then login to the host system 120 and retrieve the reports 162,164 in a secure manner. If the host system 120 has identified any flags, the flags may be inserted into the valuation report 162 itself, or may be presented as an addendum or separate file, such as in the review report 164.

In certain embodiments, once the valuation report 162 has been delivered to the client 110 by the host system 120, the appraiser 152,154 is denied write access the appraisal report 162 unless the client 110 unlocks the report 162 at their administration point with the host server 120. Any suitable means may be employed to deny access to the appraiser 152,154. For example, the appraiser module may remove or disable the “Start Appraisal” link or button 64b shown in FIG. 6E. However, if the client 110 chooses to unlock the report 162, then the appraiser 152,154 is free to remove his or her signature, modify the report 162 and then one again sign (and thus lock) the report 162. In specific embodiments, the original report may still remain in an electronic archive in the host system 120, which has been time stamped, and the modified report 162 then becomes the active report 162.

Finally, in step 90, the host system 120 may optionally permit the client 110 to subsequently manage the report 162 within the portfolio database 160. For example, the client 110 may perform standard database queries to extract a portion or all of the client's 110 related data and reports 162 from the portfolio database 160. Additionally, the client 110 may be permitted to add or alter subsequent ancillary information related to a report 162, such as whether a loan for which the report 162 was generated was denied, approved or closed. However, as previously indicated, in certain embodiments, once the appraiser 152,154 has signed the report 162, the client 110 may not alter any appraisal-related information within the report 162.

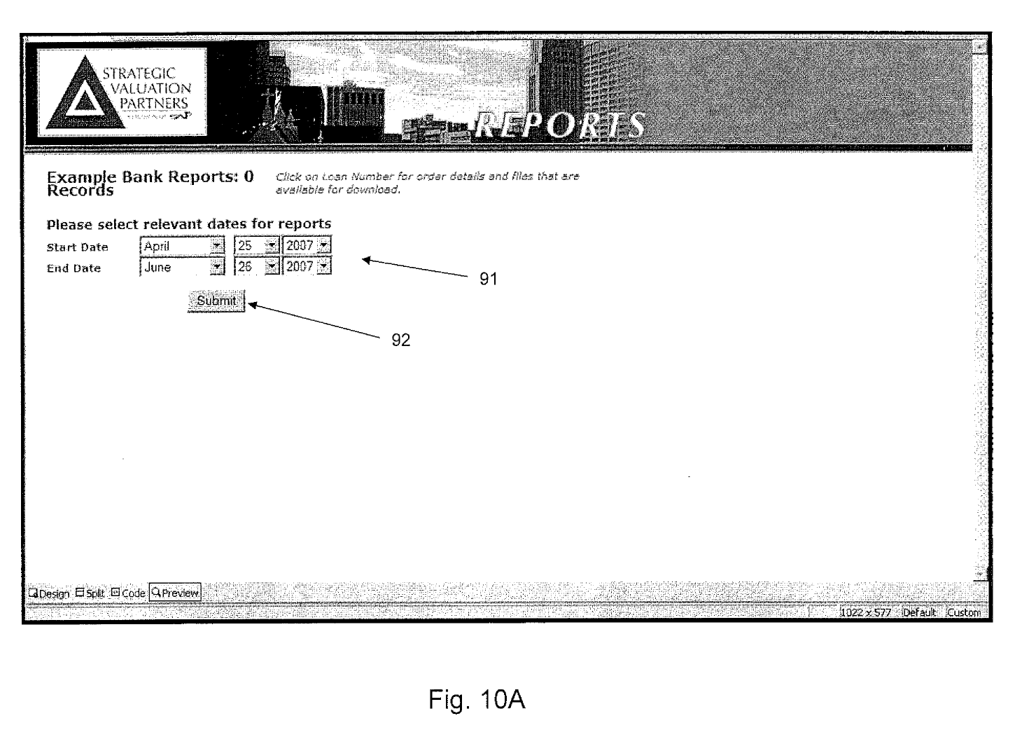

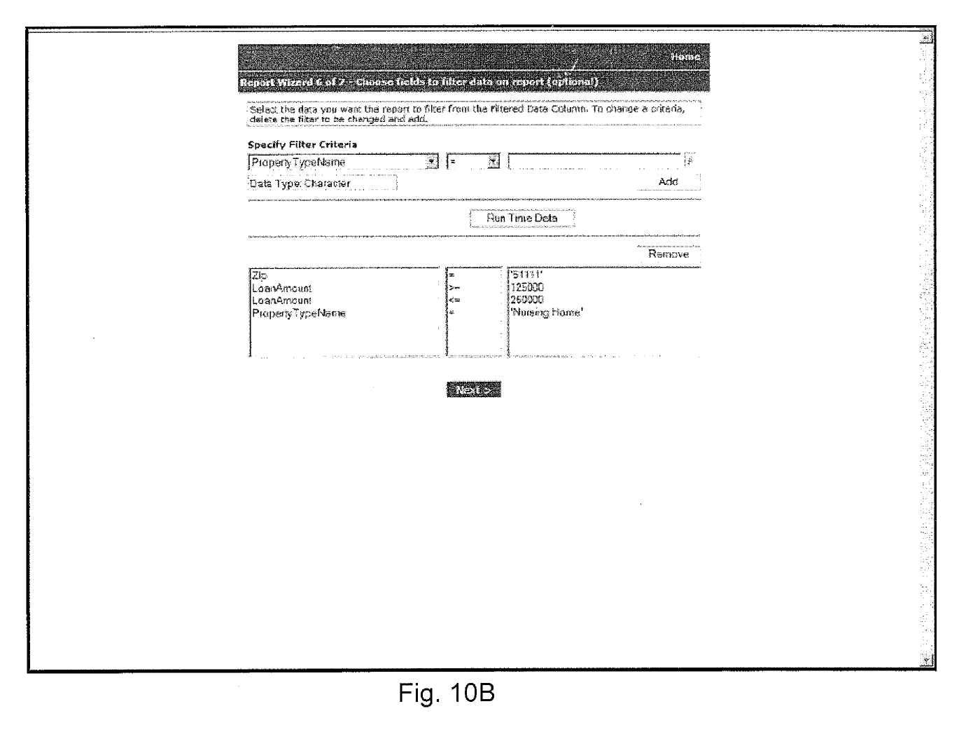

By way of example, FIGS. 10A-10B show user interface screens presented by the host system 120 that permits the client 110 to make a typical database query of the reports 162 and related data within the portfolio database 160. The specific query presented in FIG. 10A is the requesting of all reports 162 of the client's 110 within a certain date range. Drop-down boxes 91 permit the selection of a date range, and button 92 when pressed causes the client 110 to upload the date range information to the host system 120, which then performs an appropriate database query of the portfolio database 160. Other query types are certainly possible, however. For example, a more general interface is shown in FIG. 10B, which permits the client 110 to select the fields and respective values or conditions to be searched against. Any suitable programming technique may be employed for this functionality, such as SQL or the like.

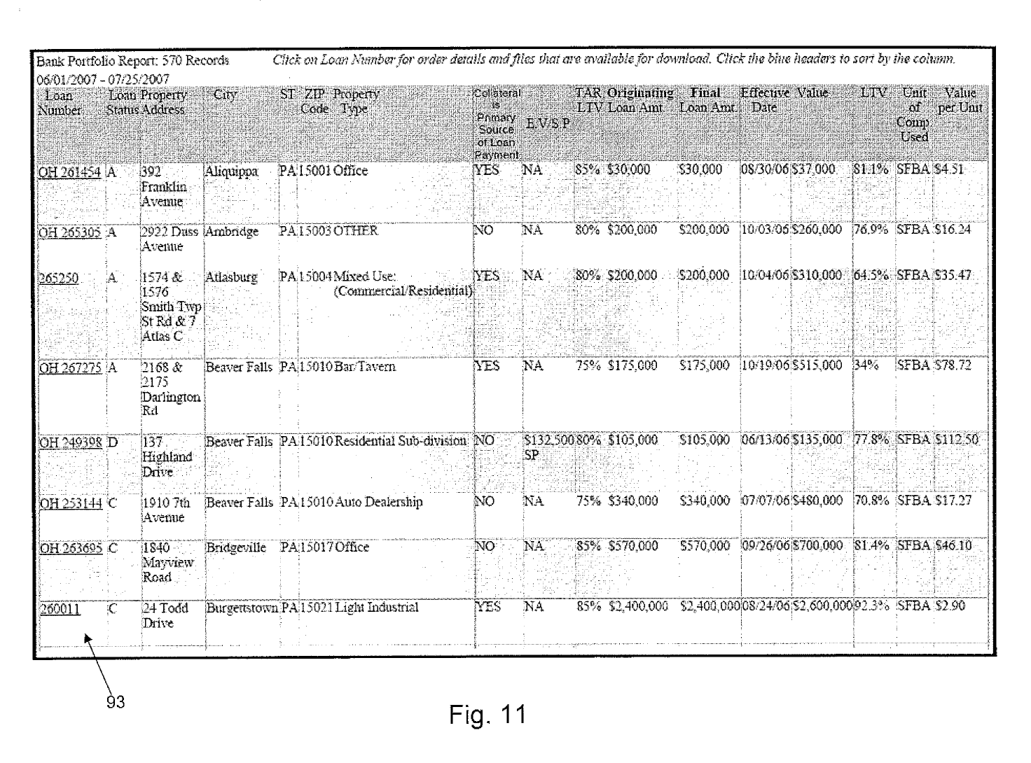

As shown in FIG. 11, the database query may generate hits, and the host system 120 may then provide to the client 110 data corresponding to those hits. The data so presented may be data which is deemed typically of most interest to the client 110; alternatively, another interface may be setup which permits the client 110 to select which data is to be presented from each hit. Additionally, for each hit a link may be provided that, when clicked upon by the client 110, causes the host system 120 to provide additional information about that hit. For example, when the client 110 clicks upon a loan number 93, the host system 120 may extract from the portfolio database 160 a sub-set or all data related to that loan number 93, compile the data into a pre-formatted report, and present the report to the client 110. Alternatively, a true copy of the active report 162 generated by the valuation expert 150 and uploaded to the host system 120 may be presented to the client 110.

In certain embodiments, the host system 120 may permit the client 110 to add information related to the report 162. For example, the host system 120 may permit the client 110 to indicate whether a loan related to the report was approved, closed or denied, and the final loan amount. In certain preferred embodiments, after the report has been submitted to the client 110, the host system may wait a predetermined time, such as 48 hours. If, after the predetermined time the client 110 has not entered the additional information relating to the report into the host system 120, the host system 120 may send, for example, a reminder email to the client 110 to do so. Permitting the client 110 to enter and associate loan-related information with the report 162 allows the client 110 to later macro-manage their loan portfolio, as discussed later. It will be appreciated that this loan-related information may also be searched by way of appropriate database queries.

As previously indicated, various preferred embodiments employ standardized reports, the formats for which are stored in the product database 130. Standardization provides numerous benefits. First, the client 110 is afforded considerable convenience, as the same format is provided regardless of which valuation expert 150 generates the underlying data. Secondly, the formats may be changed to accommodate changing needs imposed by the client 110, regulatory agencies or both. Hence, new types of reports may be created and added to the product database 130. Additionally, data present in old reports 162 in the portfolio database 160 may be migrated into new formats present in the product database 130.

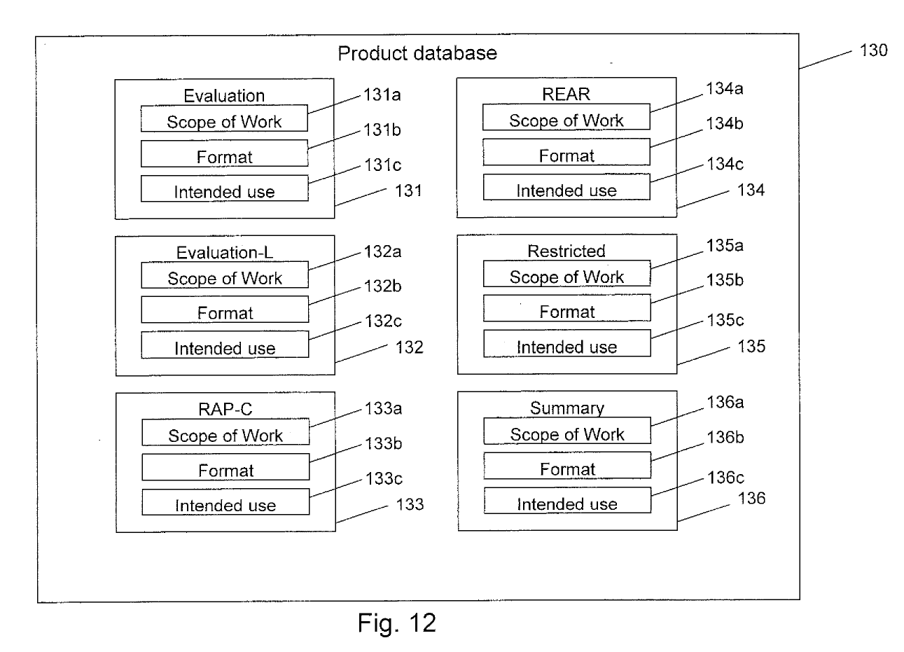

As shown in FIG. 12, the product database 130 may include a plurality of reports 131-136, each having a corresponding format 131b-136b that indicates, for example, the type of data the report 131-136 is to present, and the relative arrangement of this data. The format 131b-136b will include a plurality of fields that are to be filled with data originating from the valuation expert 150, the client 110, or from the host system 120, and will also include constant-type data, such as descriptive character strings for the various fields, data related to the layout of the report 131-136, logos and so forth. The respective format 131b-136b of each report 131-136 may be encoded by any suitable means. The reports 131-136 differ substantively from each other by the details required of the valuation analysis, and this is formally indicated by the scope of work 131a-136a of each report 131-136, respectively. The scope of work 131a-136a of each report 131-136 defines what the property valuator 150 is to do in the performance and completion of the report 131-136, and thus indirectly also determines what type of data and corresponding fields should be present within the respective format 131b-136b. The scope of work 131a-136a defines the type and extent of research and analysis the valuation expert 150 must perform to satisfactorily complete the report 162. The scope of work 131a-136a may include, but is not limited to: the extent to which the property is identified; the extent to which tangible property is identified; the type and extent of data researched; the type and extent of analyses applied to arrive at opinions and conclusions, and outline or call for the report type 131b-136b. The scope of work 131a-136a ideally includes sufficient research and analysis that are necessary to develop credible assignment results based upon the assignment elements, which may include: client and any other intended user; intended use of the appraiser's opinions and conclusion; type and definition of value; effective date of the appraiser's opinions and conclusions; subject of the assignment and its relevant characteristics, and other assignment conditions. Typically, the scope of work 131a-136a is acceptable when it meets or exceeds the expectations of parties who are the regularly intended users for similar assignments, and what the peers of the appraiser 152,154 would do in the performance of the same or a similar assignment. Assignment conditions ideally should not limit the scope of work 131a-136a to such an extent that the assignment results are not credible in the context of the intended use.

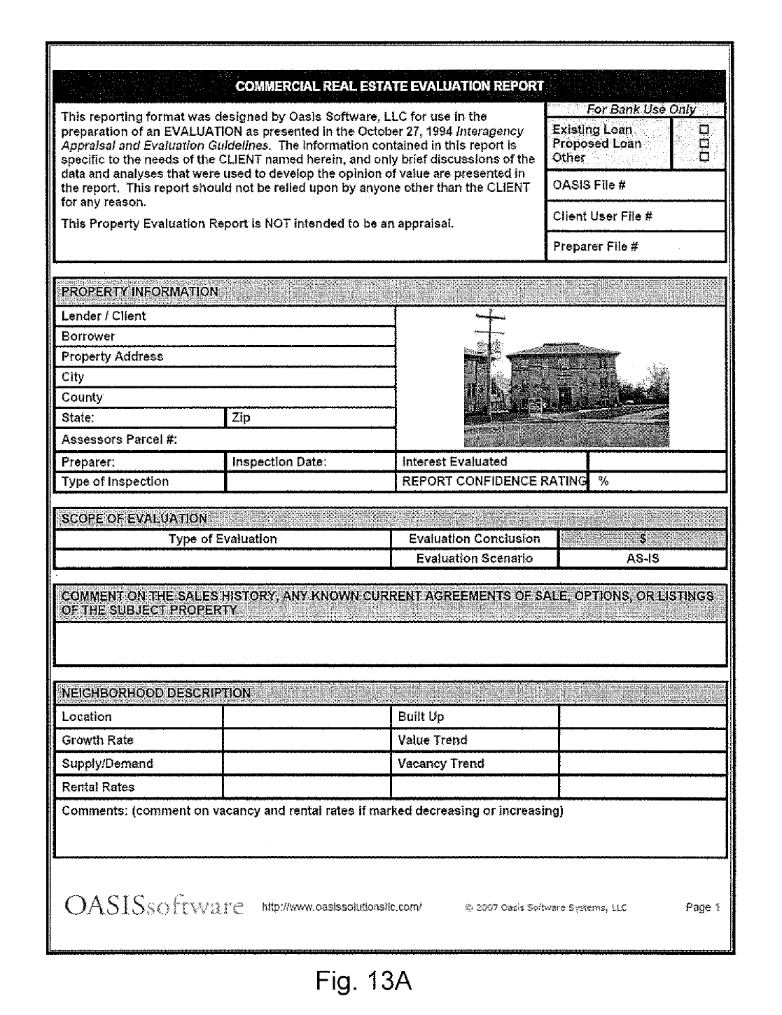

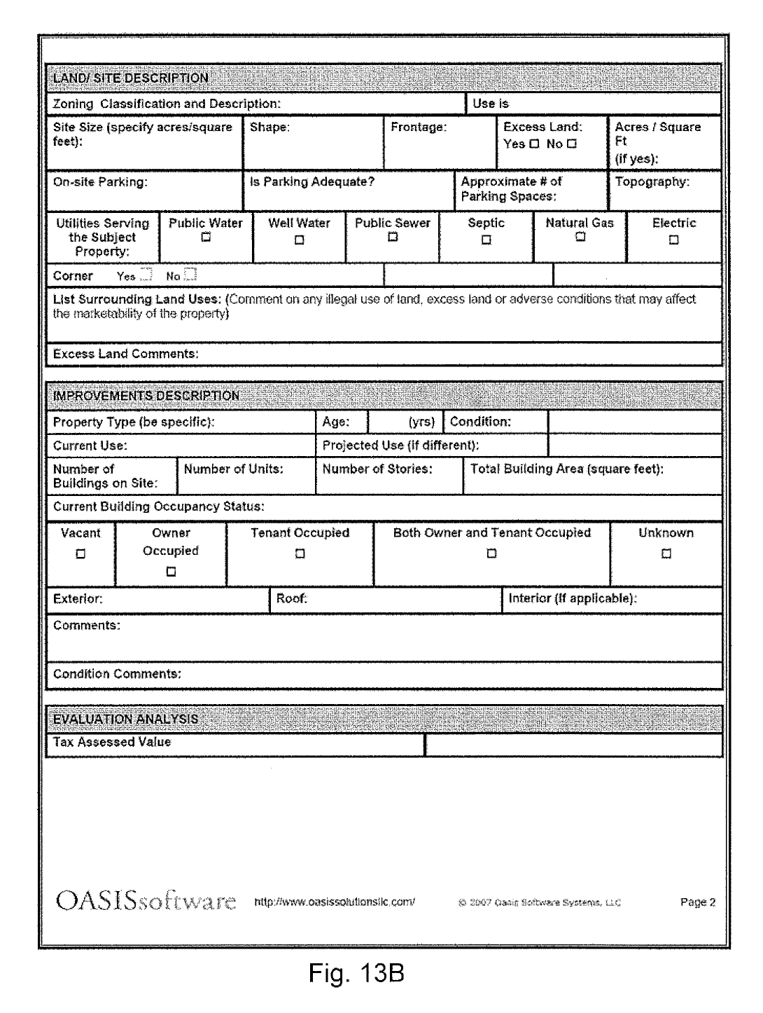

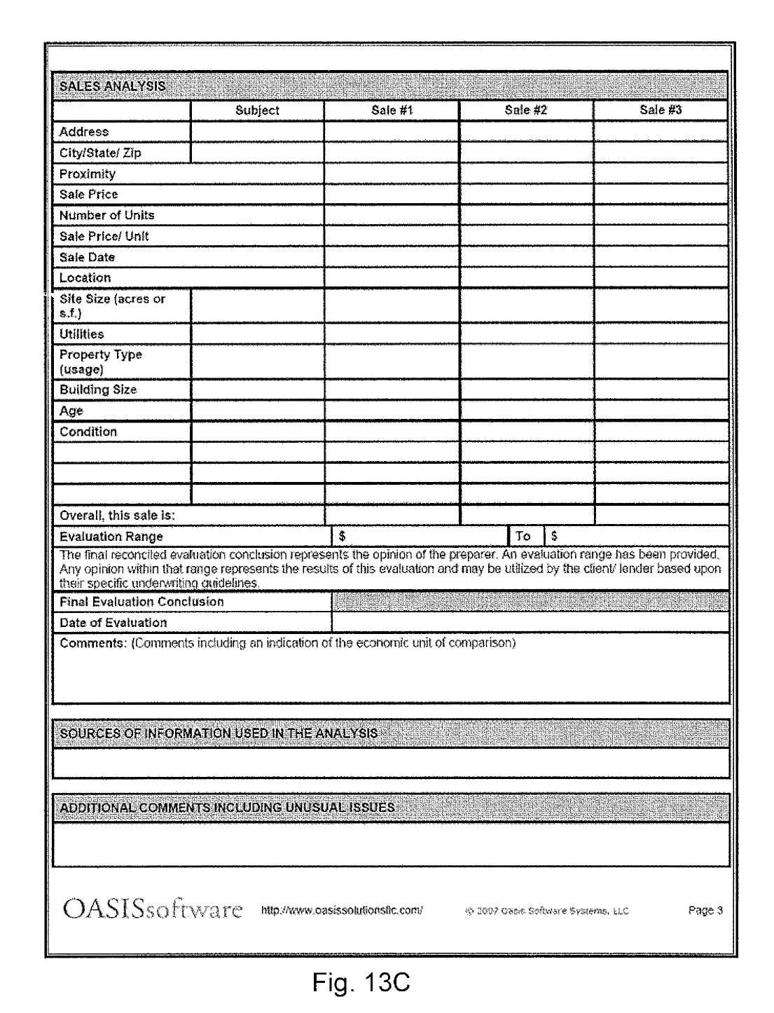

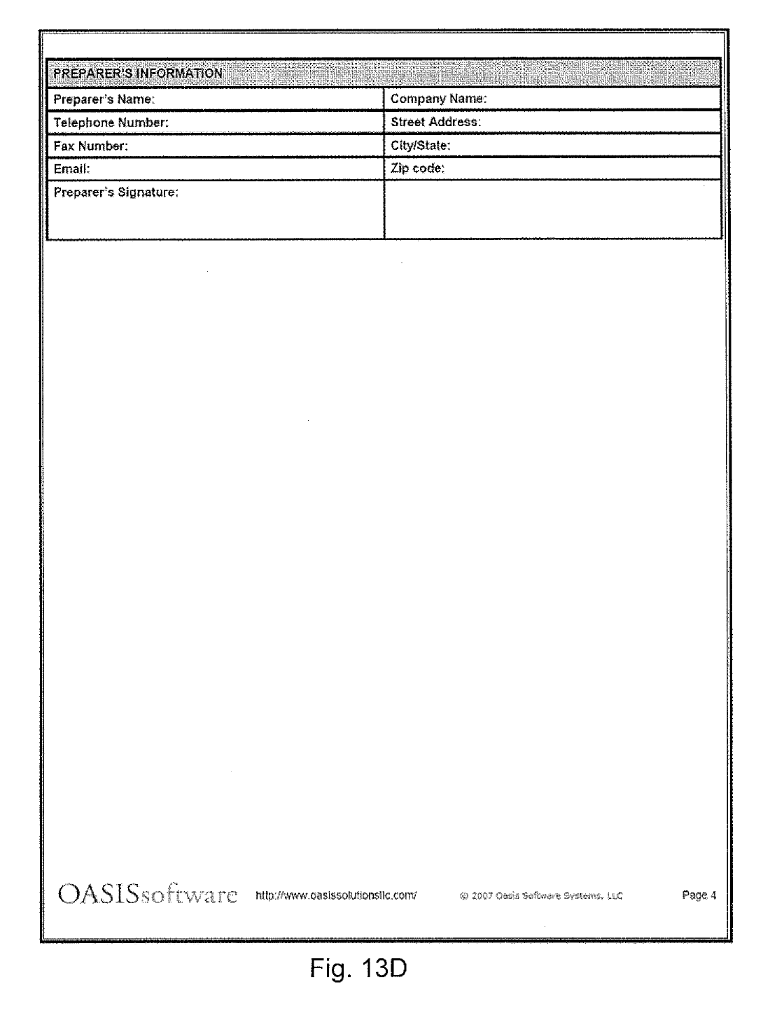

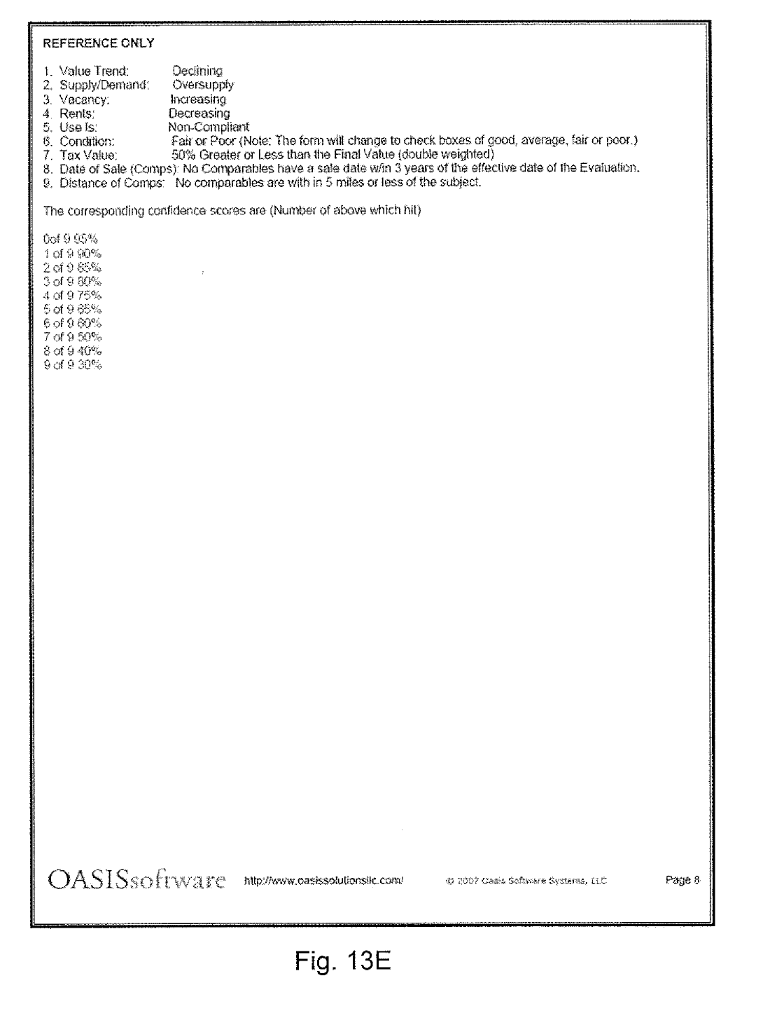

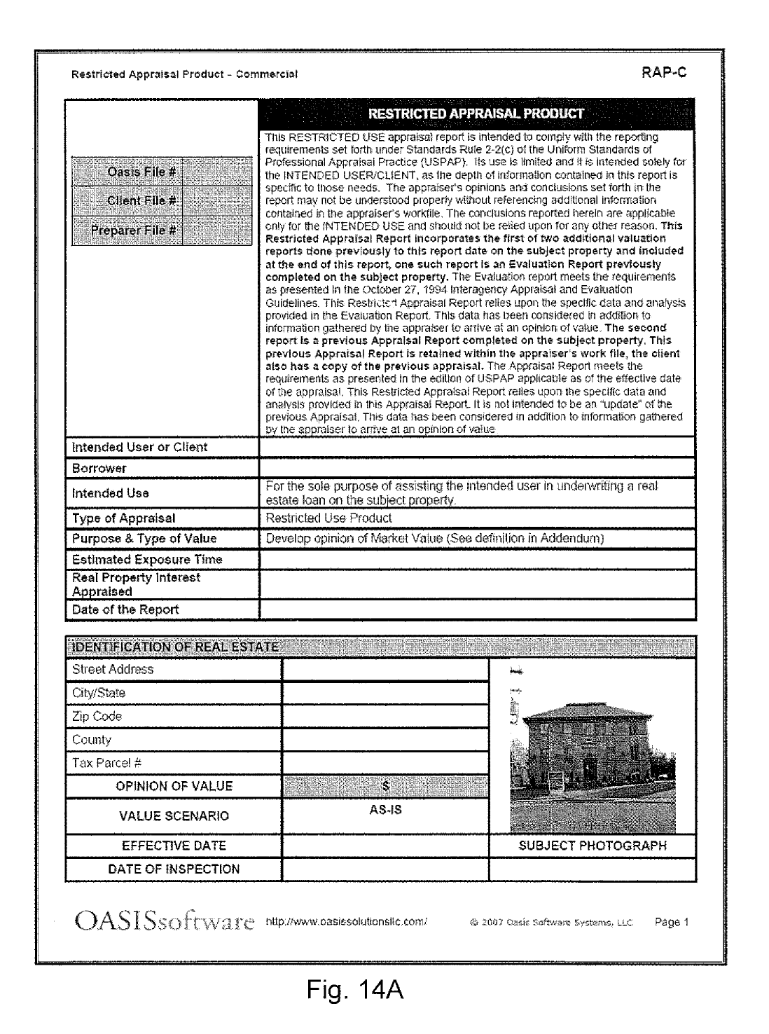

FIGS. 13A-13E show portions of an example format 131b for an Evaluation report 131. The Evaluation report 131 may also include pages for showing photographs of front, rear and street views of the subject property. For brevity, however, these pages are omitted from the figures. As shown in FIG. 13E, the last page of the Evaluation report 131 may include a listing of flags that were raised in step 70; the listing may show the field and respective value that caused the host system 120 to raise the flag. Also, as shown in FIG. 13E, a “confidence score” for the report 131 may be determined by the number of flags raised, with an increasing number of flags corresponding to a lower confidence score; this confidence score may be reported to the client 110 for consideration, or reported only when it drops below a threshold value as set, for example, by the client 110. Because of its limited nature, the Evaluation report 131 may not be performed by an appraiser working in his or her capacity as an appraiser; that is, the Evaluation report 131 is not an official appraisal of the subject property. Hence, in step 40, when the host system 120 assigns an Evaluation report 131 to a valuation expert 150, the host system 140 may refer to the appraiser database 140 and select people within the appropriate geographical location that either are not appraisers but are otherwise qualified to complete the Evaluation report 131, or who are appraisers that are willing to work not in their official capacities as appraisers. Individuals that may be qualified to perform the Evaluation report 131 include real estate agents and brokers, builders and developers, real property managers, etc.

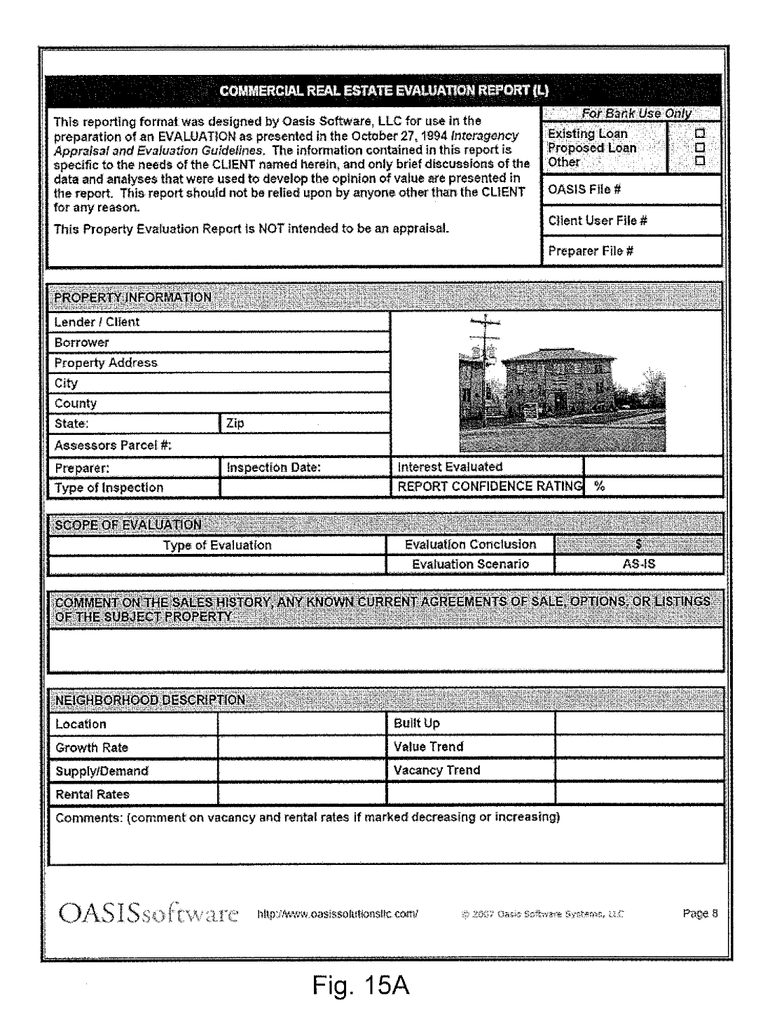

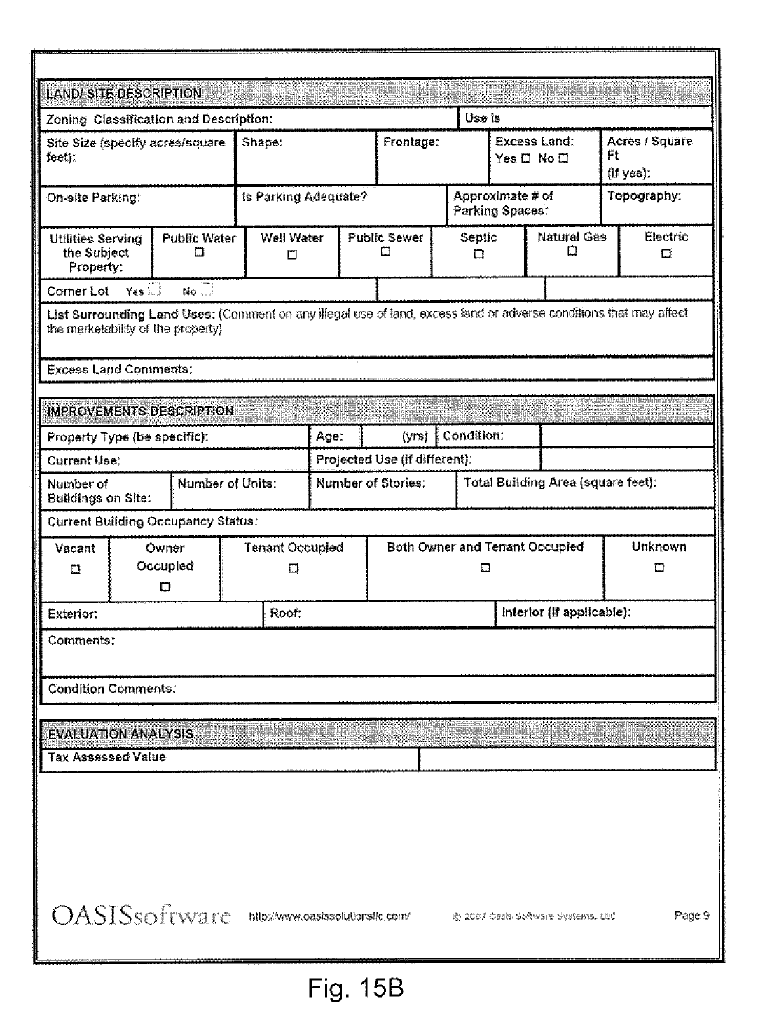

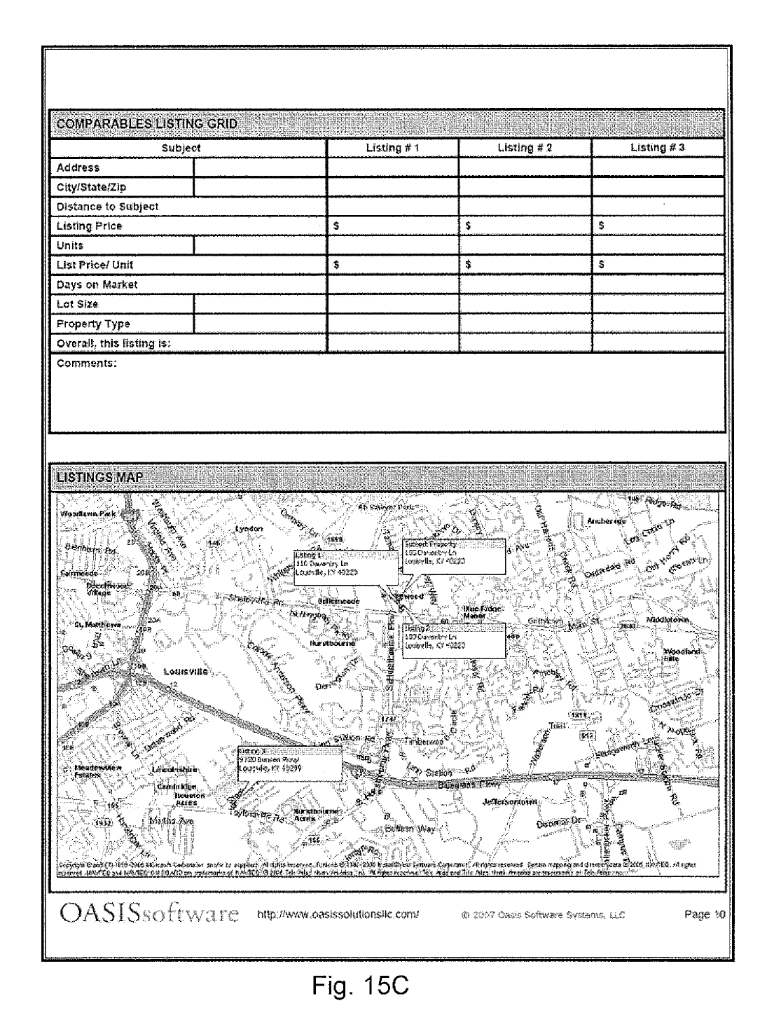

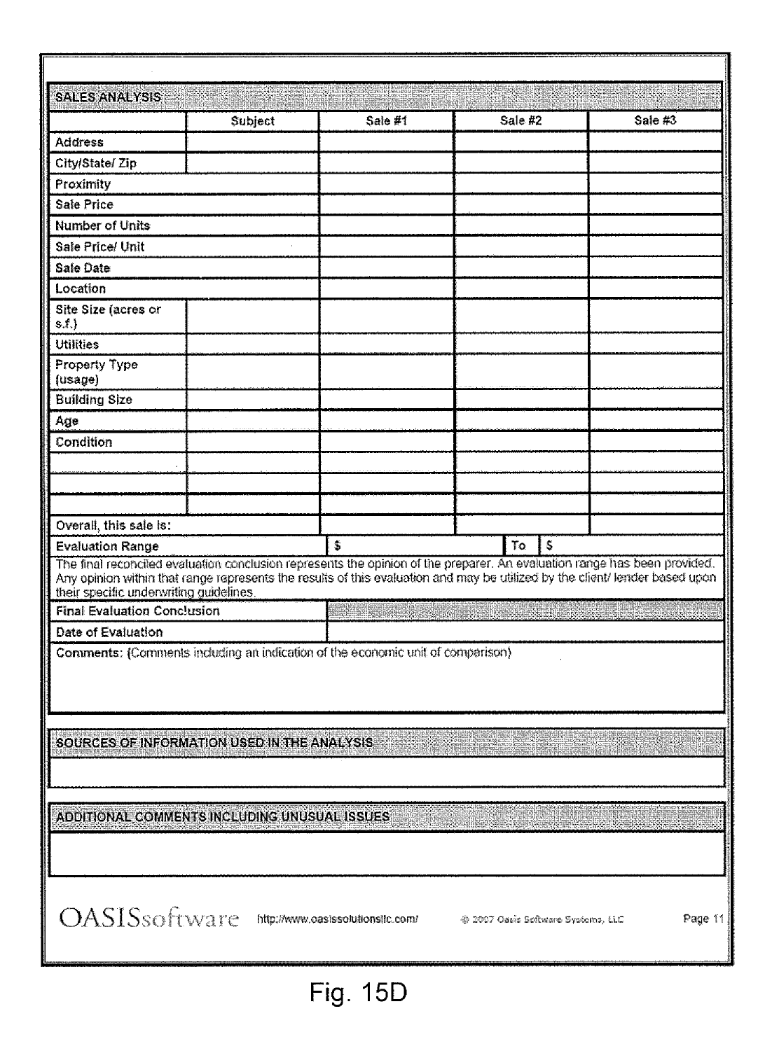

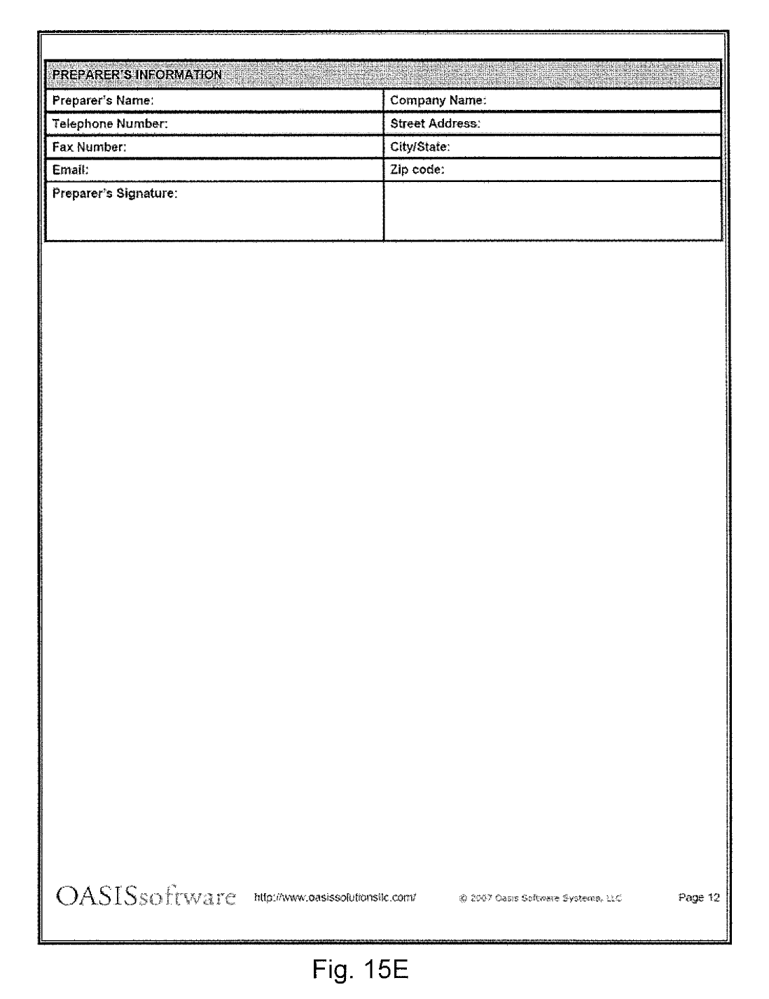

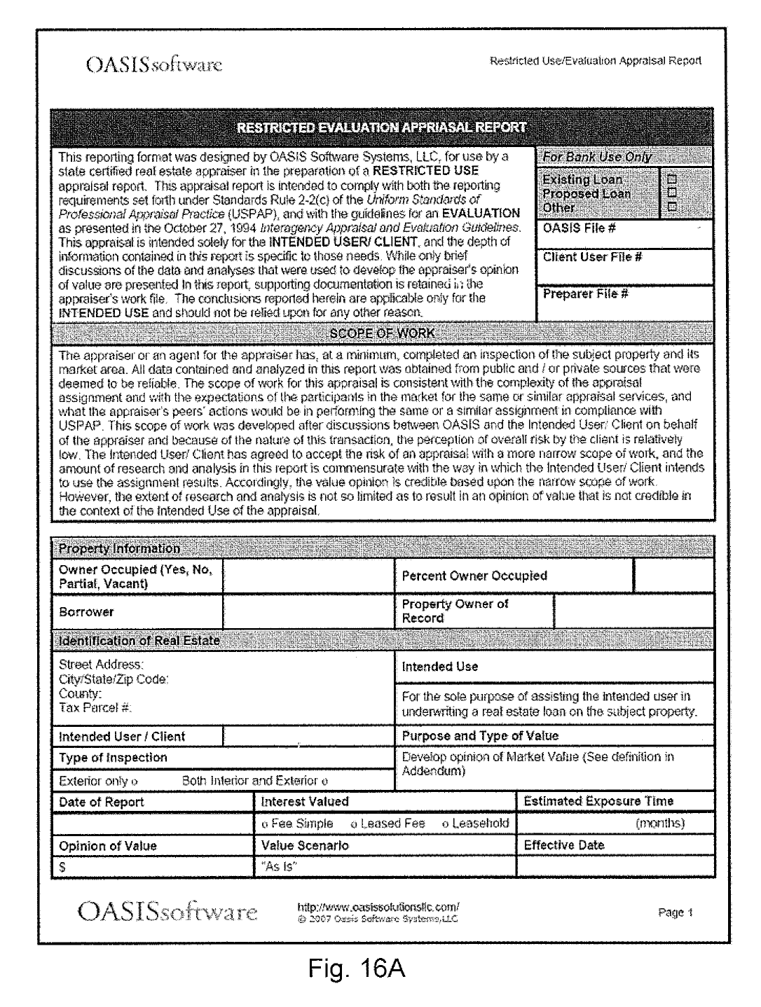

FIGS. 15A-15E show portions of an example format 132b for an Evaluation Listing (Evaluation-L) report 132. The Evaluation-L report 132 may also include pages for showing photographs of front, rear and street views of the subject property, photographs of comparable properties (typically three), and a map showing the respective locations of the subject property and the comparable properties, which are not shown. The Evaluation-L report 132 is similar to the Evaluation report 131, but further includes fields for the listing of comparable properties. Like the Evaluation report 131, the Evaluation-L report is not a formal appraisal.

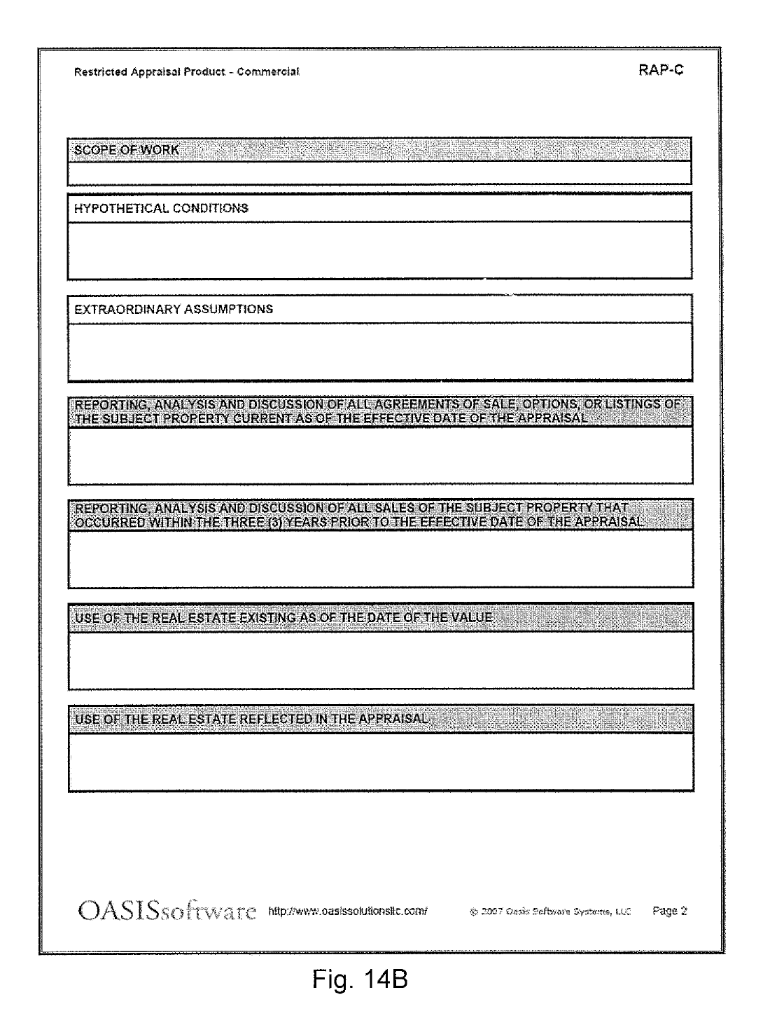

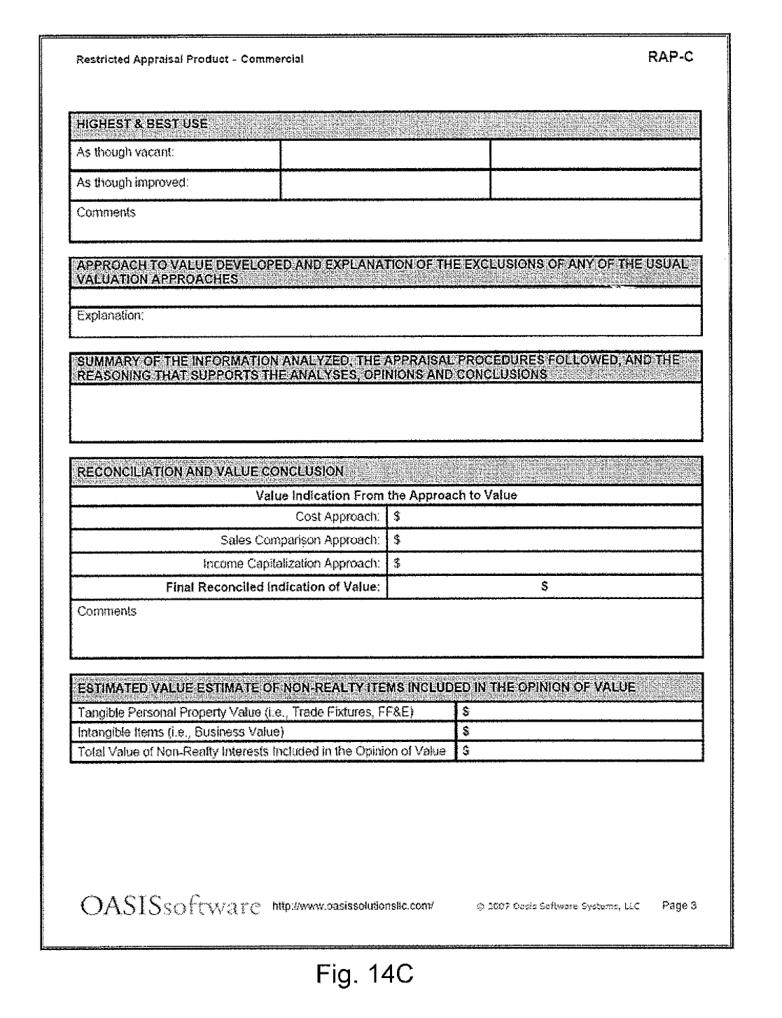

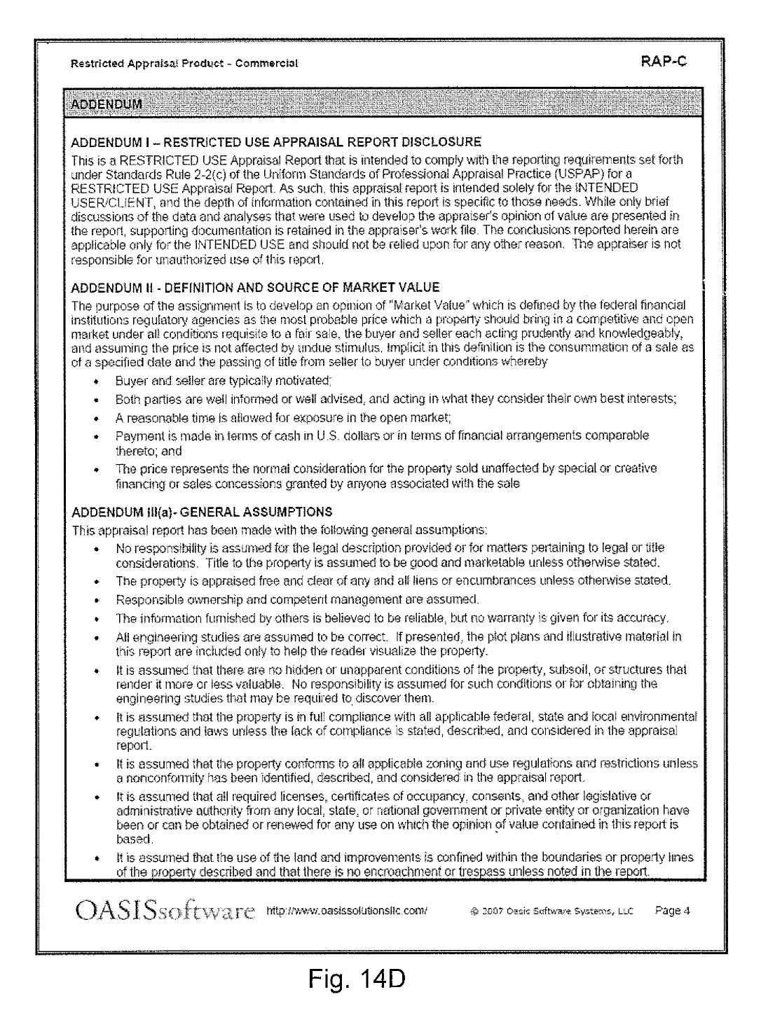

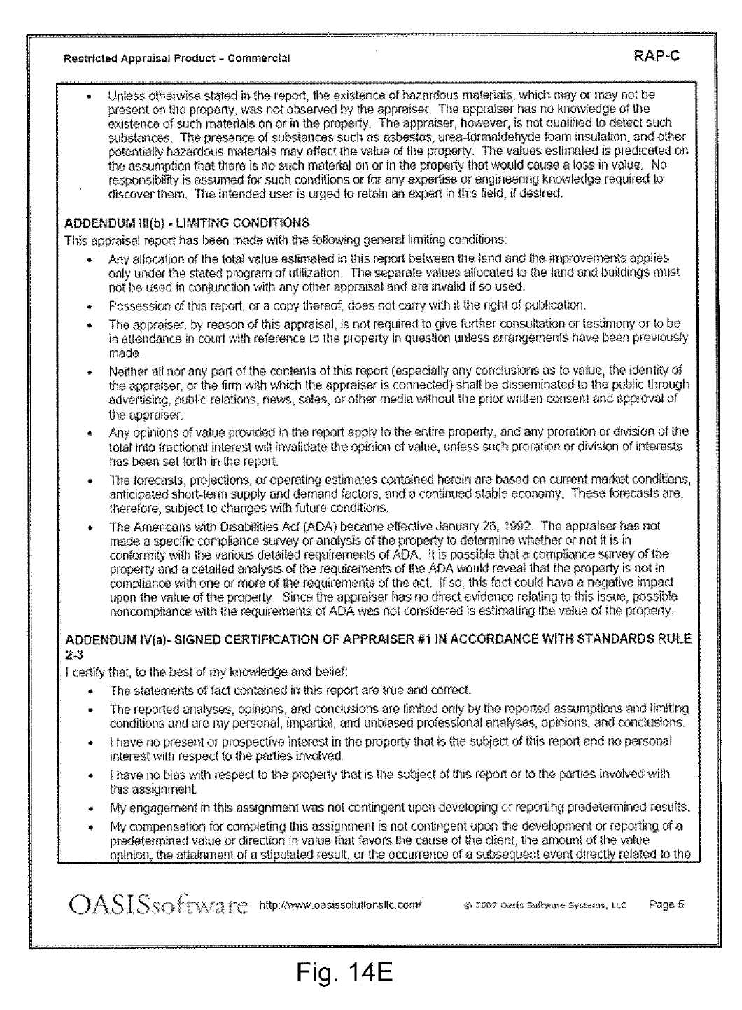

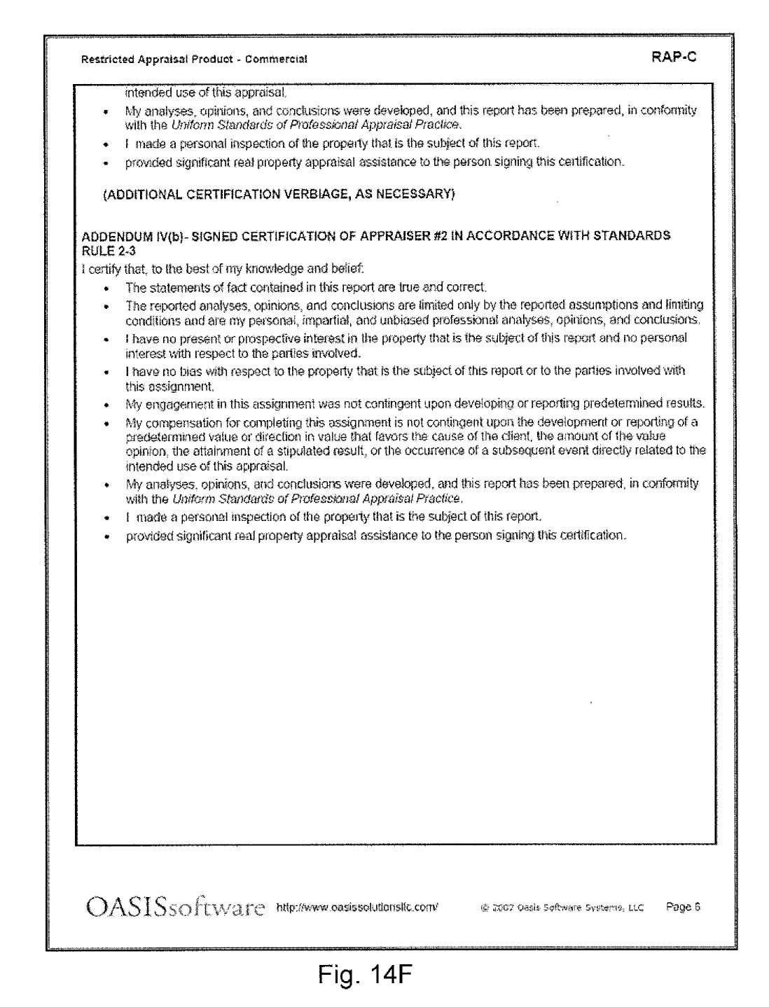

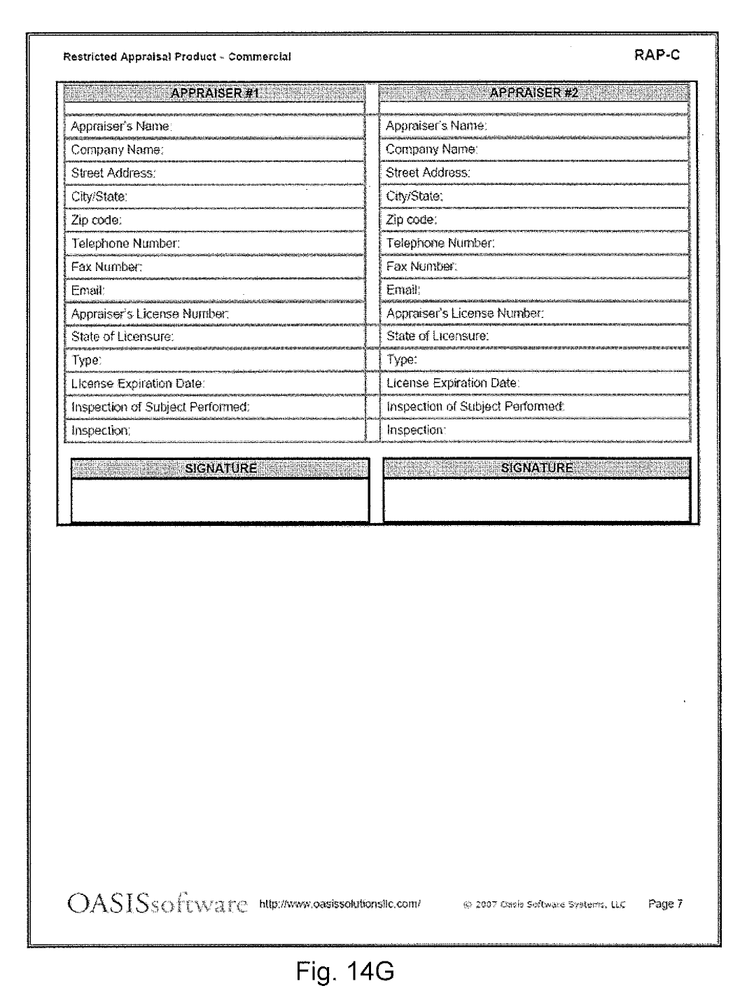

FIGS. 14A-14G illustrate portions of an example format 133b for a Restricted Appraisal Product-Commercial (RAP-C) report 133. Although not shown, as with the Evaluation reports 131,132, the RAP-C report 133 may further include pages to show photographs of various views of the subject property, of comparable properties (typically three), and a map to show where these properties are located with respect to each other. The RAP-C report 133 is preferably restricted to a single client 110, and is not intended for external distribution. The RAP-C report 133 may be thought of as a combination of either of the Evaluation reports 131,132 with a minimal appraisal report, and hence should be performed by a certified appraiser. In certain embodiments, an Evaluation report 131, an Evaluation-L report 132 or an appraisal completed by another valuation expert may be forwarded to a certified appraiser, who may then use his or her own expertise to verify if the conclusions within the report 131,132 or appraisal are accurate, assuming that all of the underlying factual assertions are correct. The results that the appraiser 152,154 reaches may then be incorporated into the RAP-C report 132 and submitted to the host system 120 by way of step 60. For example, a previously-executed Evaluation-L report 132 may be stored within the portfolio database 160. Subsequently, the client 110 may decide that a formal appraisal is desired, and thus uses steps 10-30 to generate an order for a RAP-C report 133 that is cross-referenced to the original Evaluation-L report 132 (stored as a report 162). When the appraiser 152,154 receives the order in step 42, all of the data from the prior Evaluation-L report 162 may be populated into the RAP-C report 132 (to generate a new report 162), and so the appraiser 152,154 does not have to manually enter in this already-known data when performing step 60. Hence, a client 110 may easily upgrade the non-appraisal Evaluation 131 or Evaluation-L 132 reports to an appraisal RAP-C report 133. The scope of work 133a may indicate where the underlying valuation report for the RAP-C 133 is coming from; for example, it may indicate that the RAP-C is based upon an Evaluation report 131 or Evaluation-L report 132 that is included within the RAP-C report 133, or is based upon another appraisal that was made available to the appraiser 152,154 by the client 110.

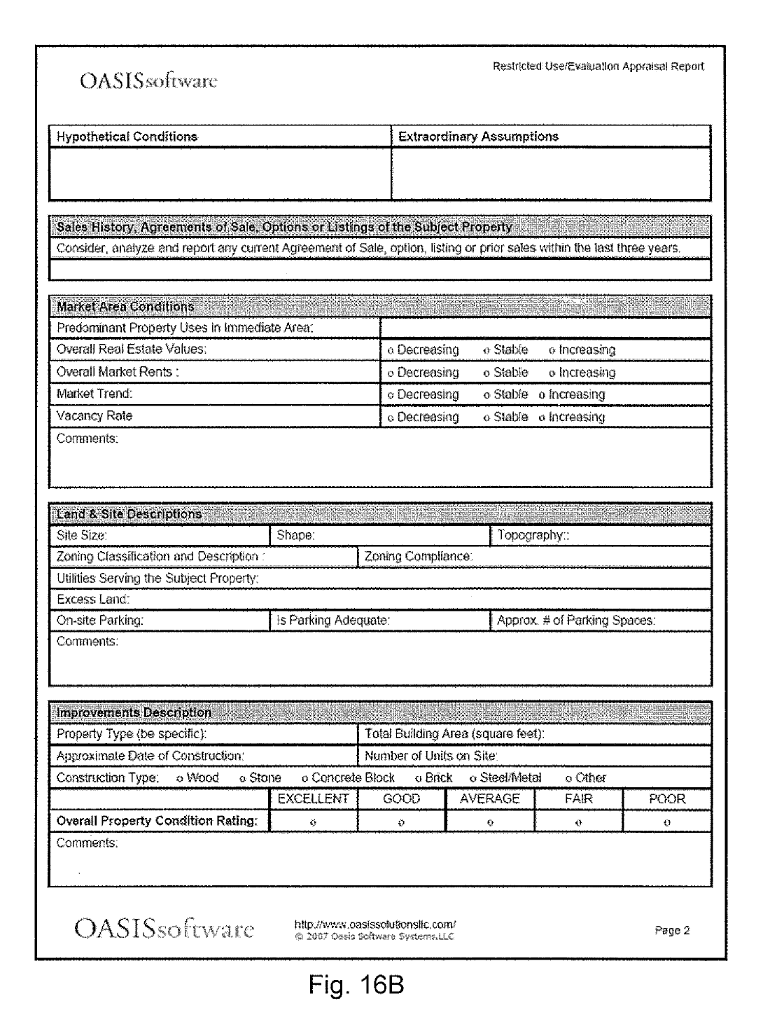

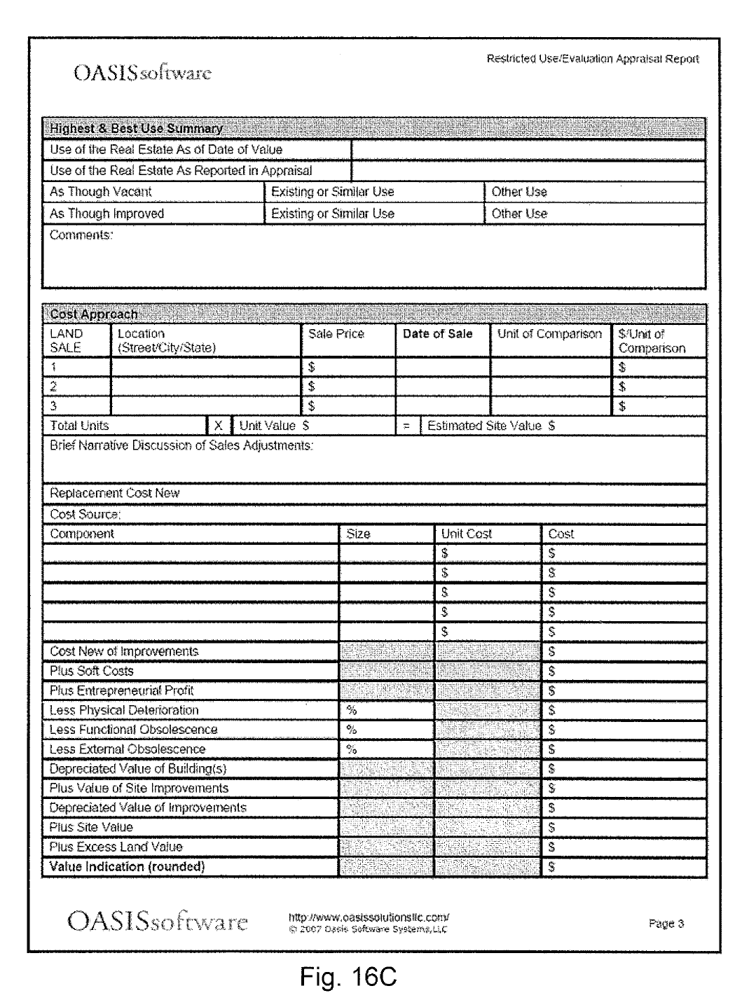

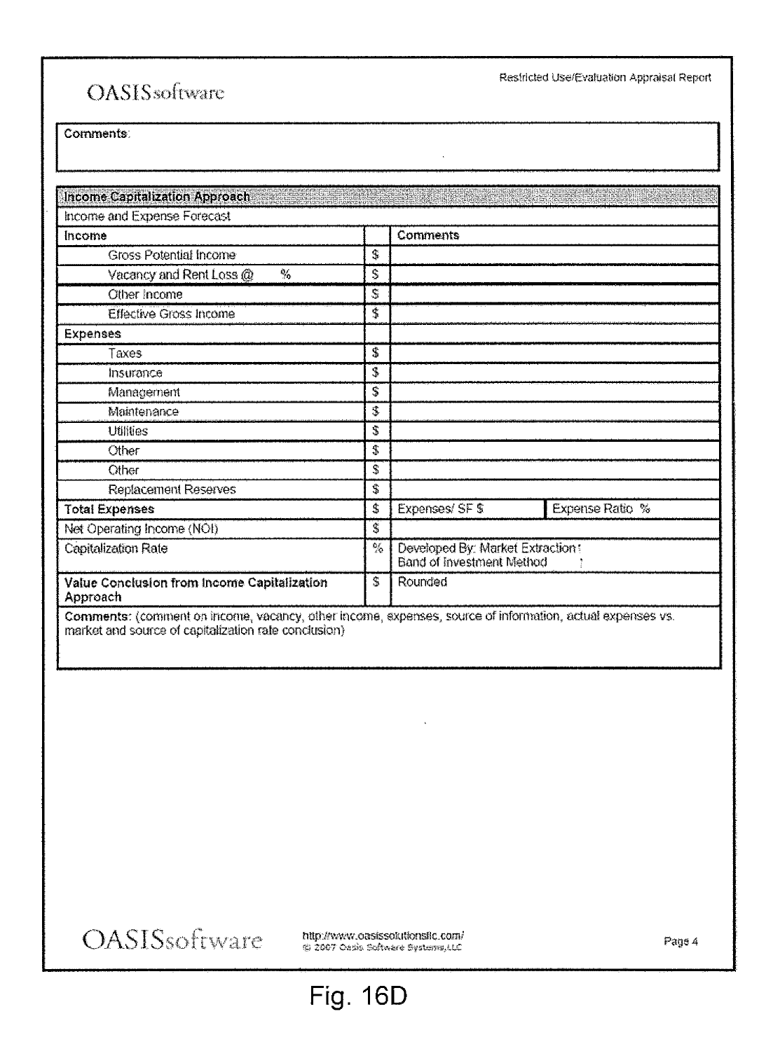

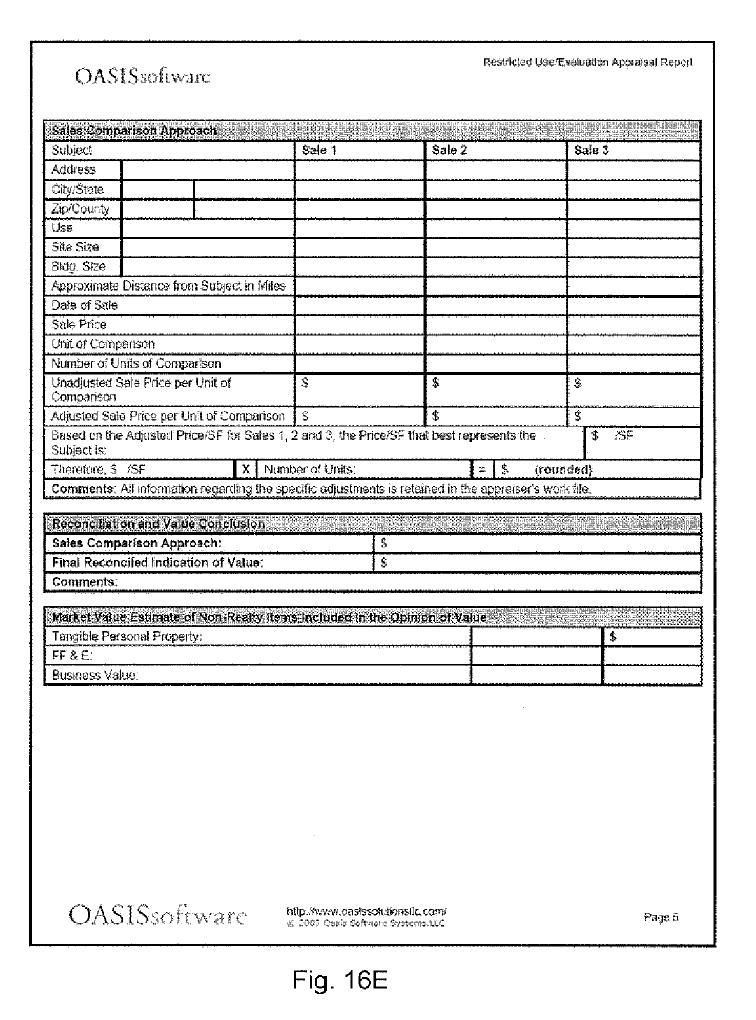

FIGS. 16A-16E illustrate portions of an example format 134b for a Restricted Evaluation Appraisal Report (REAR) 134. Although not shown, the REAR 134 may further include pages to show photographs of various views of the subject property, and a map to show where the subject property is located with respect to other comparable properties. This report may be thought of as an entry-level appraisal report that may be used on a new assignment. As with the RAP-C report 133, the REAR 134 is preferably restricted to a single client 110, and is not intended for external distribution. The REAR 134 is designed to be fully compliant with appraisal requirements as well as requirements imposed upon financial institutions by regulatory agencies. Because it is a formal appraisal document, the REAR 134 is ideally performed by a certified appraiser. The REAR 134 is a combination of an Evaluation 131 (which has more detail of the subject and market) and a Restricted Appraisal Report (which can have no to little detail on the subject or market). In many cases, Restricted Appraisals can not be reviewed because they have little to no reviewable content. The REAR 134 can be reviewed and is an appraisal.

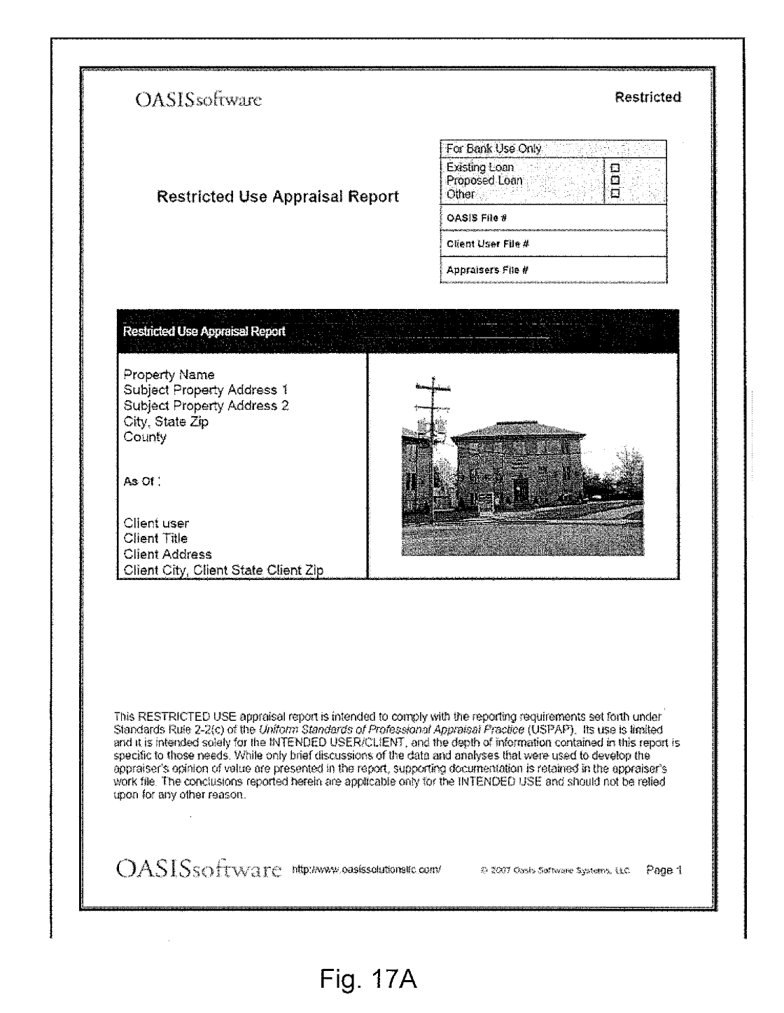

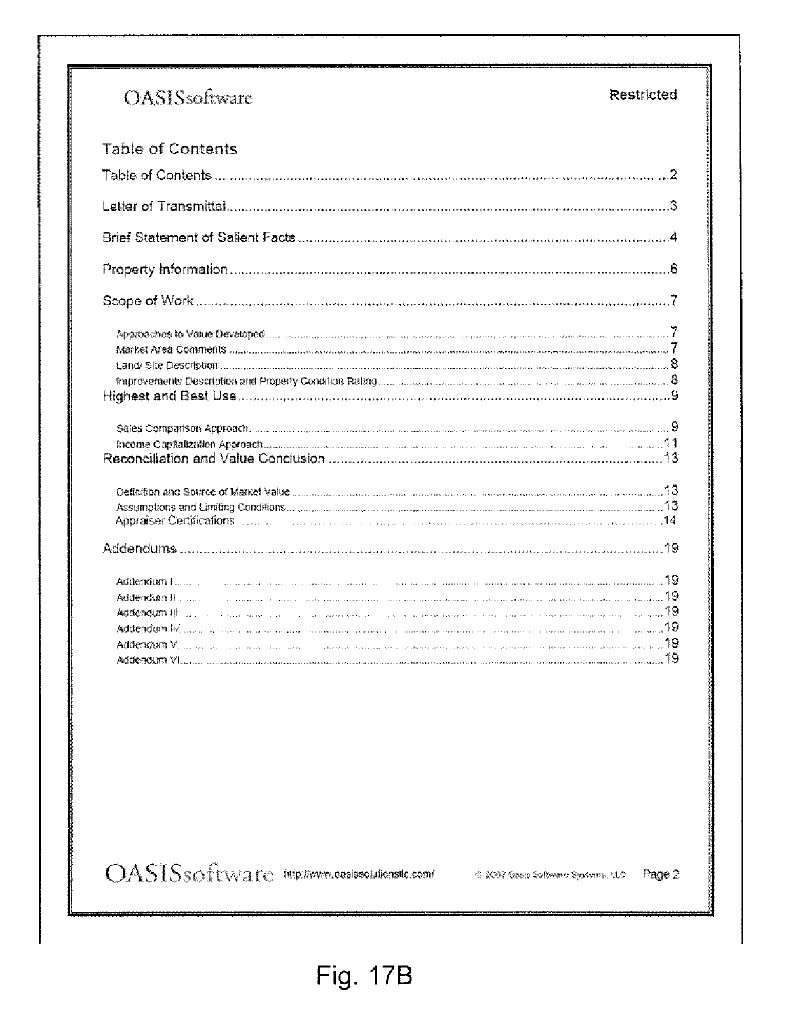

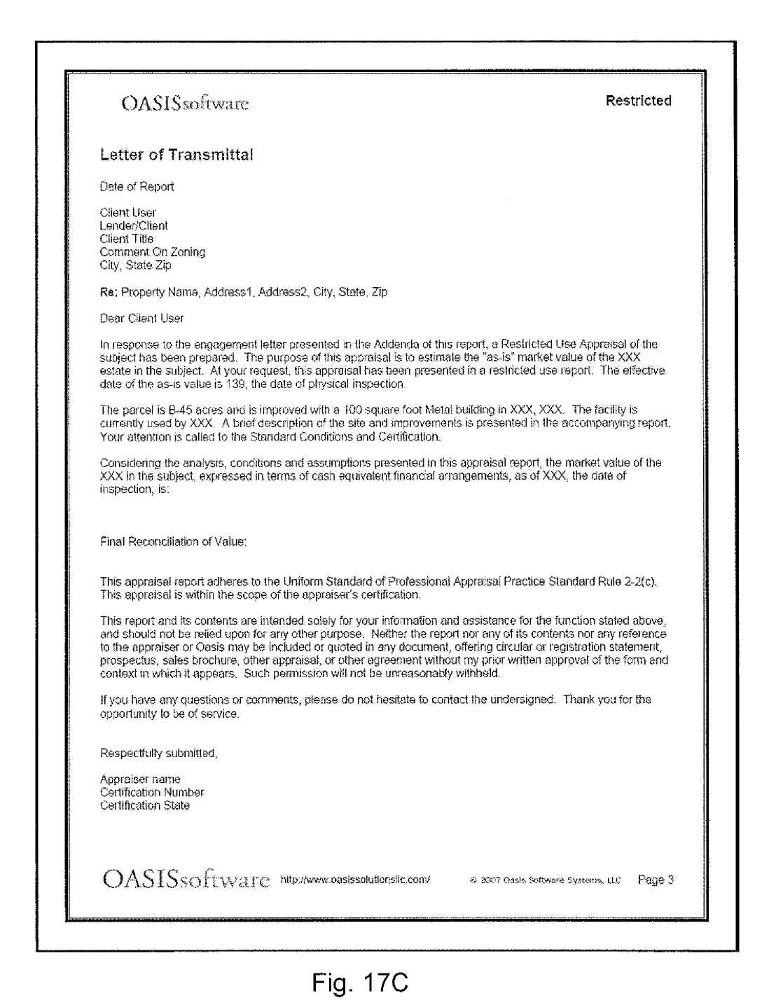

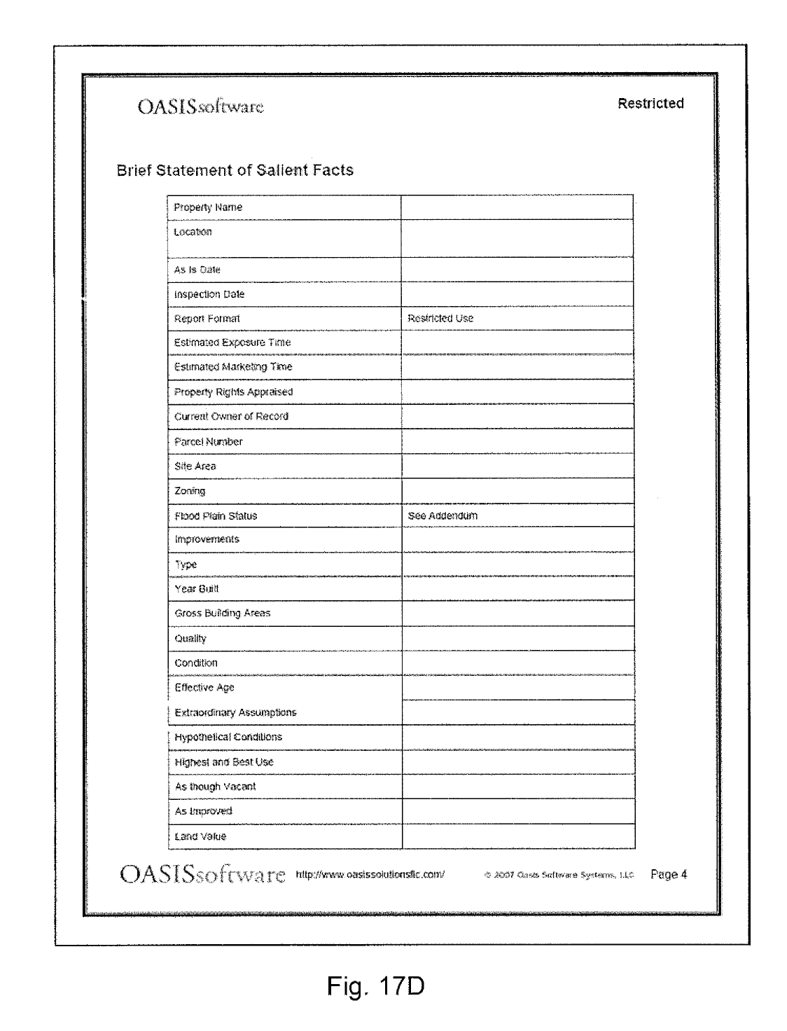

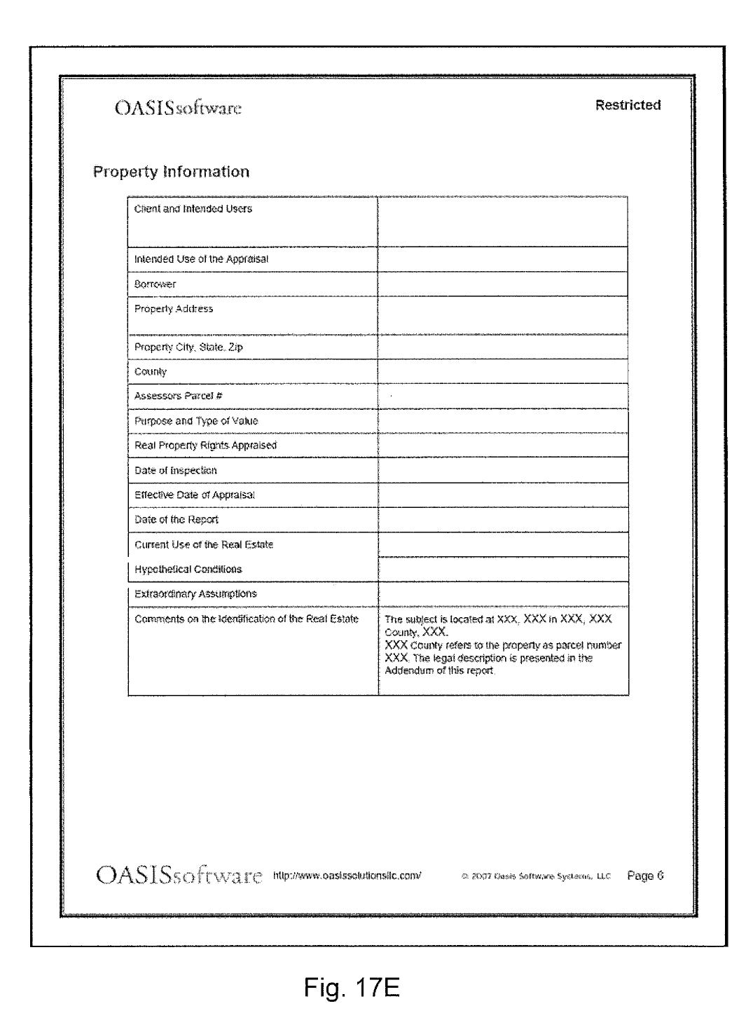

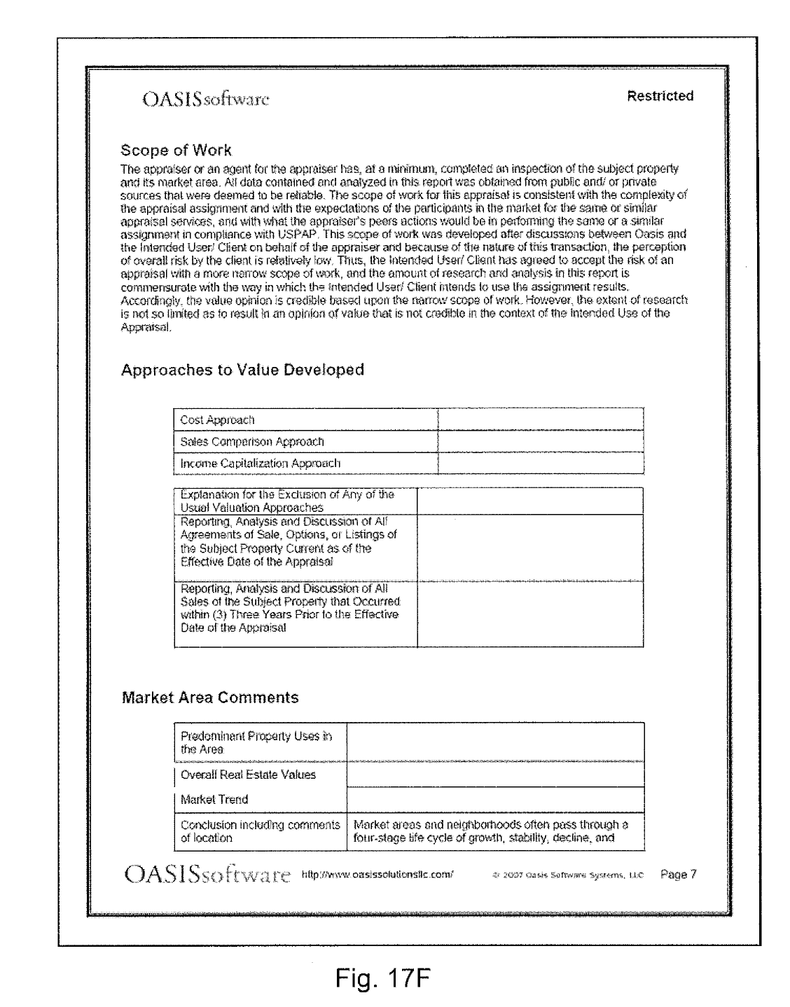

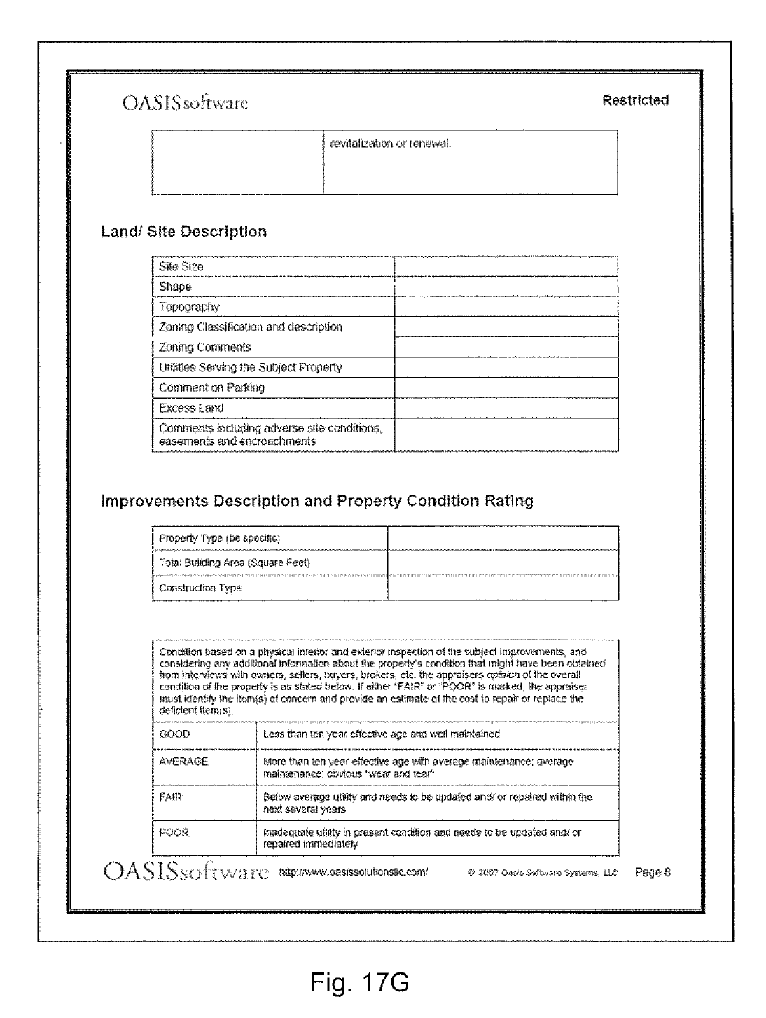

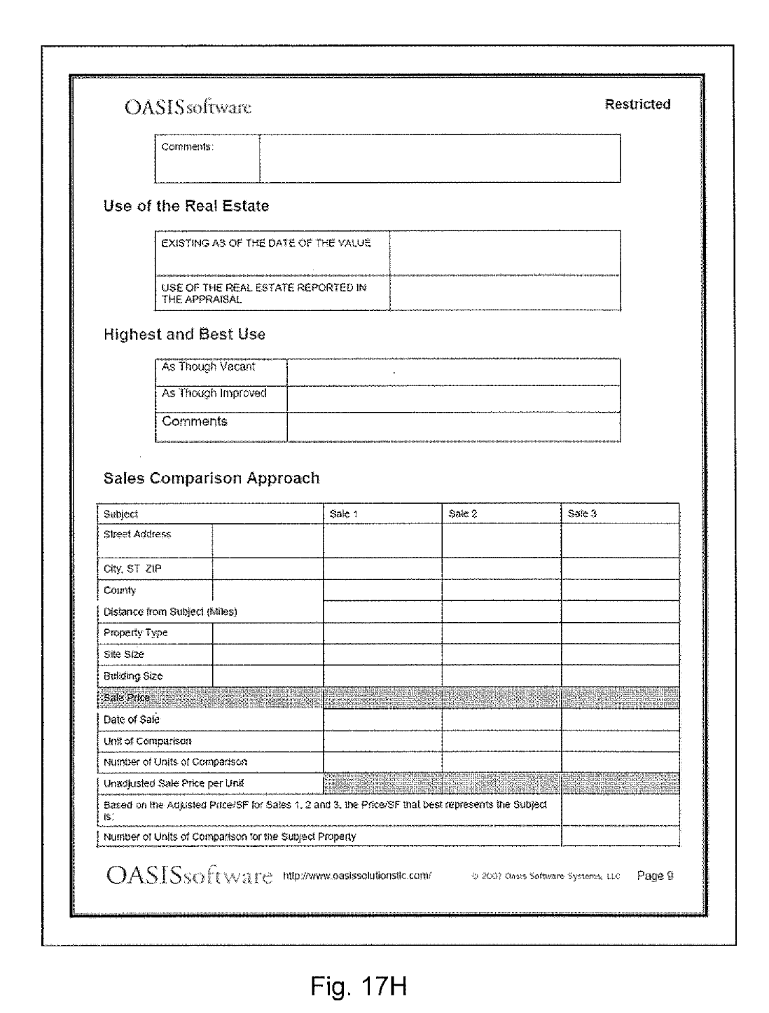

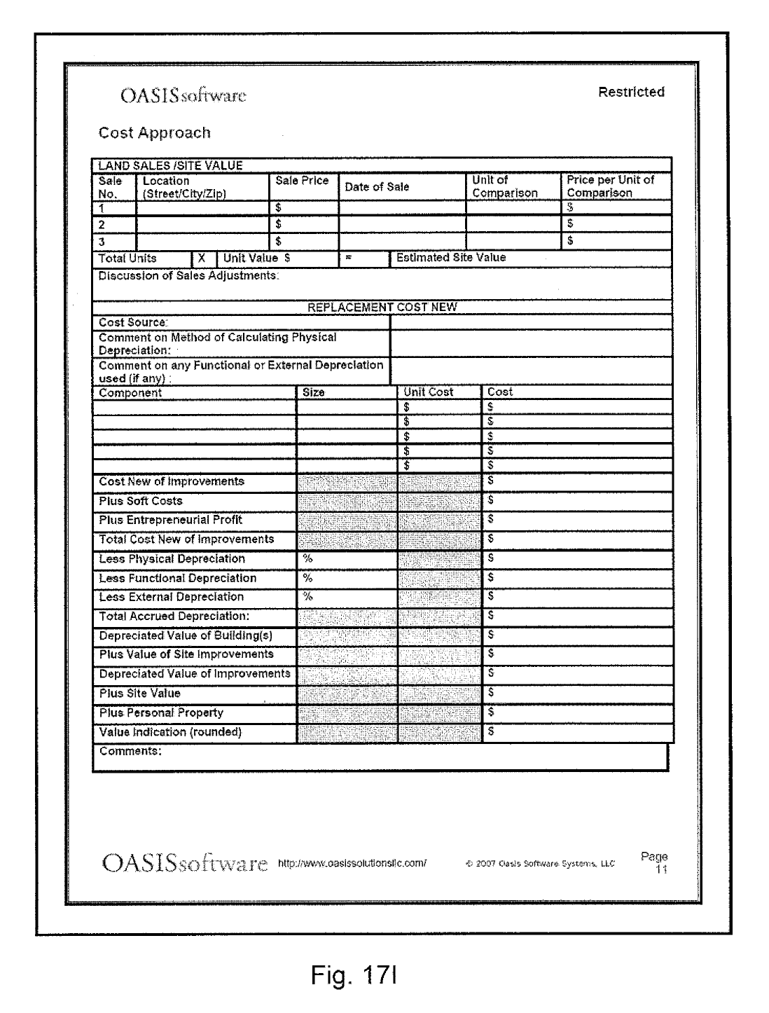

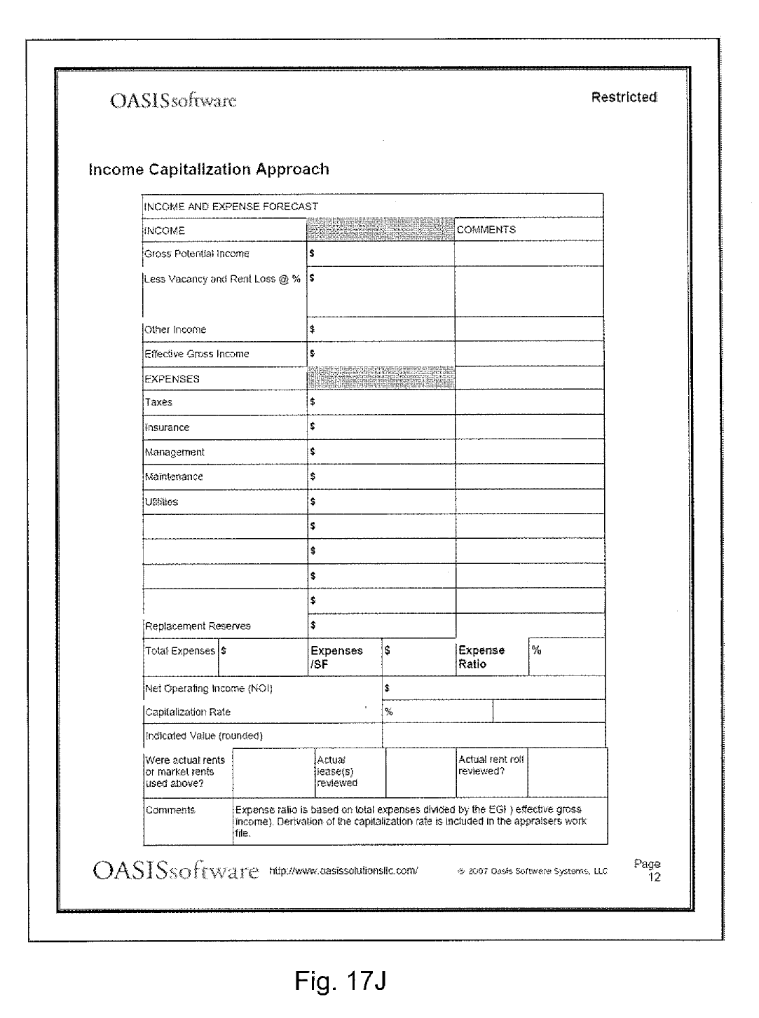

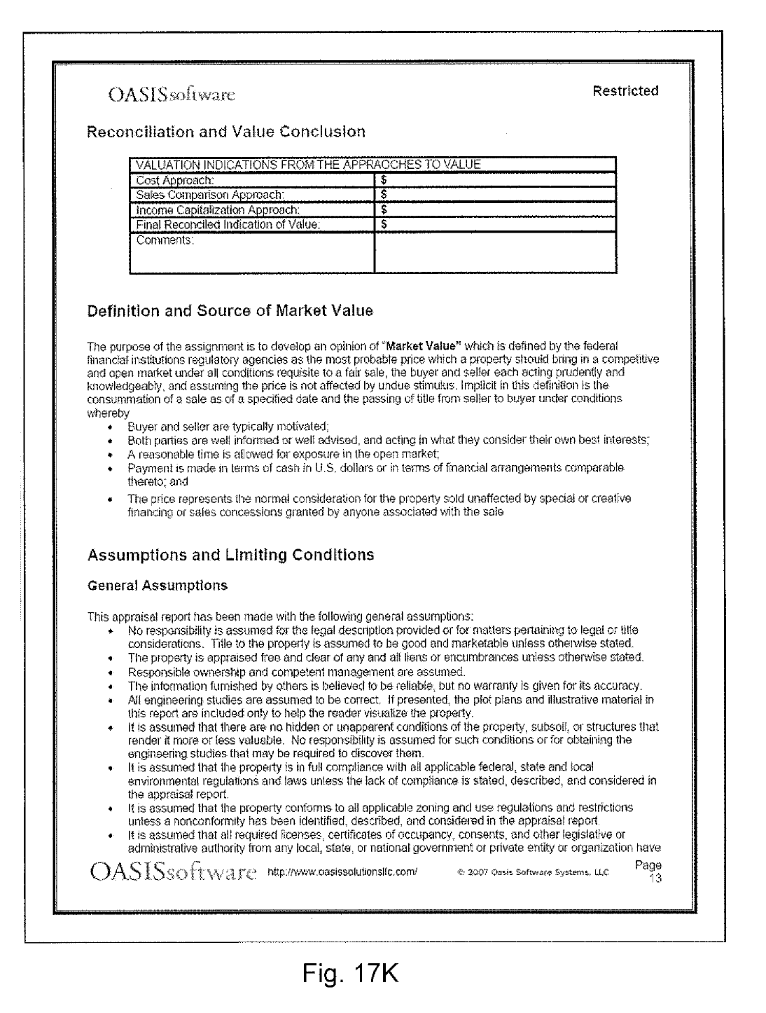

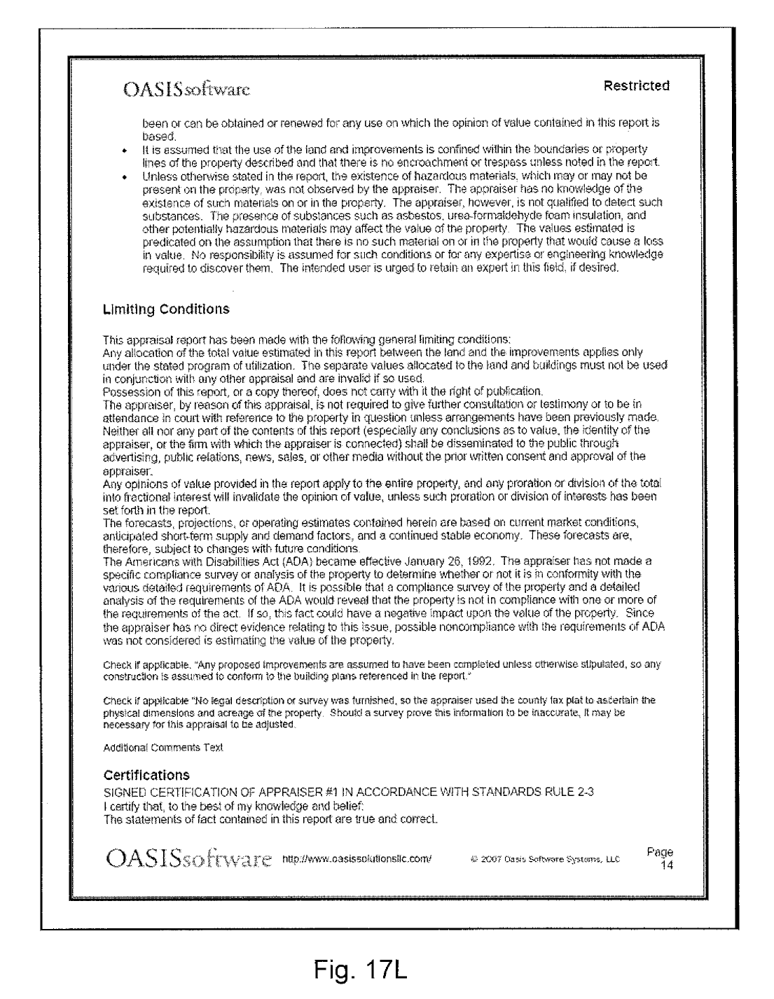

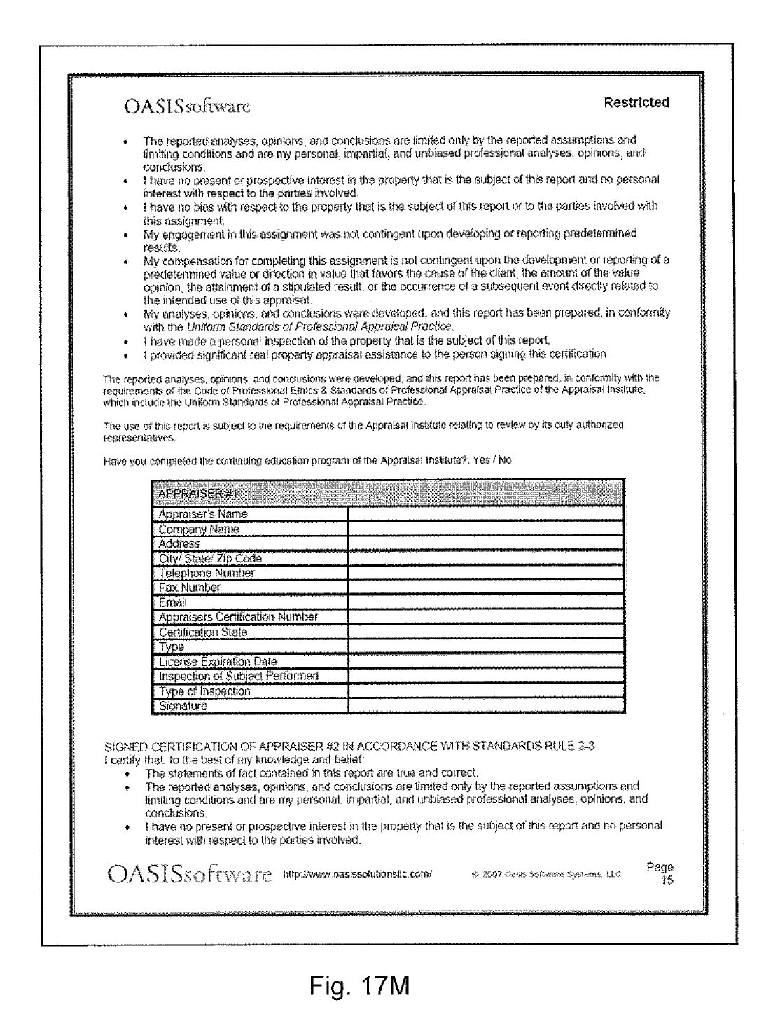

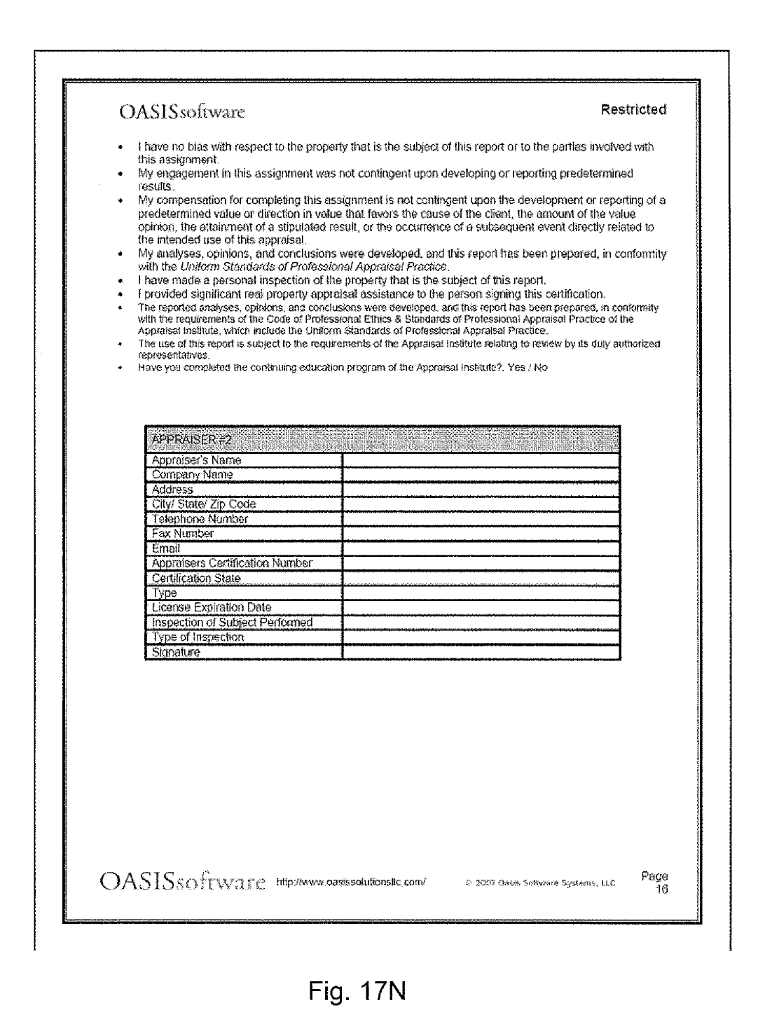

FIGS. 17A-17O illustrate portions of an example format 135b for a Restricted Use Appraisal (“Restricted”) report 135. The Restricted report 135 is the entry level reporting for an appraisal assignment which has no other valuation information or reports relied upon by the appraiser 152,154 of this new assignment. Although not shown, the Restricted report 135 may further include pages to show photographs of various views of the subject property, photographs of comparable properties, and a map to show where the subject property is located with respect to the comparable properties. The Restricted report may provide a second-level reporting for an appraisal assignment rather than an entry-level reporting as offered by the REAR report 134. As with the RAP-C report 133 and REAR report 134, the Restricted report 135 is preferably restricted to a single client 110, and is not intended for external distribution. The Restricted report 135 has greater appraisal detail than the REAR report 134, and so may be better suited for higher-risk situations.

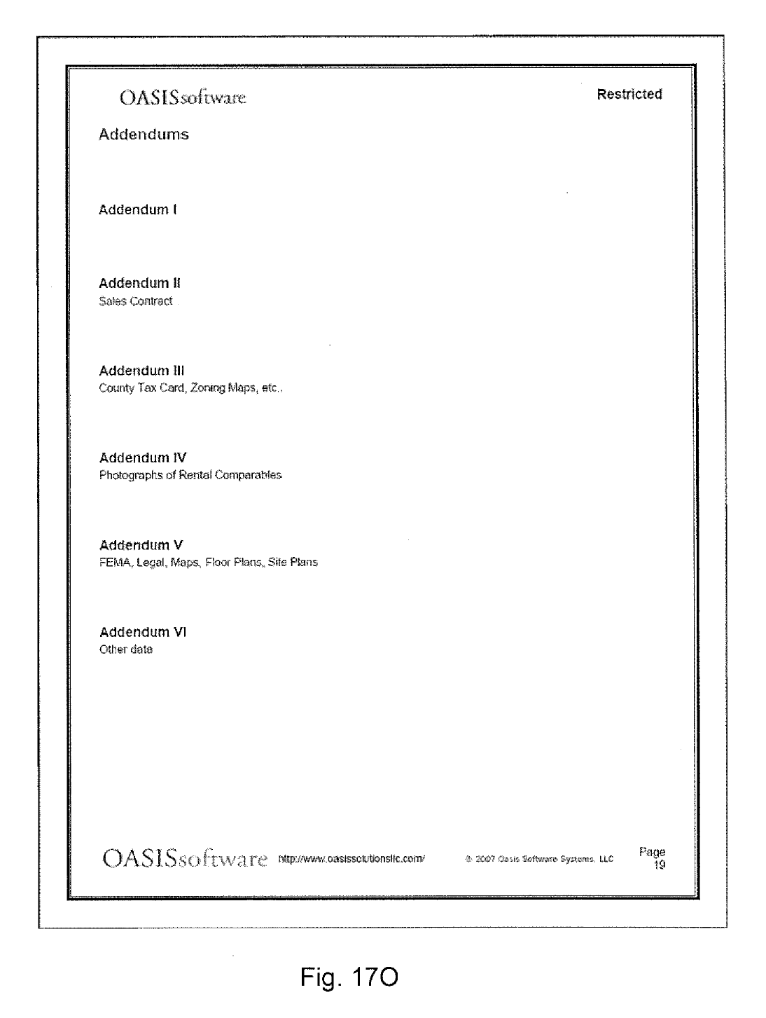

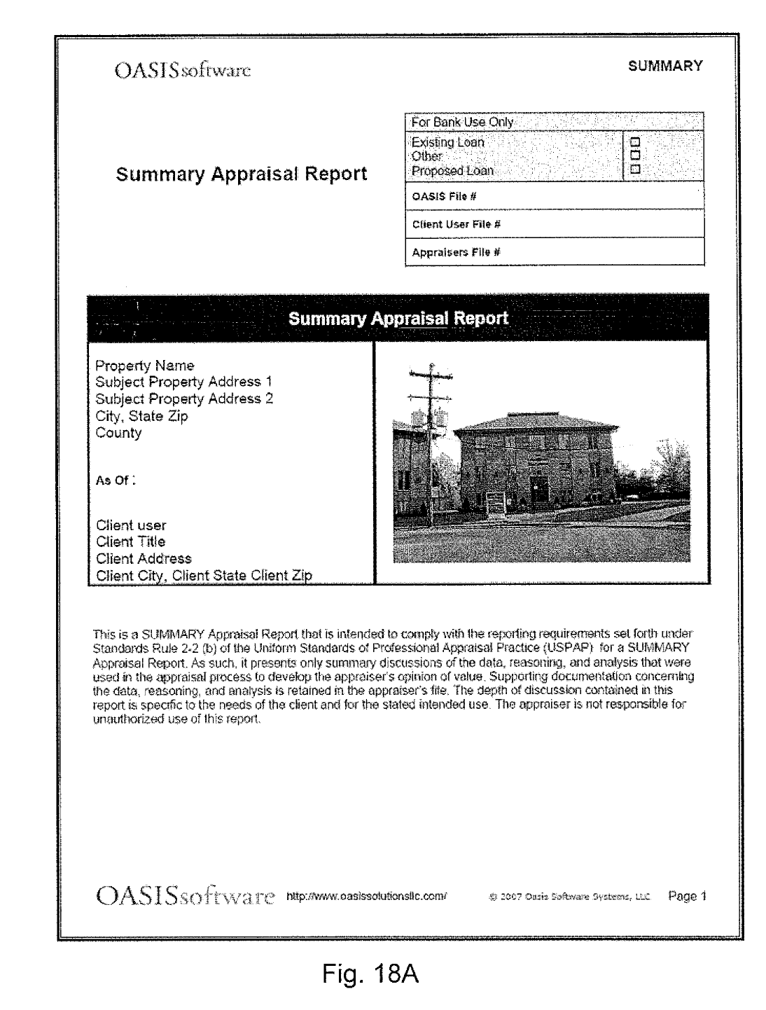

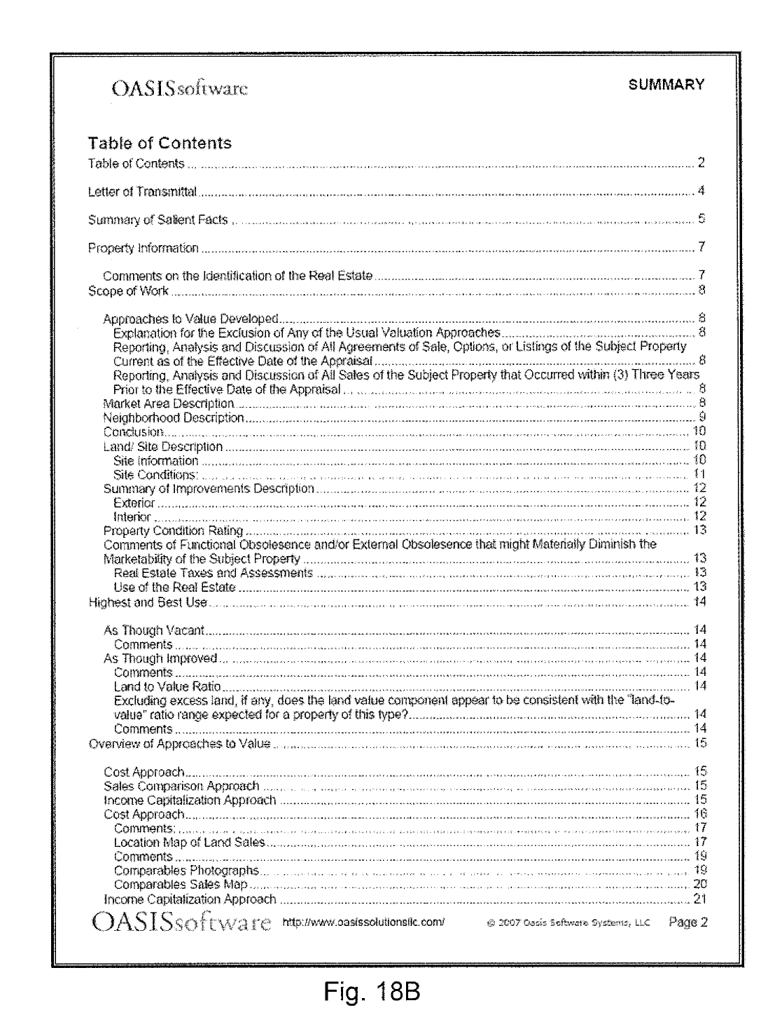

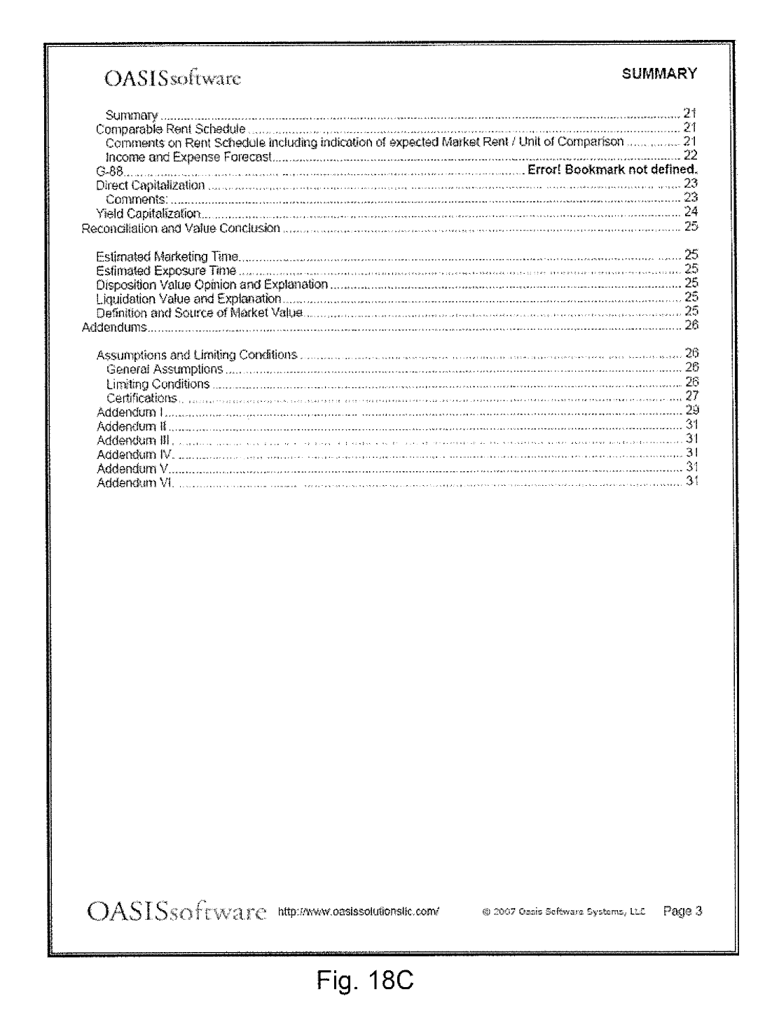

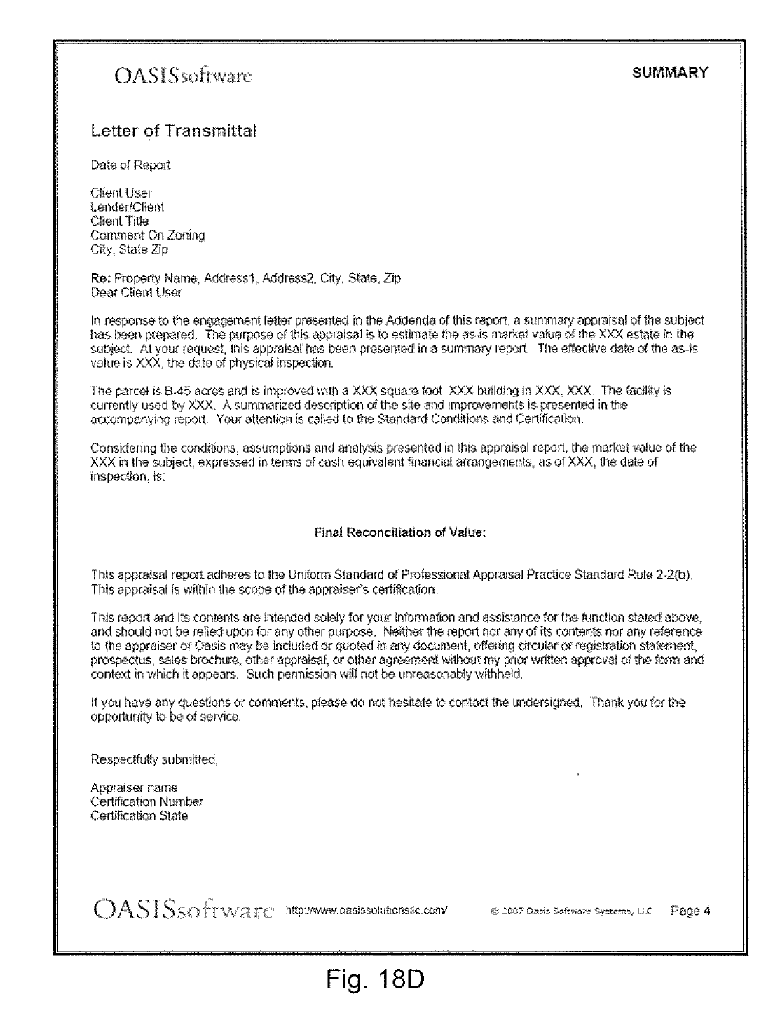

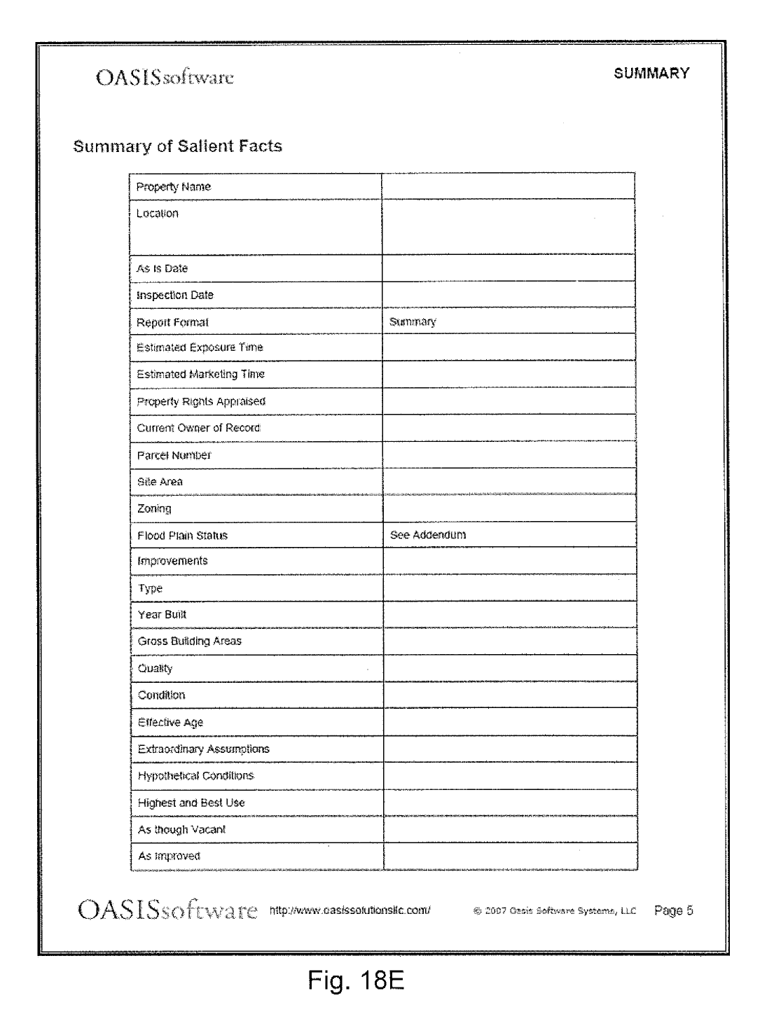

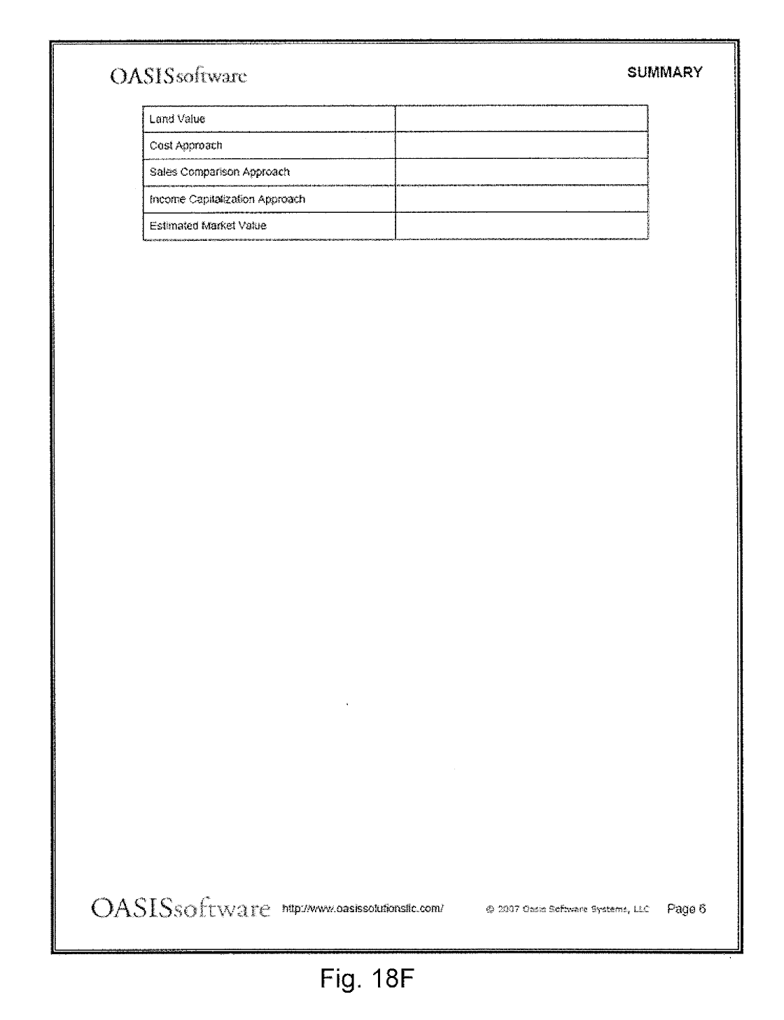

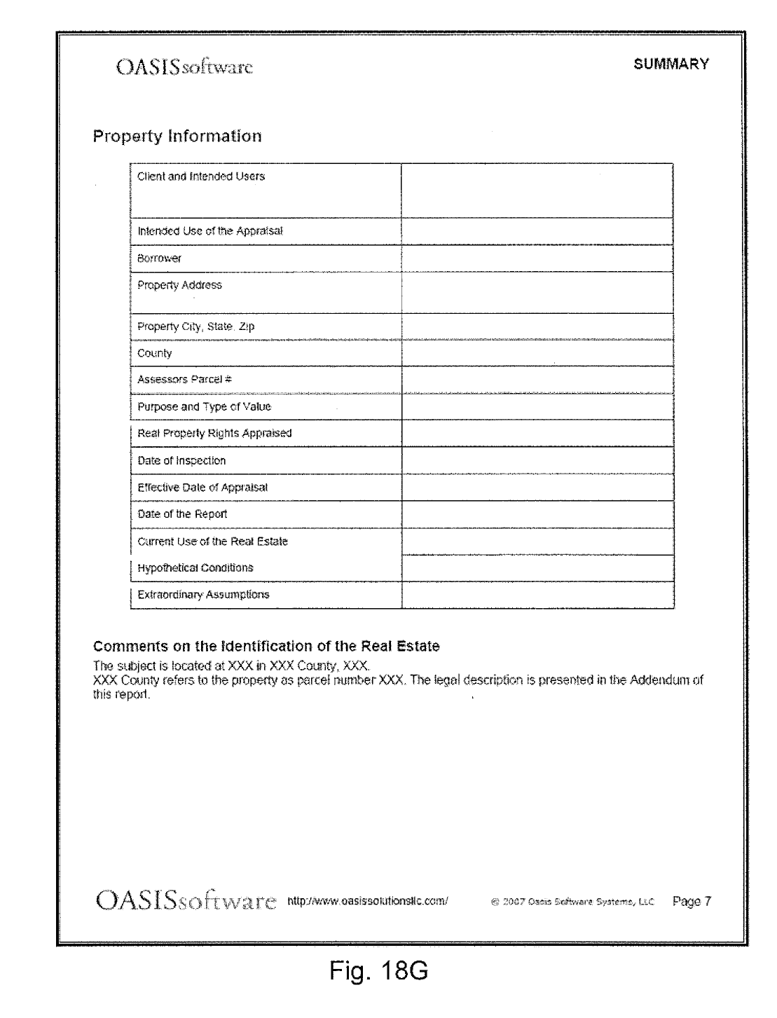

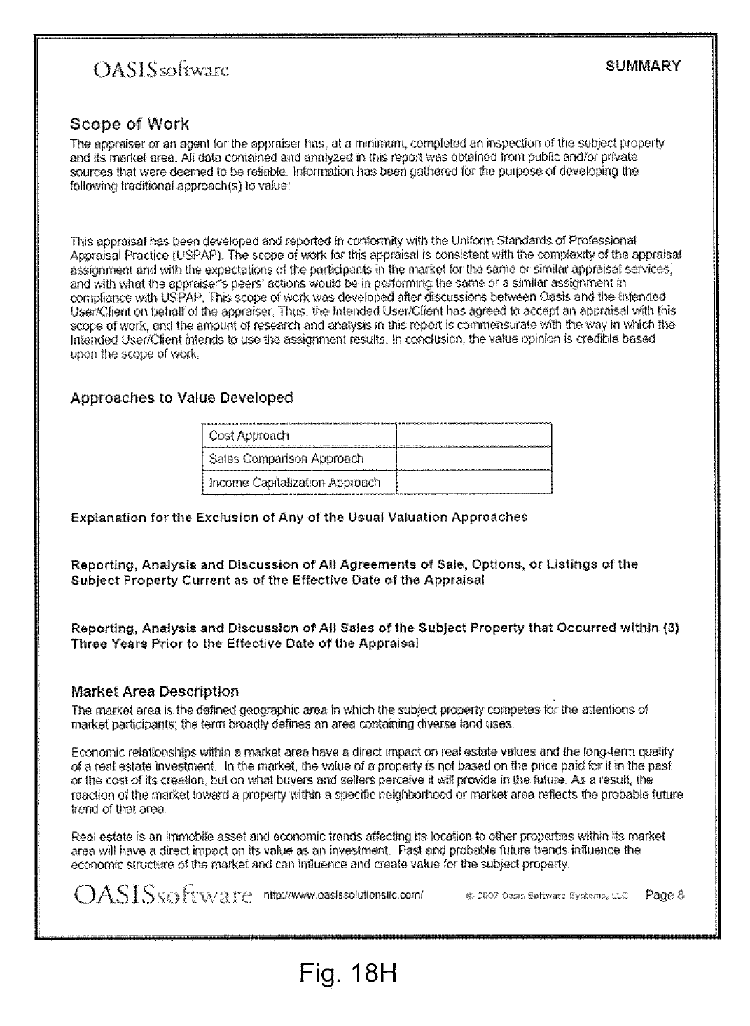

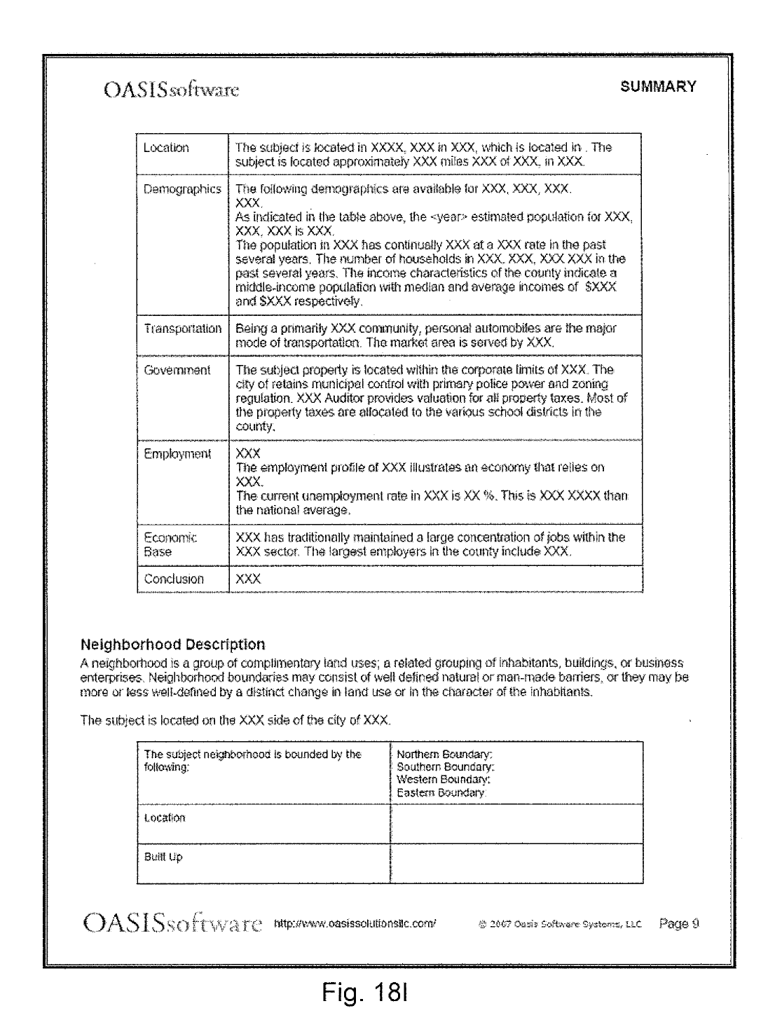

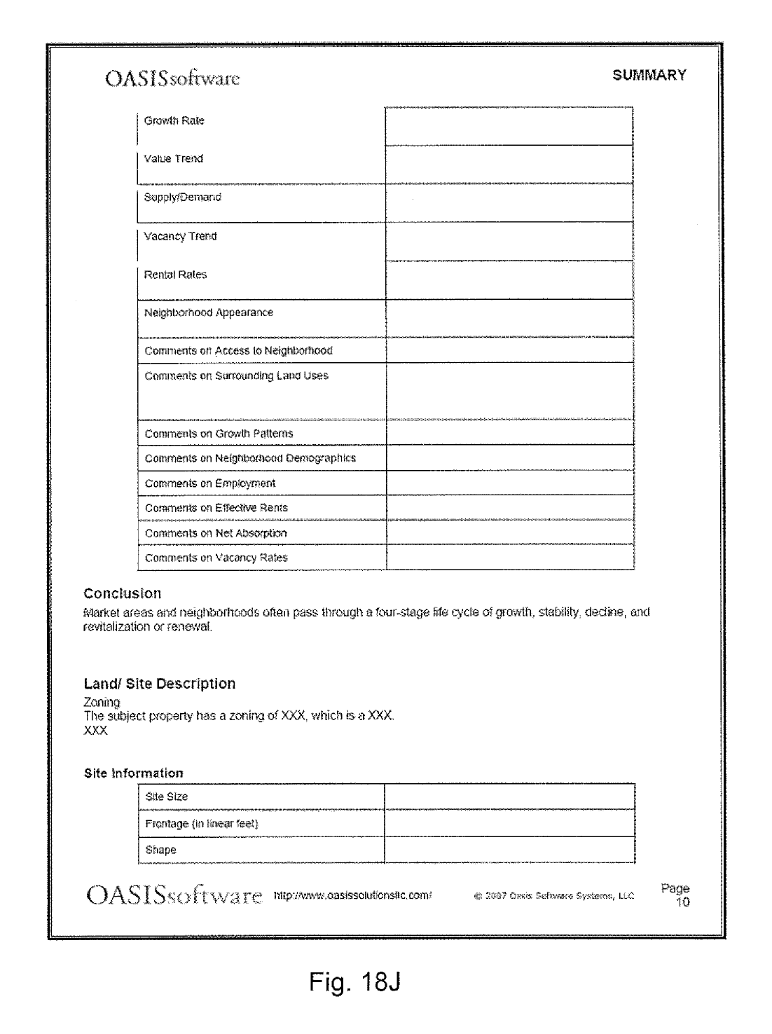

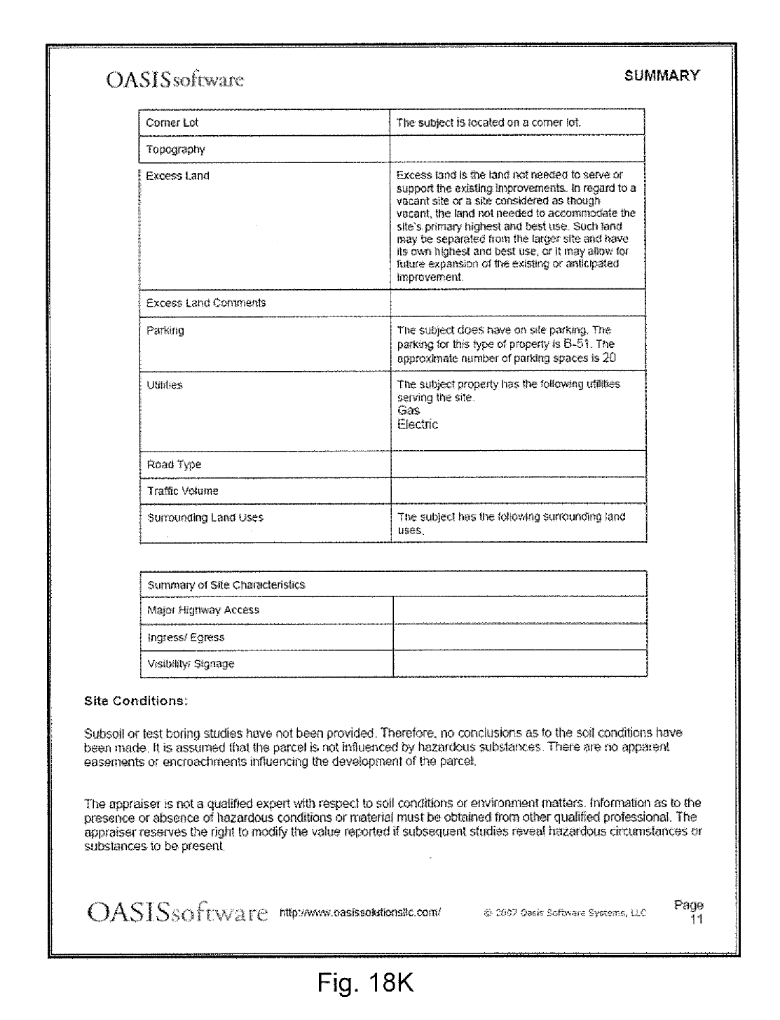

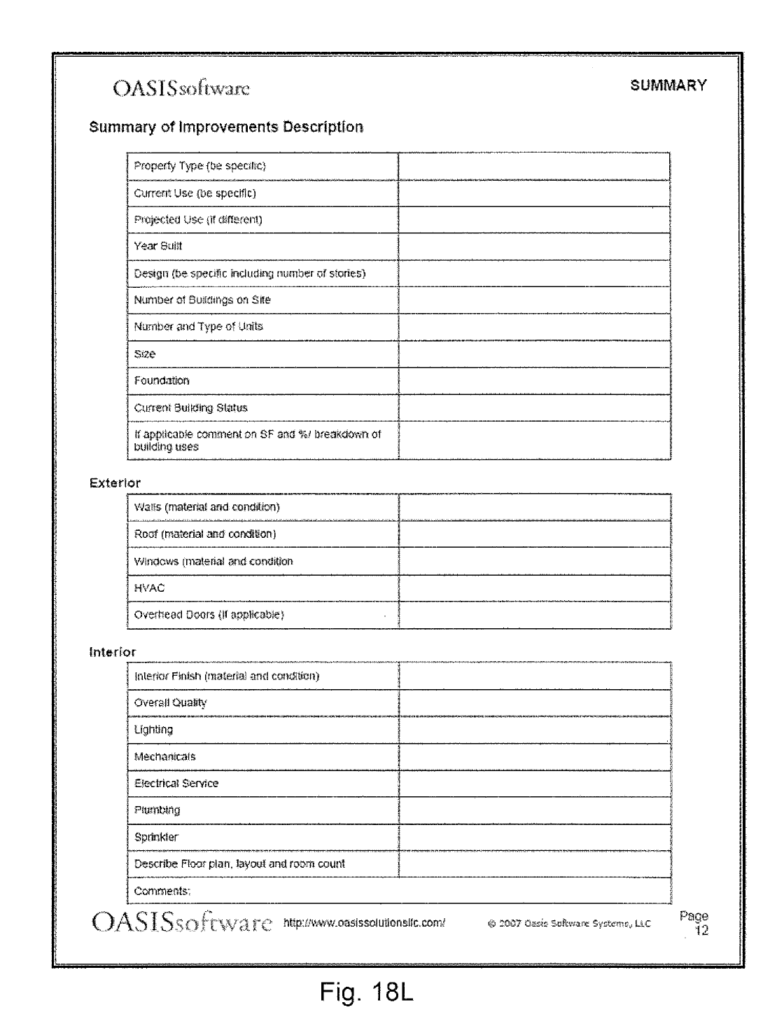

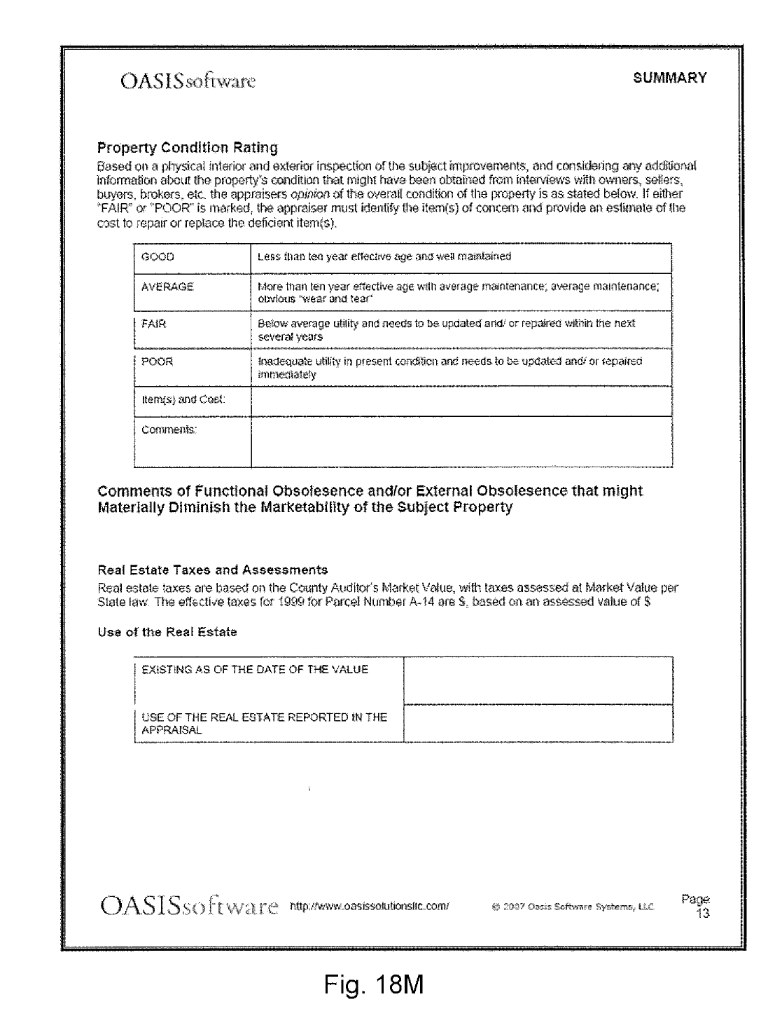

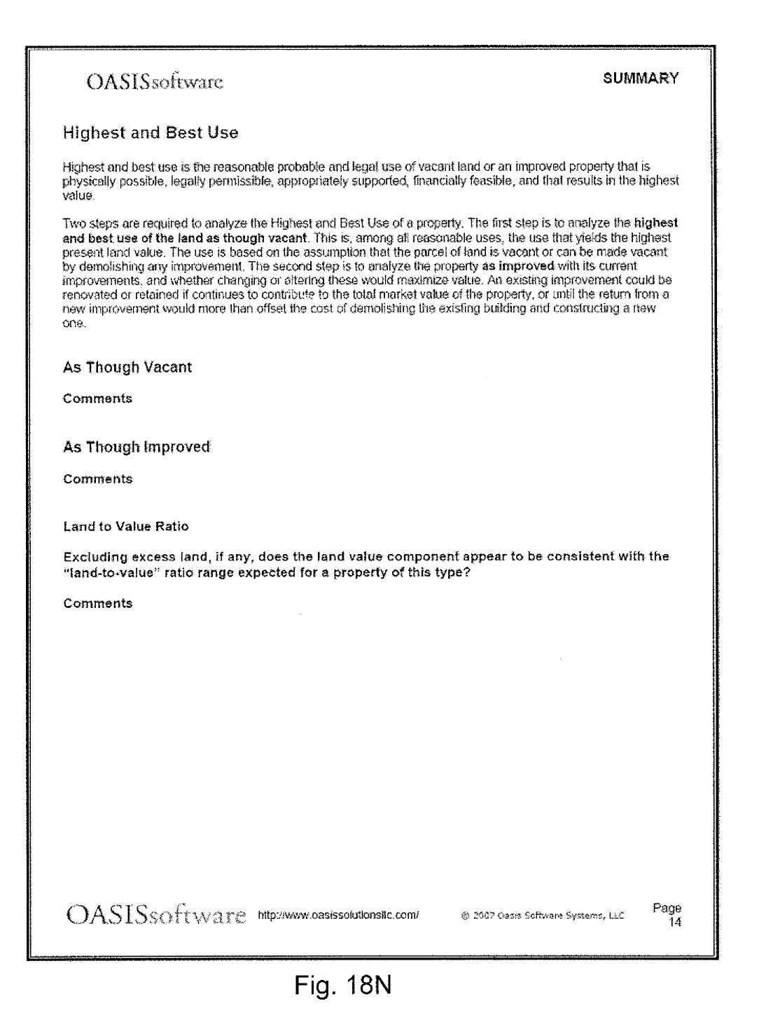

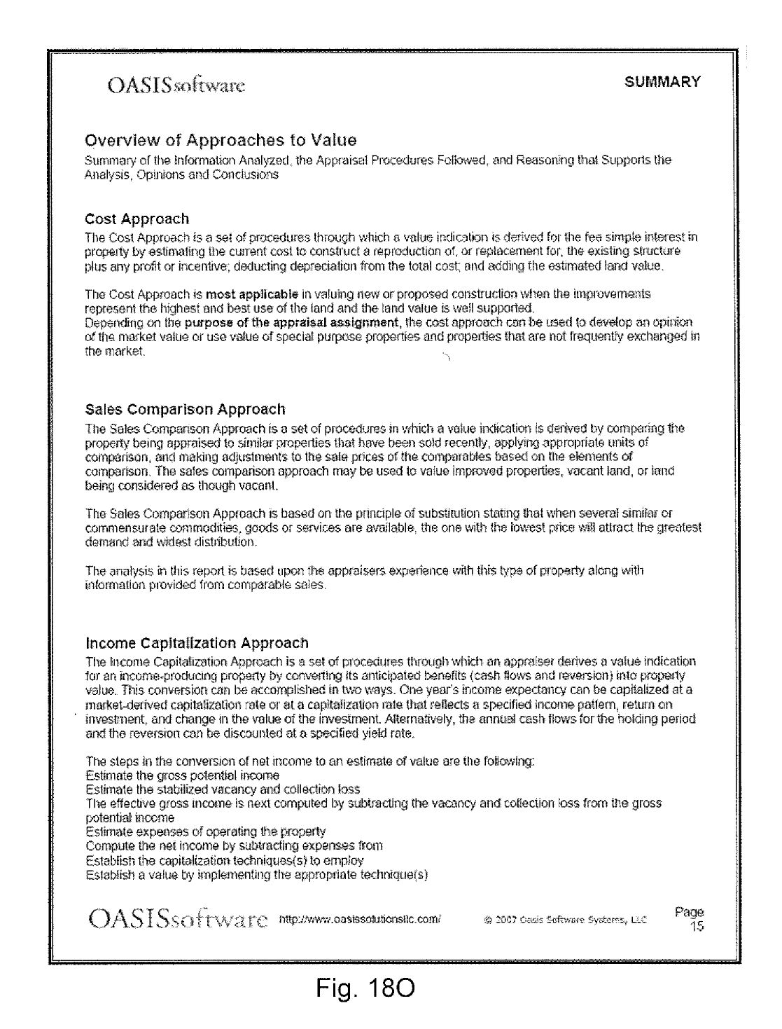

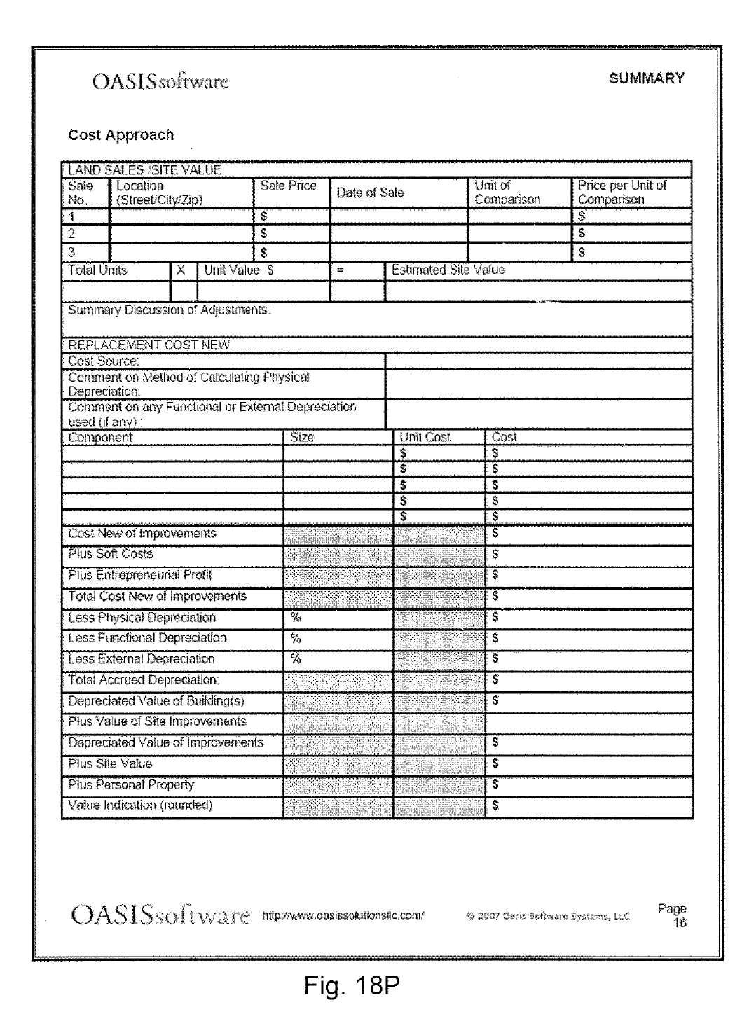

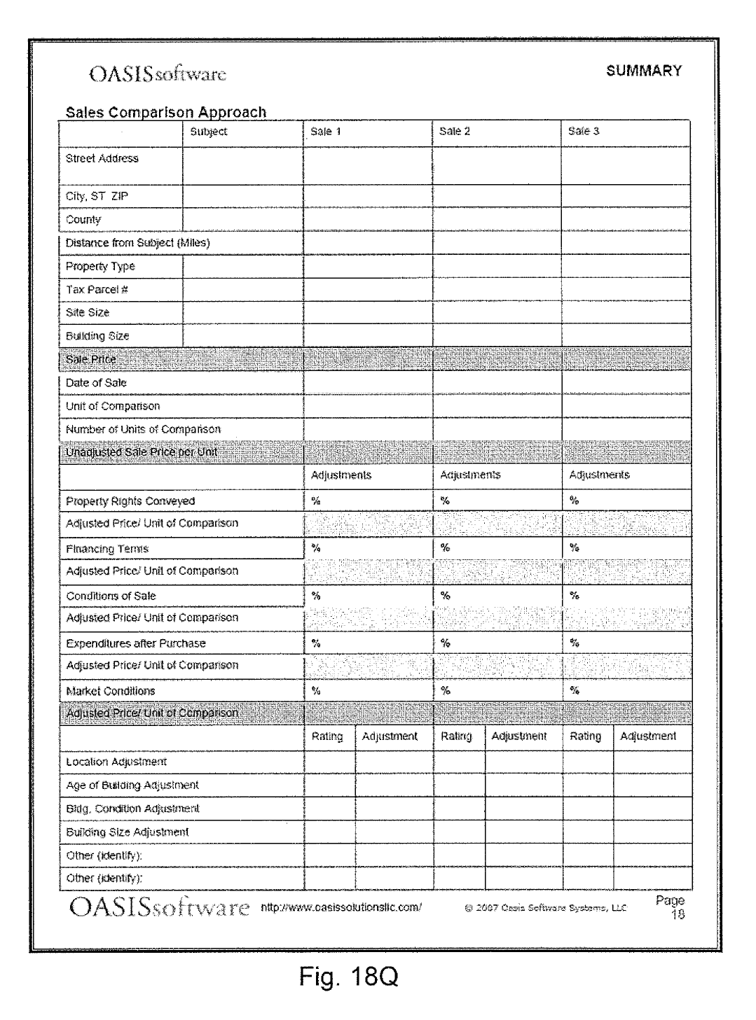

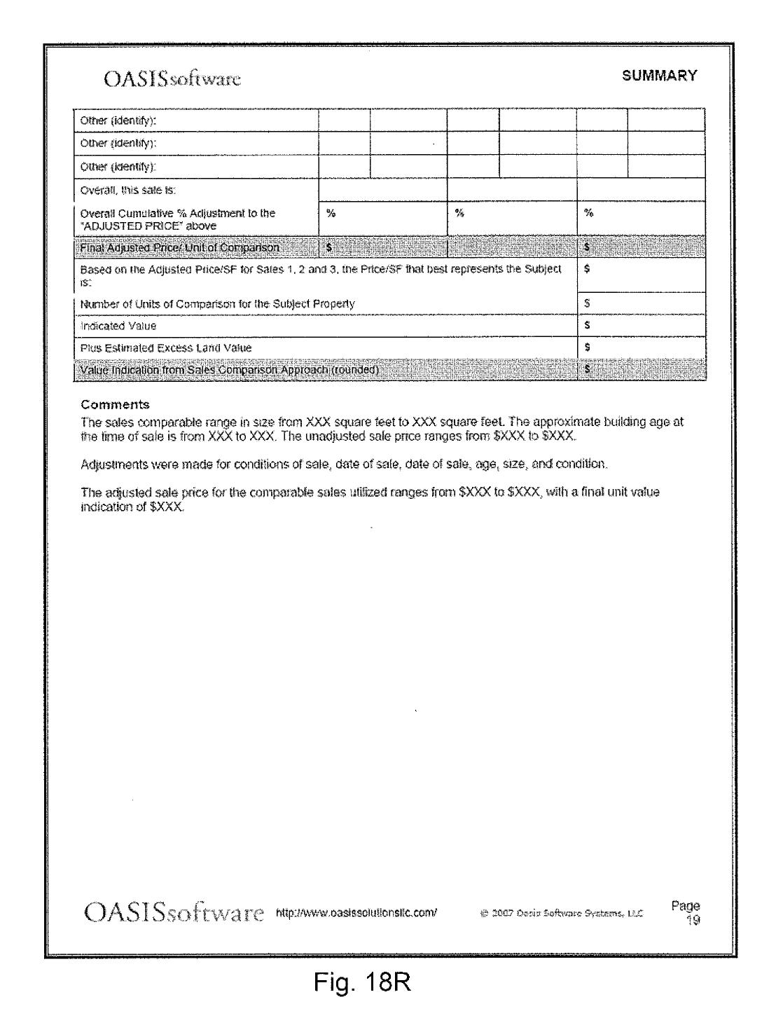

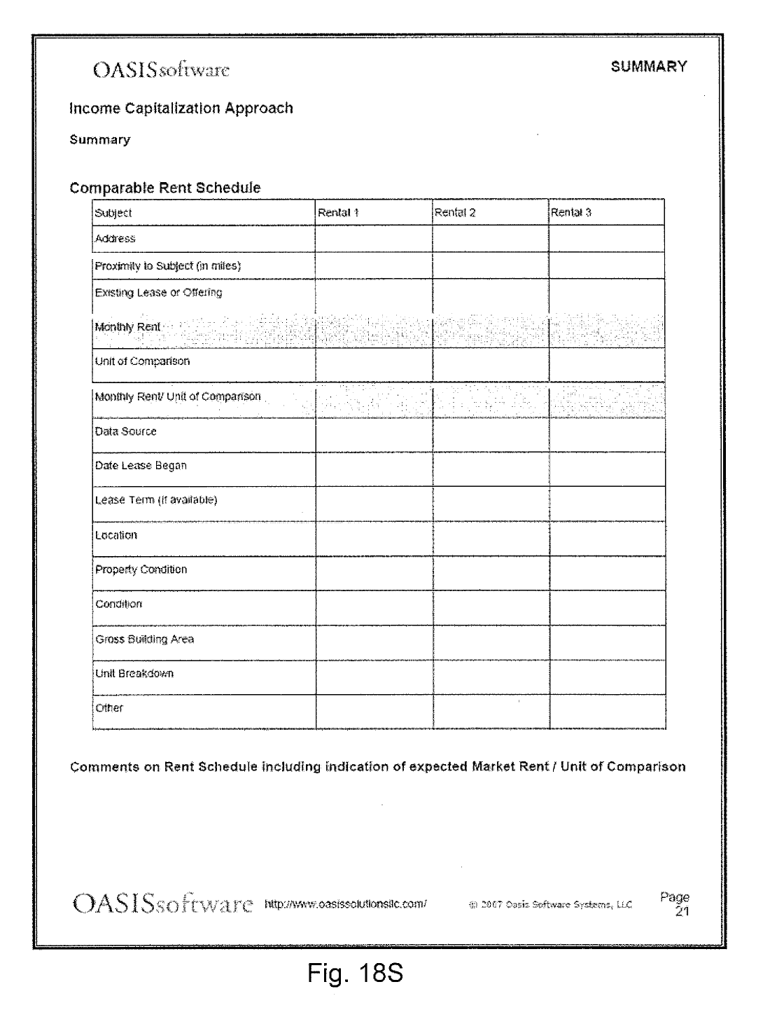

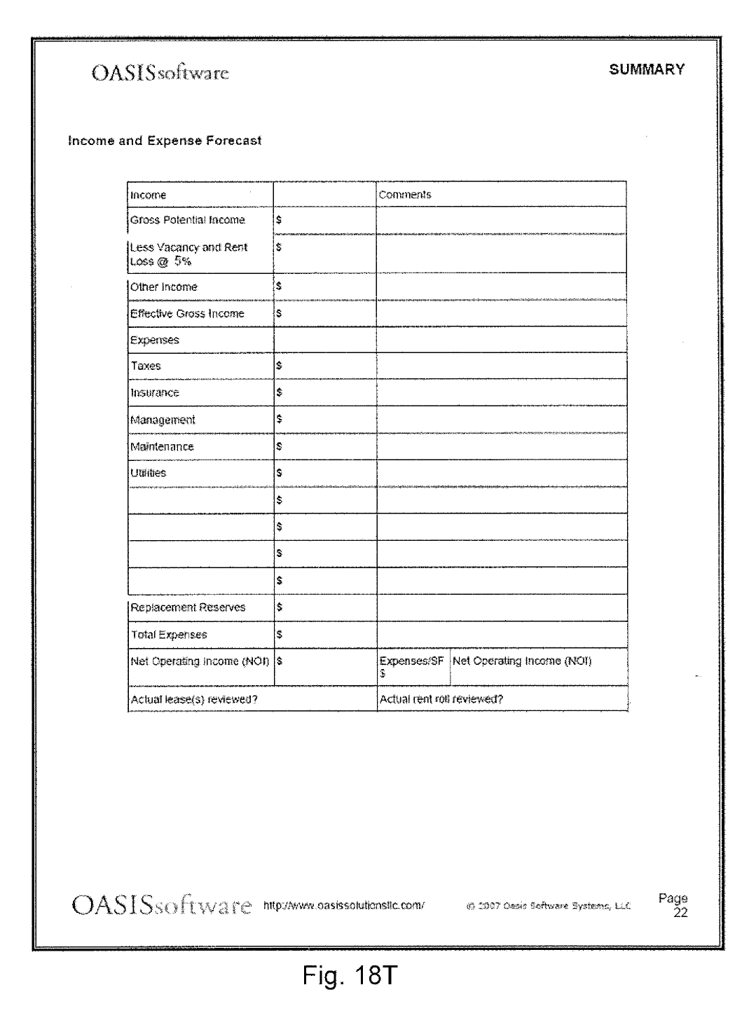

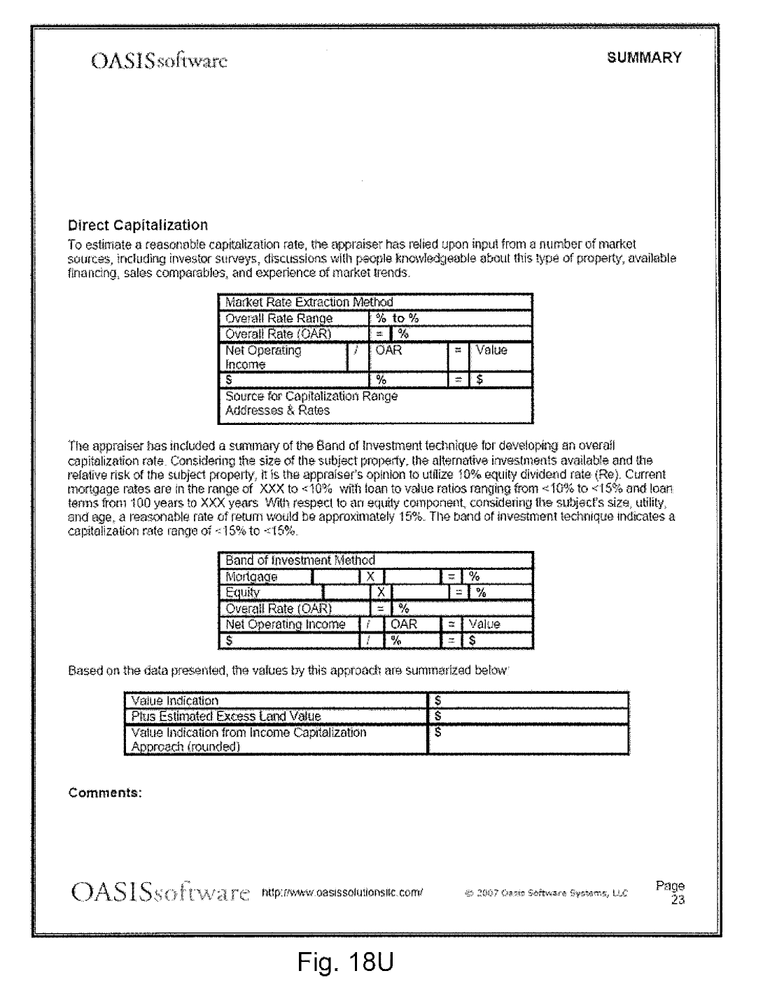

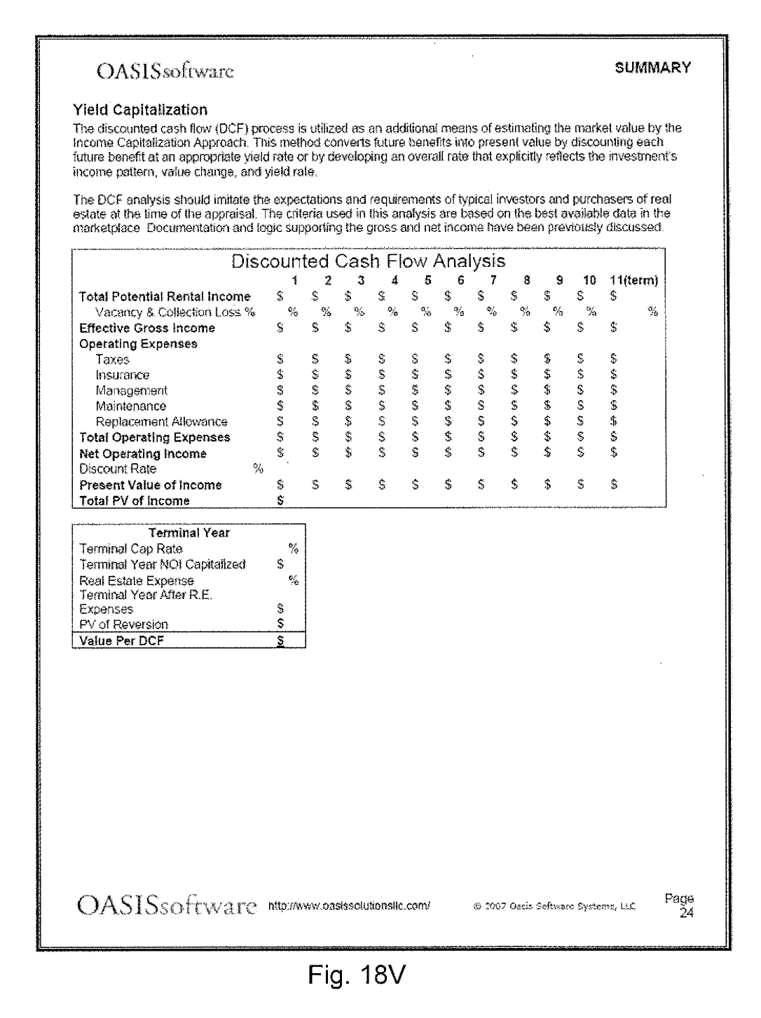

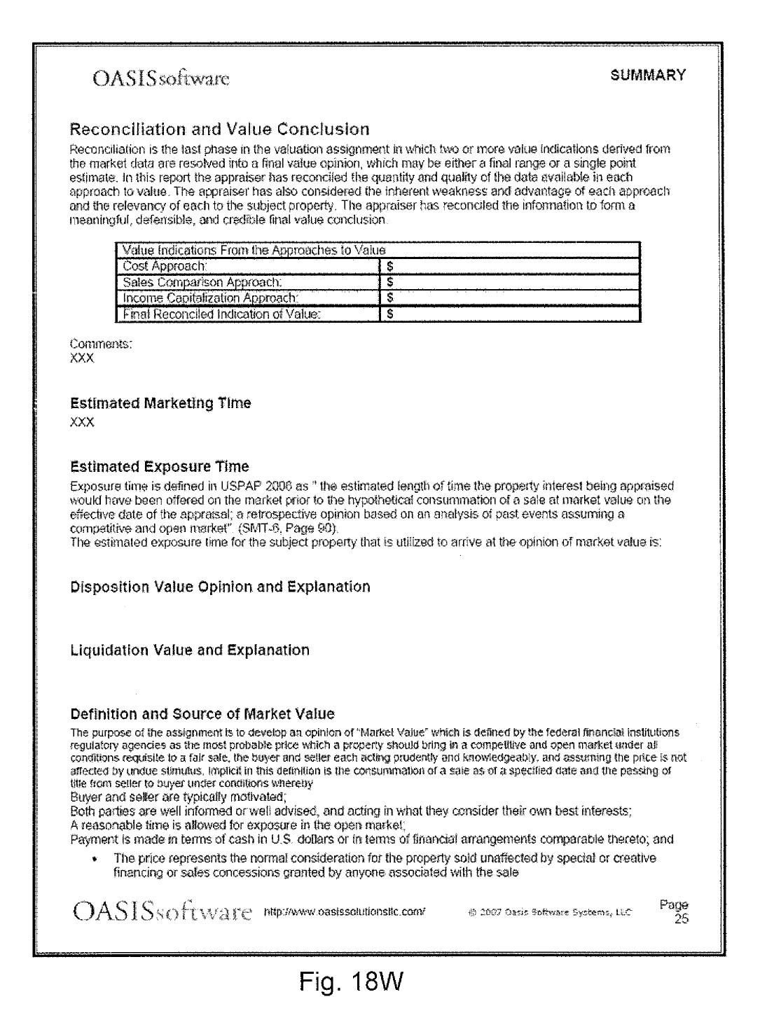

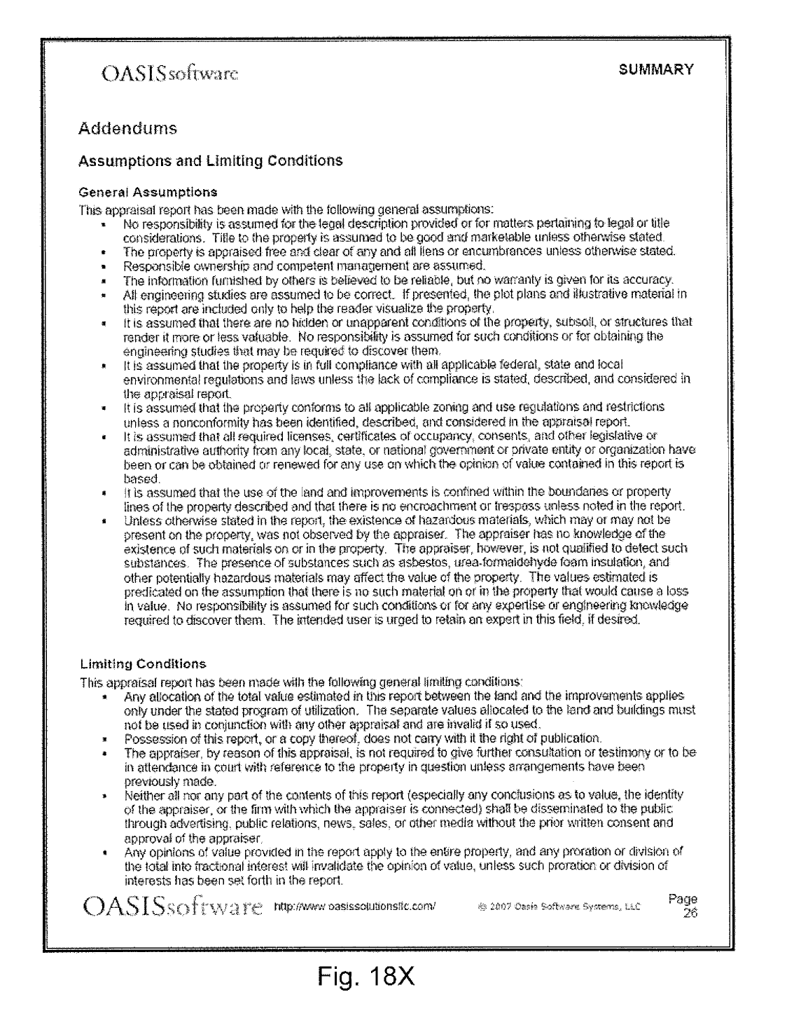

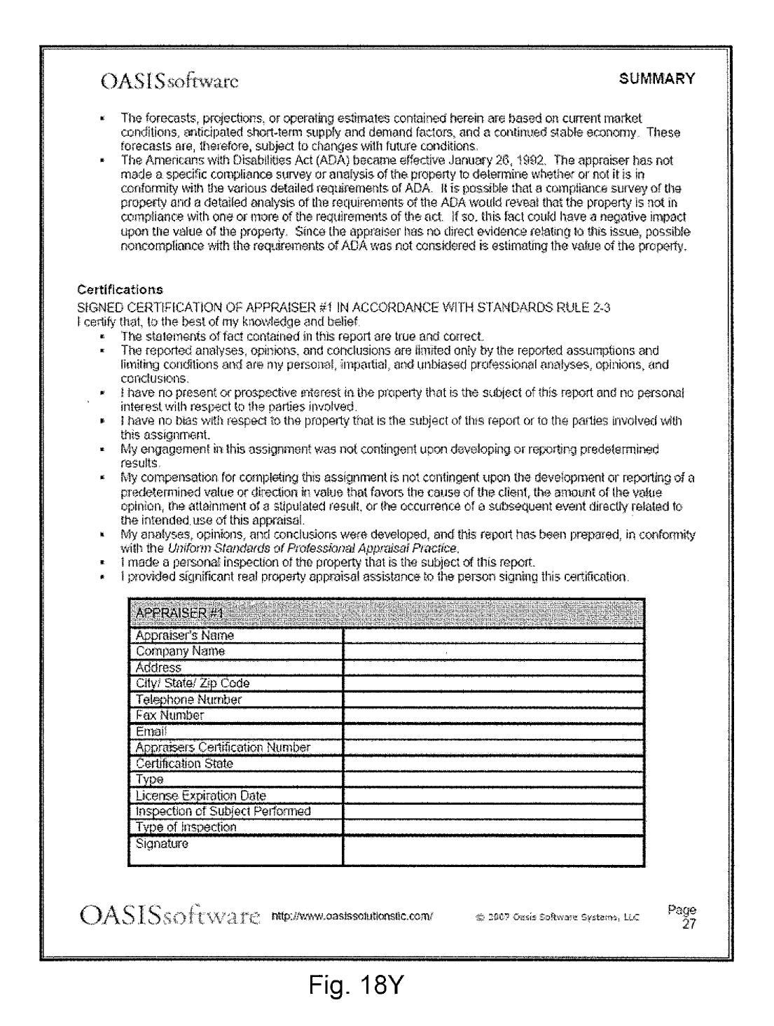

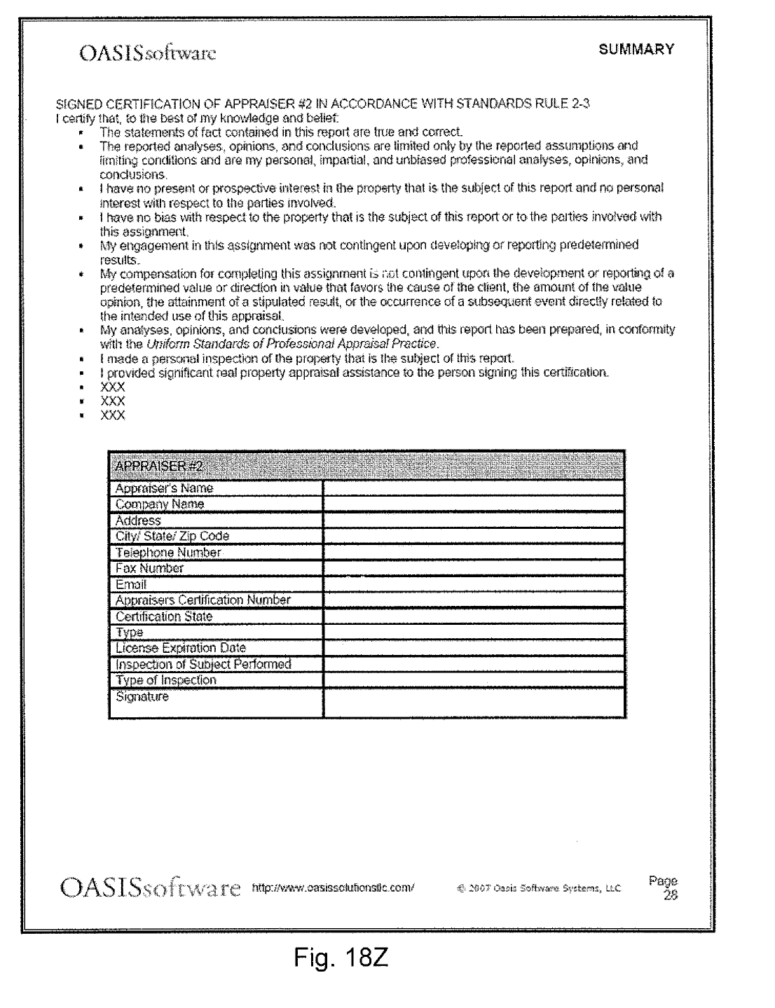

FIGS. 18A-18Z illustrate portions of an example format 136b for a Summary Appraisal report 136. Although not shown, the Summary report 136 may further include pages to show photographs of various views of the subject property, photographs of comparable properties, and a map to show where the subject property is located with respect to the comparable properties. Additionally, the Summary report format 136b may include addendum pages to include such things as zoning maps, floor plans, site plans, photographs of comparable rentals, FEMA documents, legal documents, and so forth. The Summary report 136 has greater appraisal detail than the Restricted report 135, and so may be better suited for even higher-risk situations. The Summary report 136 contains an adequate amount of information that it may be distributed by the client 110, but the report and analysis are performed only for the client 110.

As previously indicated with reference to FIGS. 9A-9J, which draw specifically on the Evaluation report 131 by way of example, the host system 120 may present to the appraiser 152,154 an interactive environment in which the appraiser 152,154 may fill in the various fields required of the respective report 131-136, and then upload the data so entered into the portfolio database 160 of the host system 120. Using the product database 130, the host system 120 may select the appropriate report format 131b-136b, populate this format 131b-136b with the data contained within the portfolio database 160, and present the populated document as the final valuation report product 162. In this manner, changes to the format 131b-136b of a report 131-136 may be quickly and easily made without having to tamper with the actual underlying data contained within the report 131-136. That is, by changing the format 131b-136b of a report 131-135 within the product database 130, and then populating that changed report 131-136 with the corresponding data from the client 110 input into the host system 120 which then populates the product database 130 which then populates the portfolio database 160, a newly formatted report 162 may be automatically generated using data previously submitted by an appraiser 152,154.

Populating fields in a report 131-136 with data is particularly useful with regards to the scope of work 131a-136a. The scope of work 131a-136a may be incorporated within the respective format 131b-136b, or may be a separate file that is linked to the respective format 131b-136b. With reference again to FIGS. 4, 6 and 12, after step 20 when an order has been generated, one of the products 131-136 from the product database 130 will have been selected by the host system 120 and confirmed by the client 110. As shown in FIG. 4, when confirming the product 131-136, the host system 120 presents to the client 110 details about the product 131-136. In particular, the host system 120 presents in an appropriately labeled field 21 the scope of work 131a-136a of the respective product 131-136 being shown. The client 110 is therefore made clearly aware of exactly what terms and conditions are imposed upon the ordered report 131-135. Similarly, as shown in FIGS. 6A-6C, when the host system 120 presents the order to the appraiser 152,154, the order is explicitly populated with a field 41 holding the corresponding scope of work 131a-136a of the report 131-136 ordered and submitted to the appraiser 152,154. The manager of the host system 120 may edit the scope of work 131a-136a of each product 131-136, and these changes will be automatically reflected in subsequent interactions of valuation experts 150 and clients 110 with the host system 120. Reports 131-136 may therefore be quickly and easily tailored to account for changing regulatory and client 110 needs. The scope of work 131a-136a may or may not be included in the formal valuation report 131-136 submitted to the client 110 in step 80; typically, in reports requiring greater appraisal depth and detail, the scope of work 131a-136a will be included in the final report 131-136, possibly with additional legal and regulatory information.

Various embodiments also provide for the insertion of an intended use 131c-136c into each product 131-136. As with the scope of work 131a-136a, the intended use 131c-136c may optionally be incorporated into the final, formal report 162 that is provided to the client 110. Unlike the scope of work 131a-136a, however, which typically is constant across each instance of the same type of report 131-136, the intended use 131c-136c may vary even across reports of the same type. The purpose of the intended use 131c-136c is to provide the valuation expert 150 information about the client 110, or information which the client 110 deems to be important. That is, the intended use 131c-136c allows the client 110 to communicate to the valuation expert 150 what the appraisal analysis and report is being used for. For example, the intended use 131c-136c may inform the valuation expert 150 why the client 110 is seeking the report 131-136, and may indicate the degree of exposure that the client 110 may be facing with regards to the subject property.

With specific reference to FIGS. 3 and 12, during submission of the order-related data in step 10, the host system 120 may present a user interface 11 that permits the client 110 to enter and upload various pieces of data. Some of the data may be in a predetermined format, and hence entered by way of drop-down boxes, radio buttons or the like. Other data, however, may be in a less determinate form, and hence entered via text boxes, file upload dialog boxes, or the like. A portion or all of the data entered by the client 110 may subsequently be used to generate the corresponding intended use statement 131c-136c for the report 131-136. Some data which may be requested from the client 110, and which may be useful for generating the intended use statement 131c-136c may include: the relative degree of the load amount, such as low, average or high; if the loan is for the purchase or refinance of real estate; if the appraisal is for a first or subordinate mortgage; the degree of the LTV ratio, such as low, average or high; if the property is to be owner or tenant occupied; if the property is the primary source of the loan repayment; the degree of the borrower's ability to repay the loan, such as average, good or strong; if the borrower is a current bank customer; if the property is current bank collateral; if the property is new construction, and if the property is additional or primary collateral. Based upon the information submitted by the client 110 in step 10, the host system 120 may generate corresponding intended use statements for insertion in the intended use 131c-136c of the ordered report 131-136. For example, the user interface 11 may present radio buttons 12y, 12n that permit the client 110 to indicate if the borrower is a current customer of the client 110. If the client 110 selects the “Yes” radio button 12y, the host system 120 may insert into the intended use 131c-136c the sentence, “The borrower is a current bank customer.” On the other hand, if the client selects the “No” radio button 12n, the host system 120 may insert the sentence, “The borrower is not a current bank customer,” into the intended use statement 131c-136c. It should be clear, then, that various methods may be employed to insert intended use statements 131c-136c into the ordered product based upon information received from the client 110.

As indicated in FIG. 4, when the host system 120 presents to the client 110 details of the order for the client 110 to accept or decline, one of the fields presented may be a field 23 that is populated with the intended use 131c-136c of the product 131-136 being ordered. The intended use field 23 may include, for example, a plurality of sentences, each constructed according to a data previously supplied by the client 110, or from other sources. As shown in FIG. 6, the same intended use 131c-136c is again populated into a field 43 that presents the client's 110 intended use for the order to the appraiser 152,154 so that the appraiser 152,154 is made explicitly aware of the various reasons and circumstances surrounding the order 131-136.

The host system 120 may include an administration module 170 that permits the host system 120 to be configured and changed as needed. The administration module 170 may be a resource exclusively for the system administrator of the host system 120. Alternatively, certain aspects of the administration module 170 may be accessible to the client 110, while others may be restricted only to the system administrator. In particular, the host system 120 may be configured so that only senior credit personnel 113 of the client may access those portions of the administration module 170 that are accessible to the client 110. Such security configurations are design choices that may be considered when implementing the host system 120. Tasks that the administration module 170 may perform include modifying the scope of work 131a-136a for the various products 131-136, modifying the format 131b-136b for the products 131-136, making adjustments to a decision matrix that is used to select an appropriate product 131-136 for a client 110, and which is discussed later, and editing and configuring the various potential intended use statements.

The administration module 170 may include a configuration database 180 used to store some or all of the various parameters of the host system 120. With specific reference to the intended use aspect of the various embodiments, this configuration database 180 may include many or all of the potential intended use statements that a product 131-136 may have inserted into its respective intended use field 131c-136c, and one or more matrices that provide for the appropriate selection of these statements based upon input received from the client 110 in step 10, or from other considerations. By providing appropriate editing and augmenting of this configuration database 180, the various intended use statements, and the conditions under which they are respectively selected for inclusion into the intended use 131c-136c of a report 131-136, may be updated as required to provide for flexibility of the host system 120.

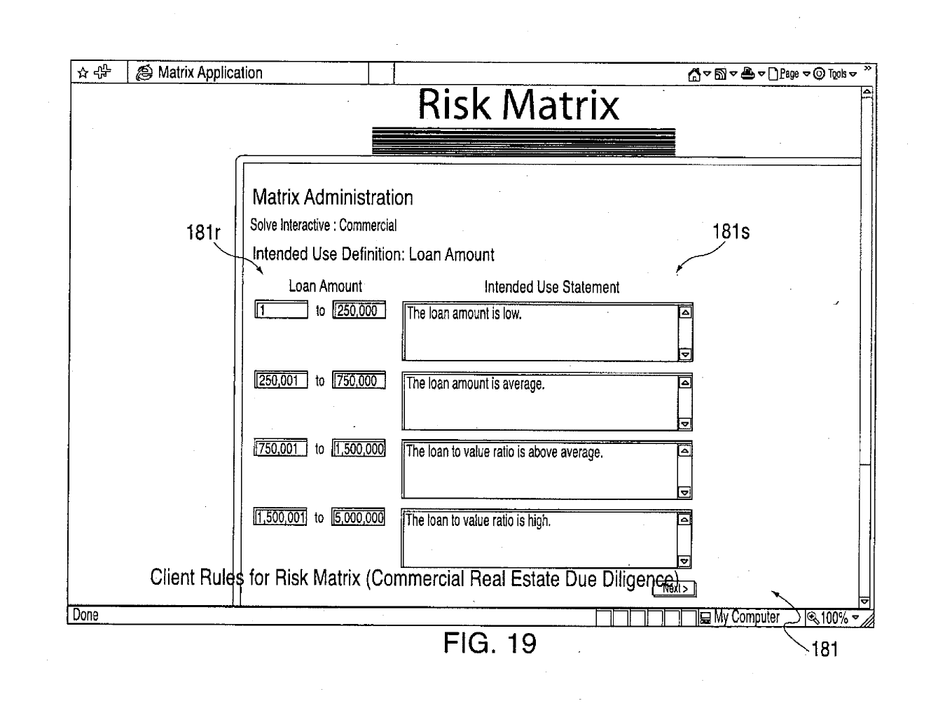

For example, one of the intended use statements that may be inserted into a report 131-136 may indicate the relative degree of the loan amount, as low, average or high. As shown in FIG. 3, a field 13 may permit the client 110 to enter the monetary amount of the loan for which the valuation report 131-136 is being requested. The host system 120 may further include a matrix, such as an indexing table, that may be used to convert the value in field 13 into a corresponding one of a plurality of sentences according to that value. As shown in FIG. 19, the administration module 180 may present a user interface 181, such as for the benefit of the client 110 or system administrator, that provides for the selection and creation of a plurality of value ranges 181r, each with a corresponding intended use statement 181s, and which is used to update or modify the indexing table. Clearly, then, based upon the value present in field 13, the host system 120 may select an intended use statement 181s that corresponds to the range 181r in which the value in the field 13 falls. This corresponding intended use statement 181s may then be inserted into the intended use 131c-136c for the product 131-136, and populated through the various forms, as when presented to the client 110 and appraiser 152,154.

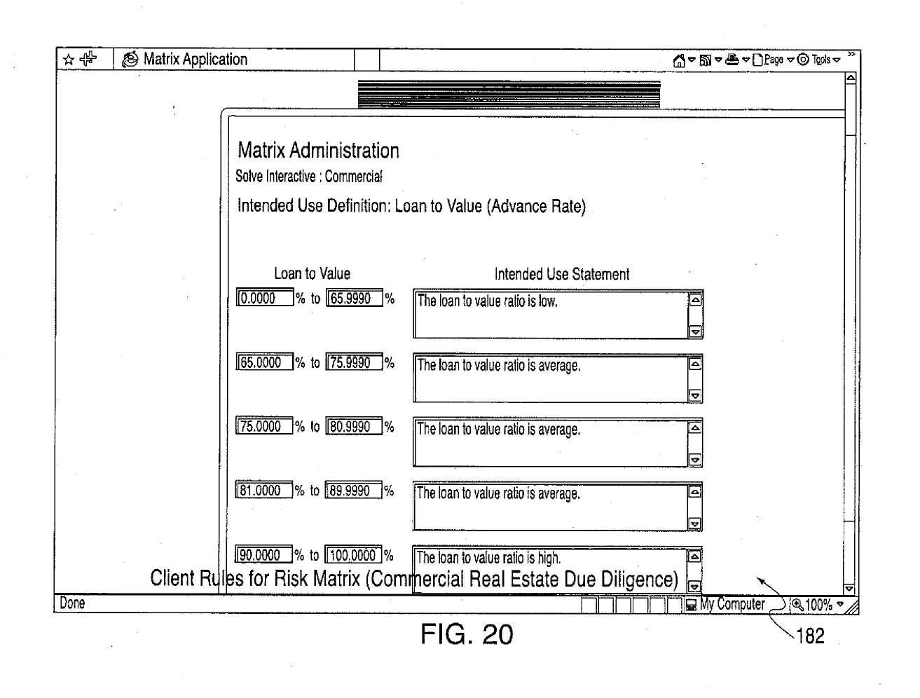

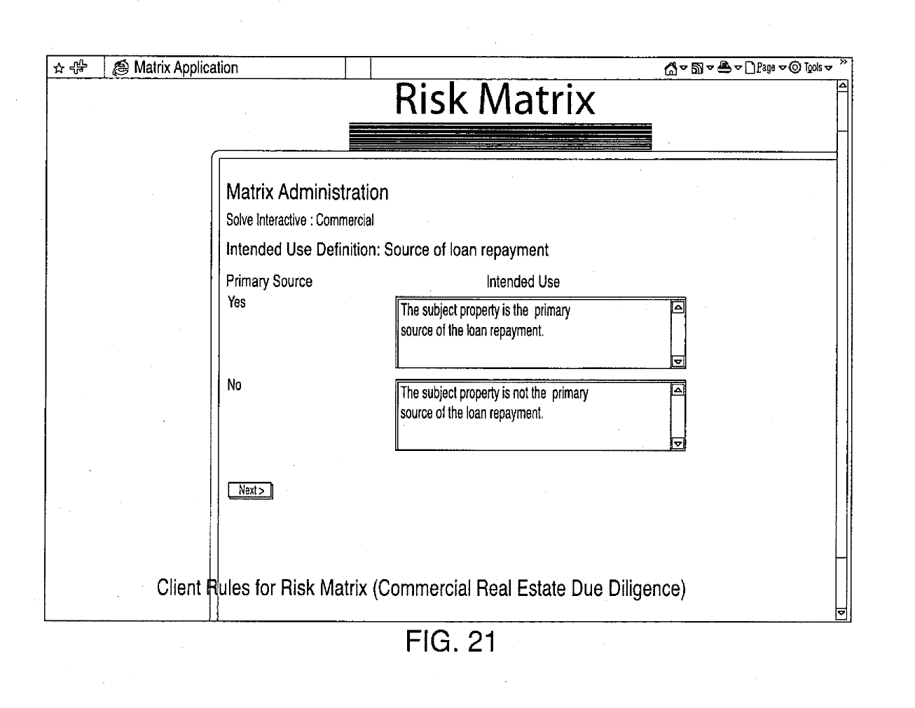

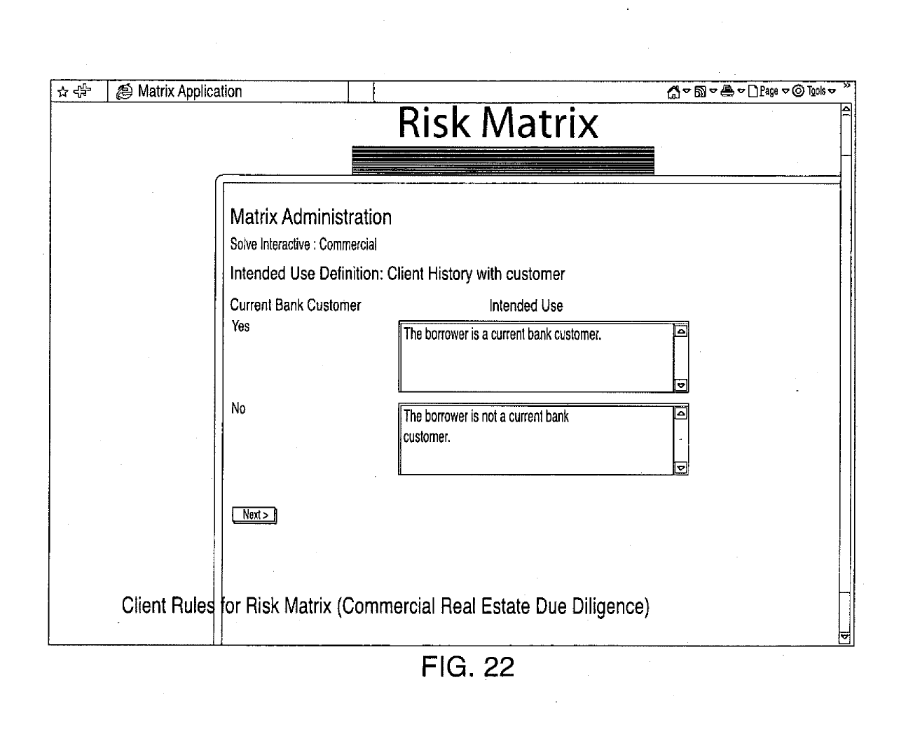

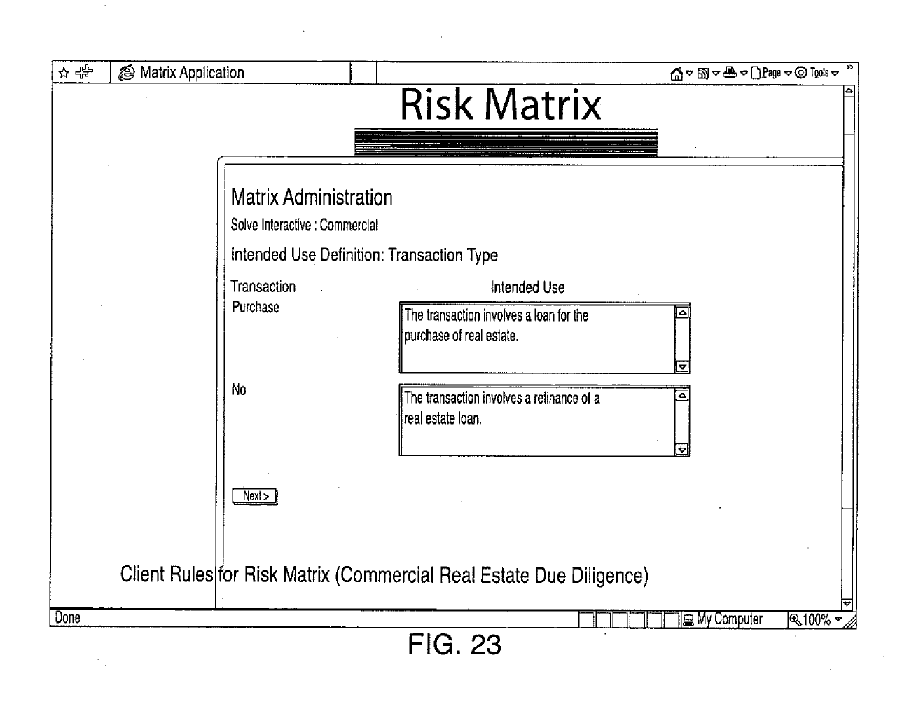

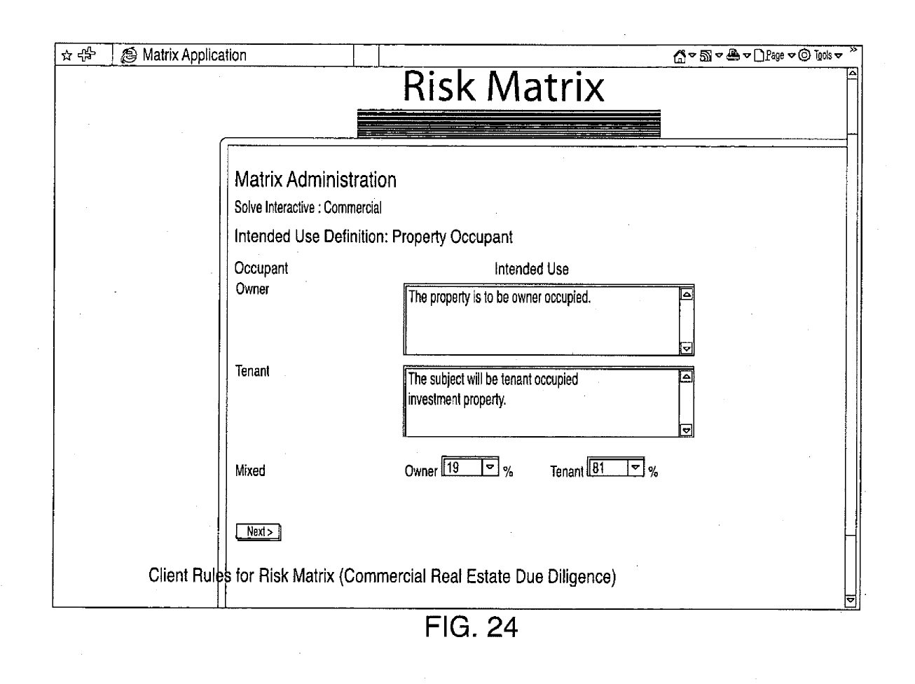

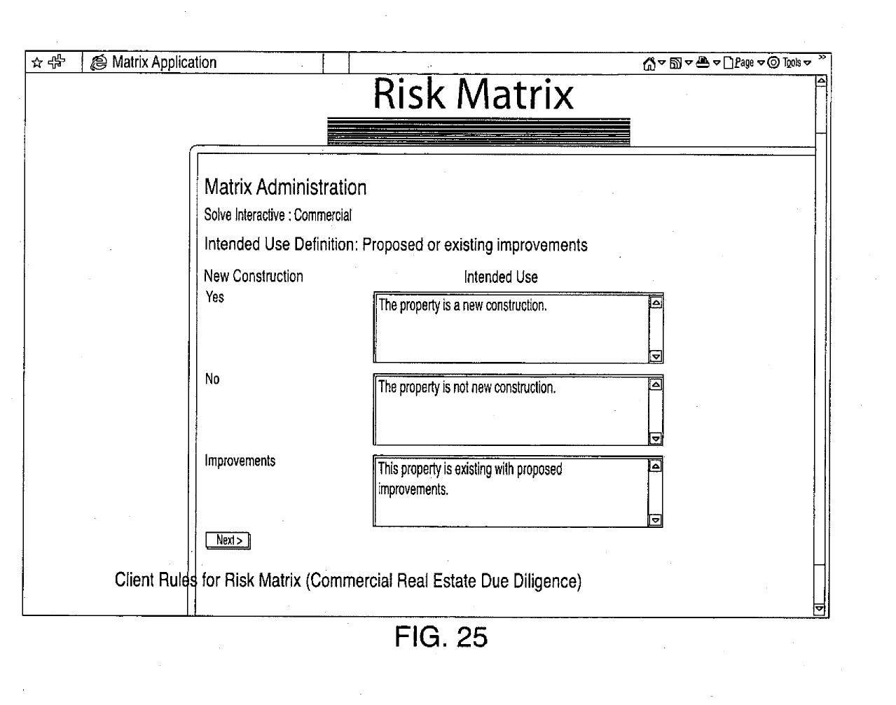

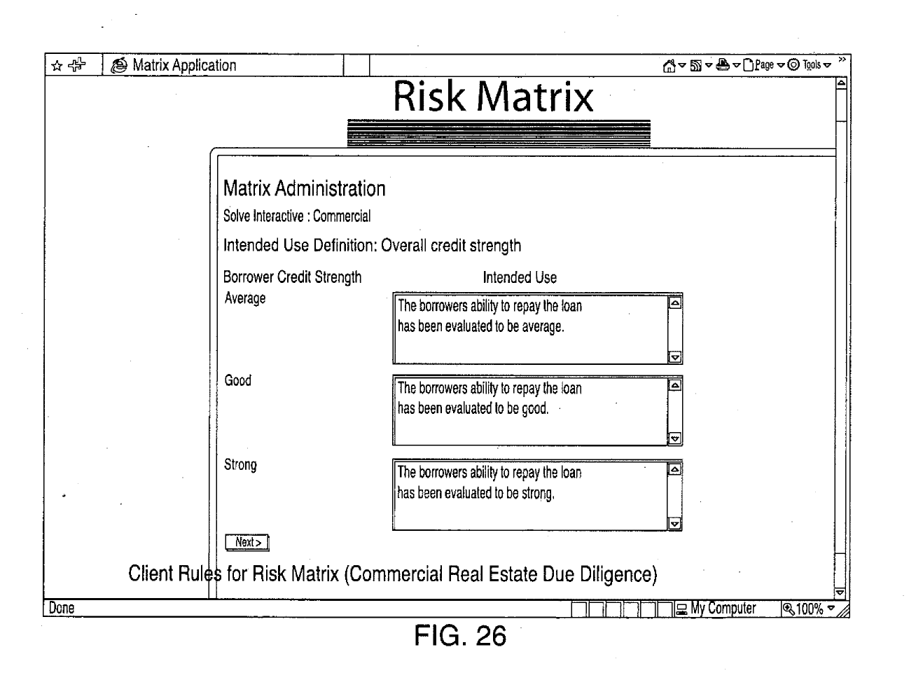

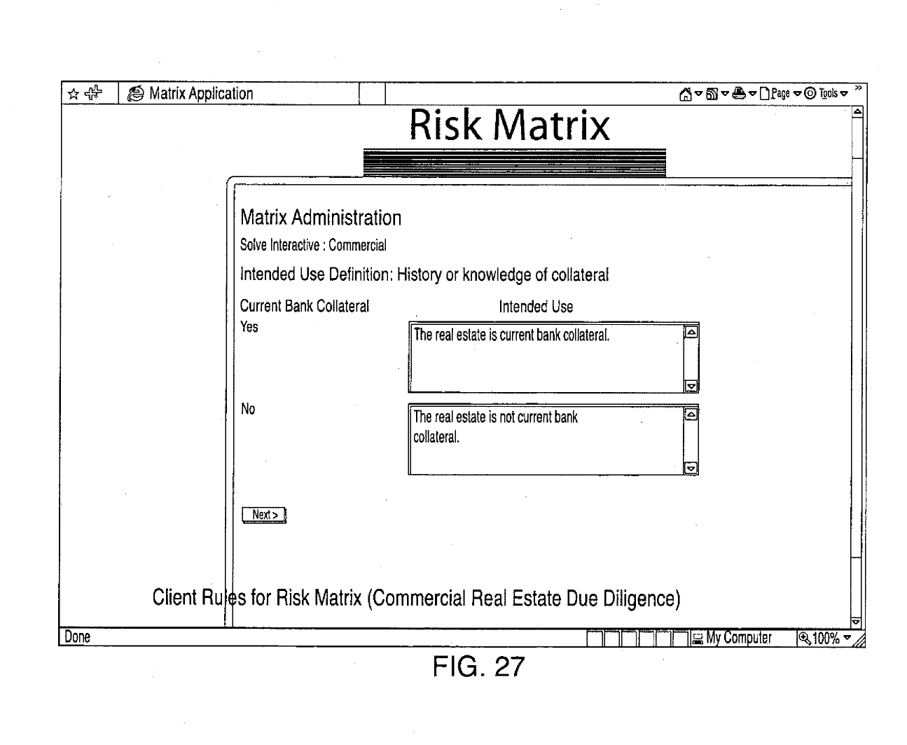

The administration module 170 may present various other user interface pages that permit the client 110, system administrator or both to edit matrices related to various other intended use statements. For example, as shown in FIG. 20, a user interface 182 may be provided that provides for intended use statements related to the LTV ratio in a manner analogous to that used in FIG. 19. FIGS. 21-27 show embodiment user interfaces, each of which respectively handles configuring intended use statements in a specific category, including: the source of the loan repayment, the history the client 110 has with the customer of the client 110, the type of transaction for which the loan is sought, who the property occupant is or will be, the type of construction to be done, the overall credit strength of the client's 110 customer, and the client's 110 history or knowledge of the subject property. Each of the intended use statements in these configuration pages may be subsequently selected based upon, for example, the order-related data obtained in step 10, and cumulatively added to the intended use 131c-136c for the order 131-136.

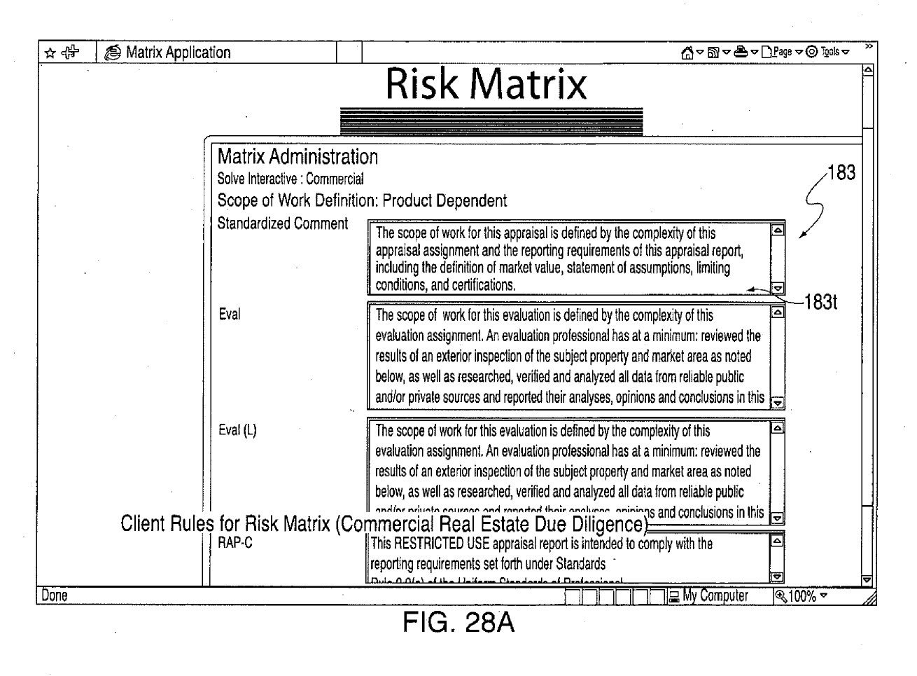

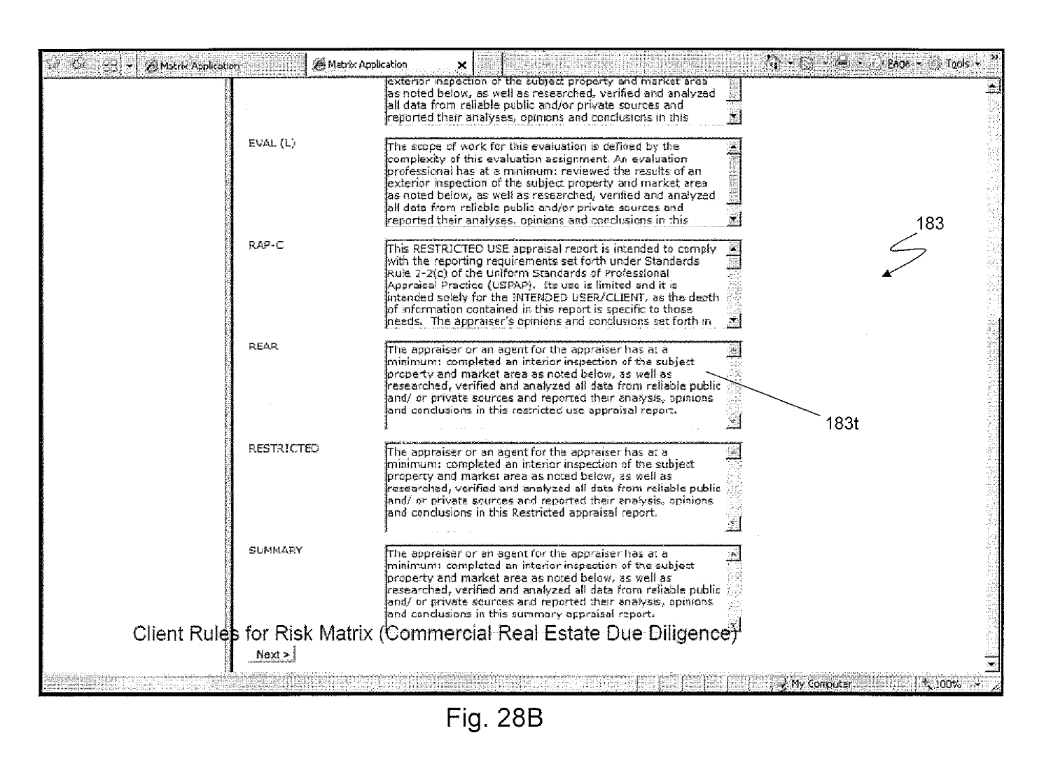

The administration module 170 may also be used to edit the scope of work 131a-136a of each product 131-136. FIGS. 28A-28B present screen shots of a user interface page 183 that the administrator of the host system 120, for example, may have permission to access. By way of a plurality of respective text boxes 183t or the like, the administrator may make changes to each of the scope of work 131a-136a definitions for the products 131-136.

As previously indicated, when a product 131-136 is selected, the scope of work 131a-136a for that product 131-136 will then usually have a fixed format, as setup, for example, by the configuration page 183. However, in certain embodiments it is possible that the scope of work 131a-136a for a particular product 131-136 may have slight additions or variations particular to that ordered product. For example, in step 10 when the client 110 provides the order-related information, the user interface 11, as shown in FIG. 3, may have a field 14 that permits the client 110 to indicate if the loan is a Small Business Administration (SBA) loan. Due to regulatory requirements, such loans may have additional requirements for the related property appraisal, and this will affect the scope of work 131a-136a for the product 131-136. For example, an SBA loan may require that the appraisal include the resume and license of the appraiser 152,154, as well as images of comparable properties. Hence, regardless of the product 131-136 that is finally selected and agreed upon between the client 110 and appraiser 152,154, if an SBA loan is involved, the scope of work 131a-136a for that product 131-136 should include a statement that satisfies the SBA requirements. In these embodiments, the host system 120 may insert an additional statement within the scope of work 131a-136a for a product 131-136 depending upon information provided by the client 110, or, optionally, from other sources.

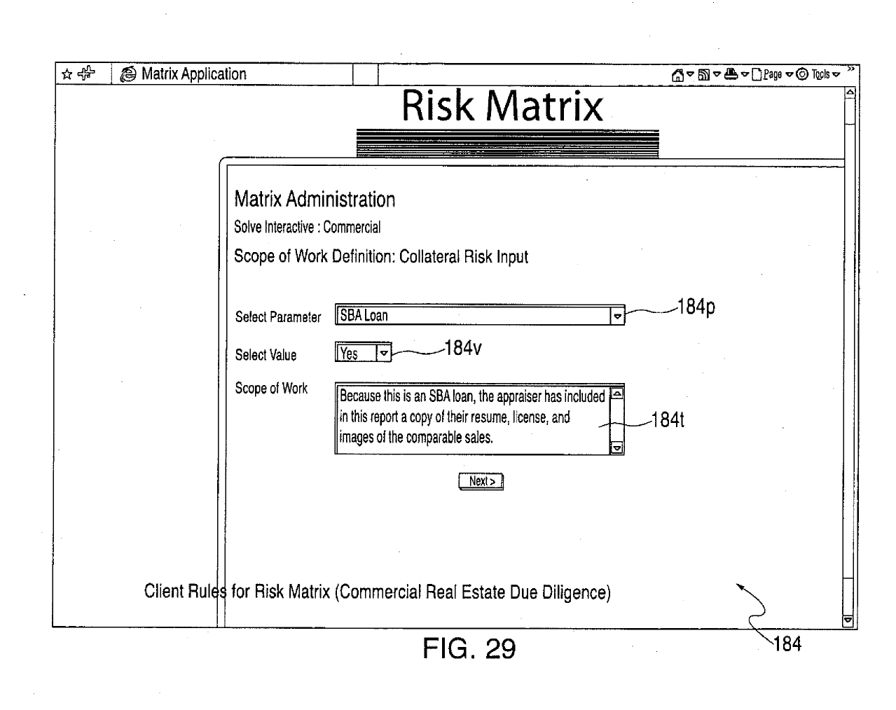

To provide for flexibility, in certain embodiments the administration module 170 may further support one or more matrices that permit augmentation of the scope of work 131a-136a of a product 131-136 based upon, for example, client-submitted information, and the editing of these matrices. Of course, as previously indicated, the matrices related to the selection and creation of the intended use statements 131c-136c may be similarly edited. As shown in FIG. 29, the host system 120 may provide a user interface 184 that either the administrator of the host system 120, the client 110 or both may access to edit a matrix associated with a parameter, such as the SBA information provided by the client 110 or other potential client-related information. By way of example, predetermined parameters may be selected by a drop-down box 184p; expected input values for these parameters may be selected by another drop-down box 184v, and text corresponding to these values may be provided by way of text box 184t. The selections of parameters and related values, and the corresponding text provided in textbox 184t may be saved internally within the host system 120 as a related matrix. Subsequently, depending upon the values provided by the client 110 order-related information, these matrices may be parsed to extract the related statements as provided in textbox 184t and inserted into the standard scope of work 131a-136a for the product 131-136.

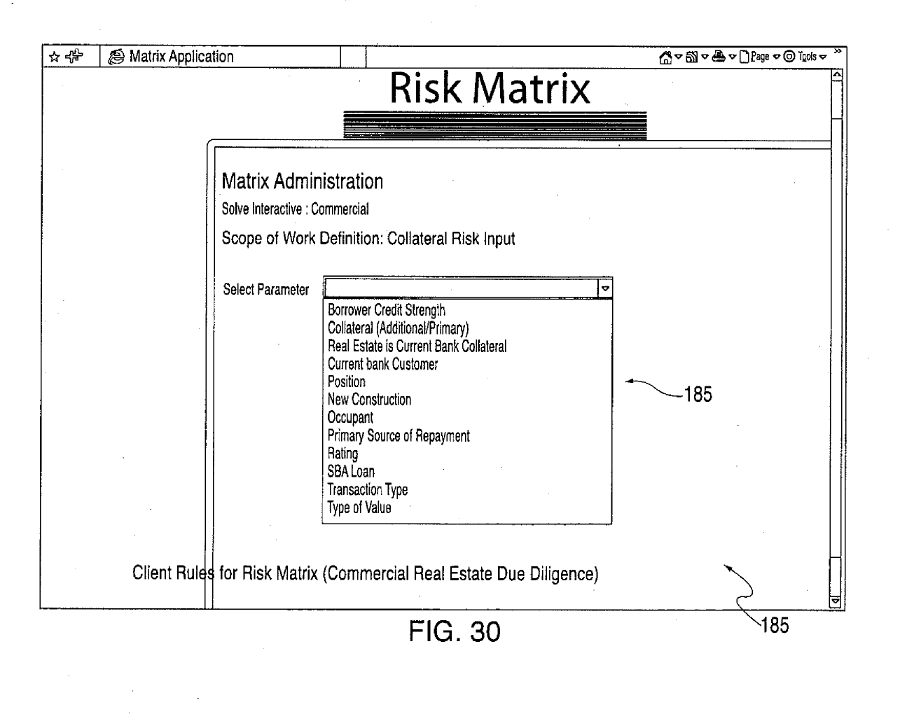

As shown in FIG. 30, the administration module 170 may provide a general matrix administration page 185 that provides for the editing of all matrices in the host system 120, including those related, to generation of intended use 131c-136c and scope of work 131a-136a statements, by selection of an appropriate parameter, such as with a drop-down box 185d. Once a parameter is selected, other user interface objects, pages or both may appear to permit the selection of related possible input values and the corresponding desired output data.

In certain preferred embodiments, after the client has submitted the order-related data in step 10, the host system 120 uses this data to select an appropriate product 131-136 from the product database 130, populate this product with the appropriate intended use 131c-136c and scope of work 131a-136a statements, and then presents this product 131-136 to the client 110 for acceptance. A decision matrix may be employed that uses the order-related data as input and generates as output a suggested product 131-136 with pre-populated scope of work 131a-136a and intended use 131c-136c fields.

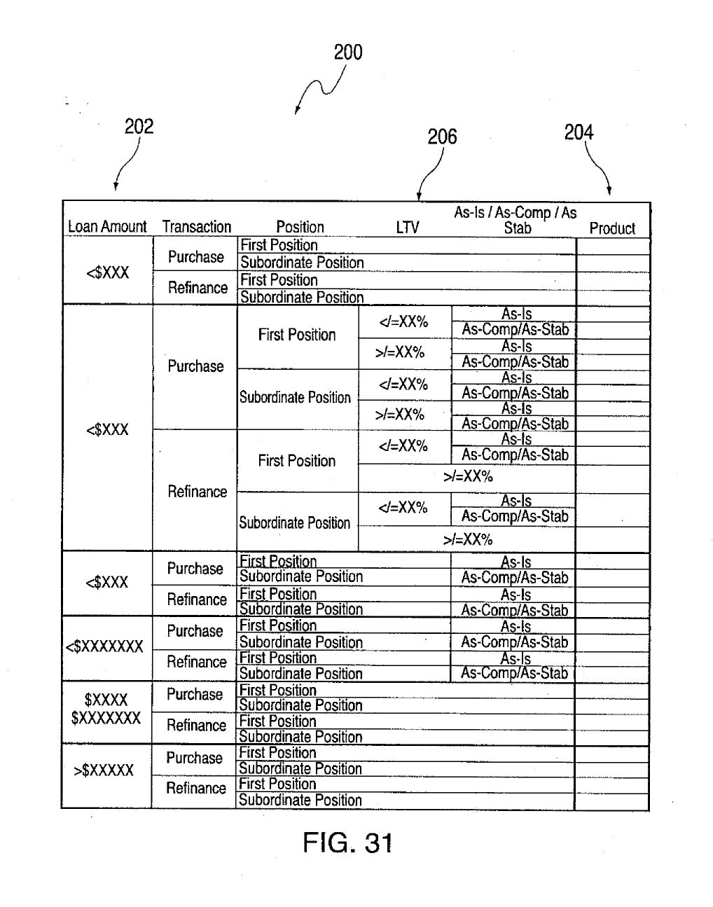

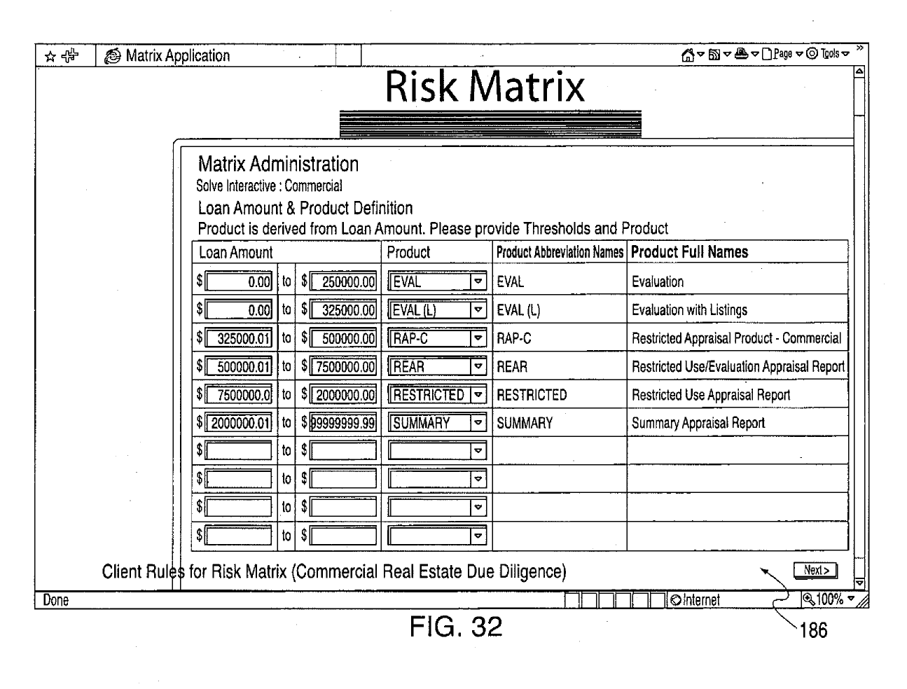

The products 131-136 may be ranked, for example, by the level of appraisal depth and detail offered. Generally, more detailed products 131-136 are desired for riskier ventures. As a result, the decision matrix may be designed to employ input parameters that select for risk, and parse those parameters for the most suitable product 131-136. Order-related data that may correspond to risk include the loan amount, whether the transaction is to purchase or refinance, whether the loan is a first mortgage or a subordinate mortgage, the LTV ratio, and the type of value. Some of these parameters may be broken into ranges and parsed accordingly; others may be parsed based on discrete values. By way of example, FIG. 31 presents an embodiment decision matrix 200. The matrix 200 may input parameters obtained from the order-related data, such as: the loan amount, the mortgage type, the transaction type, the LTV ratio, and the value type. As output, the matrix 200 may provide a suggested product. The matrix 200 may be configured, for example, by setting appropriate values within the columns. For example, the client 110 or administrator of the host system 120 may set values within a column 202 corresponding to the loan amount so as to configure for a plurality of loan amount ranges. FIG. 32 shows an embodiment user interface 186 that may be used to configure the various values within the loan amount column 202 and the corresponding suggested product for each loan value range. A column 206 for the LTV ratio may be similarly configured. The product column 204, which provides the output of the matrix 200, may be configured according to the values and ranges within each row of the column 204, and hence may be used to adjust what may otherwise be the default position based purely on the loan amount 202. Of course, input data other than that shown in FIG. 30 may be employed to provide the decision matrix 200; the exact data used may be a design choice for specific embodiments.

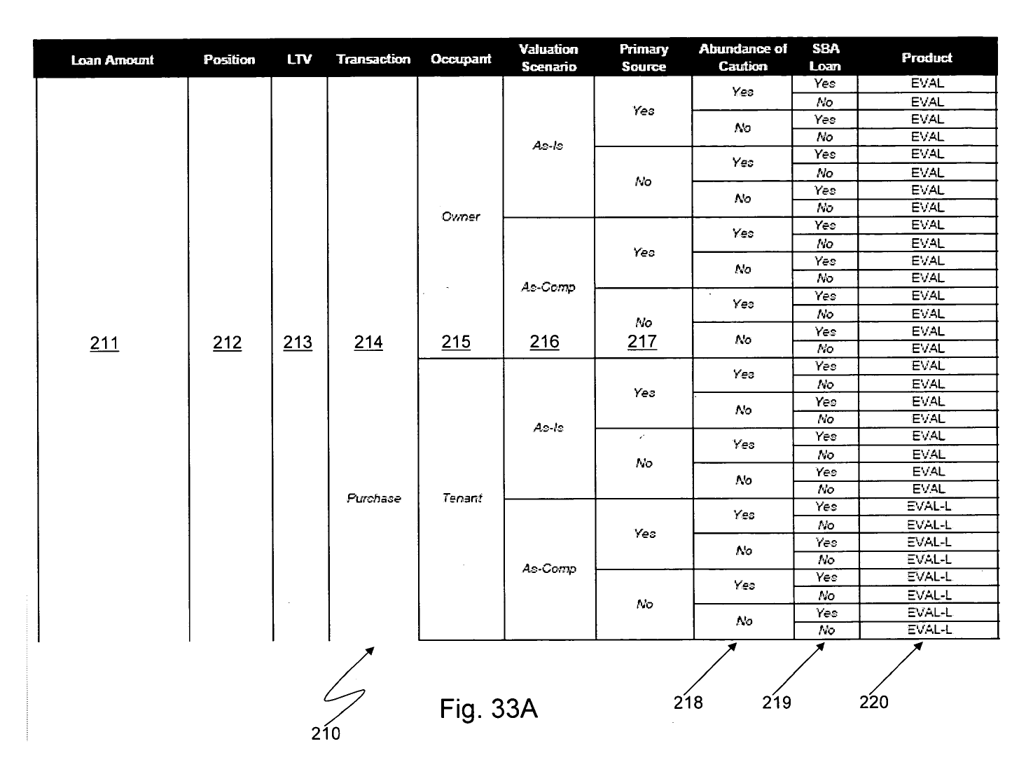

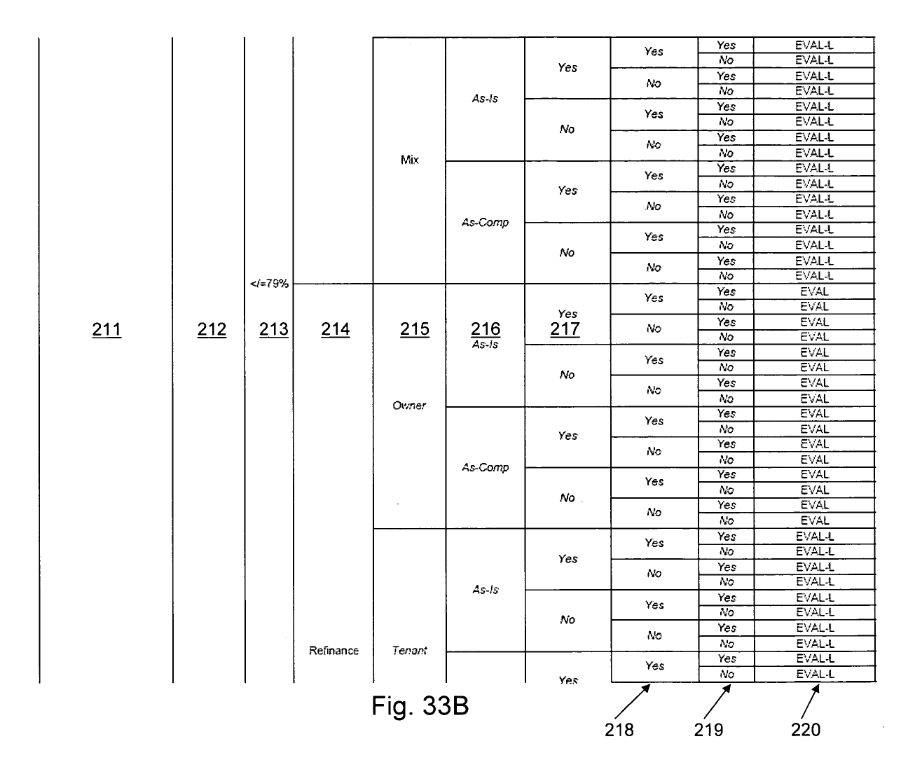

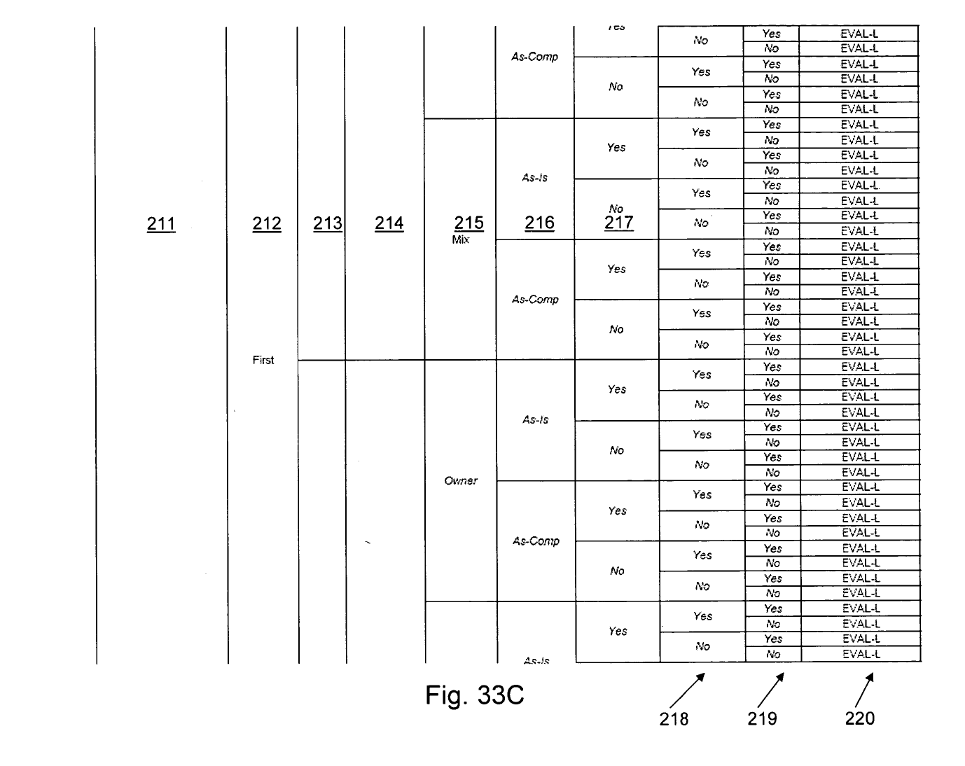

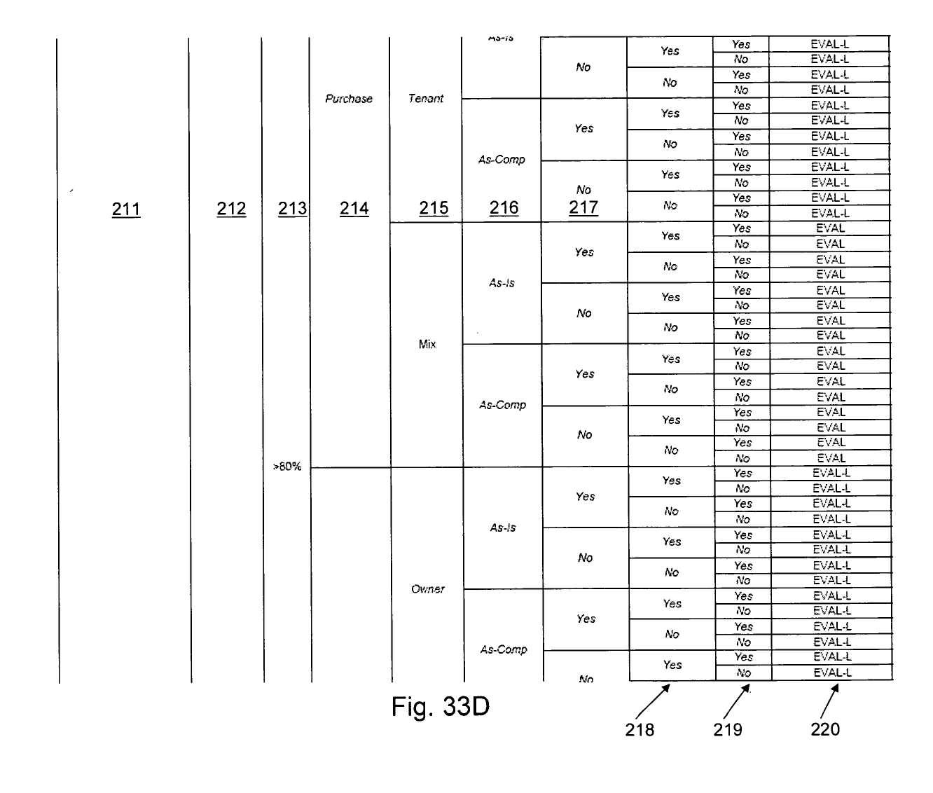

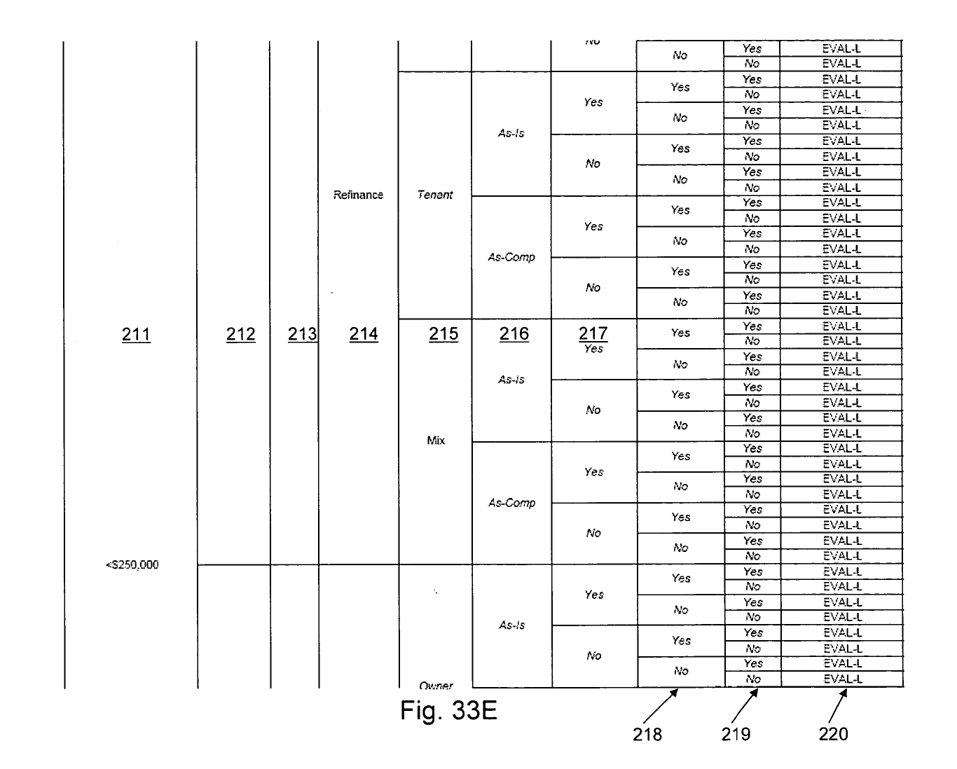

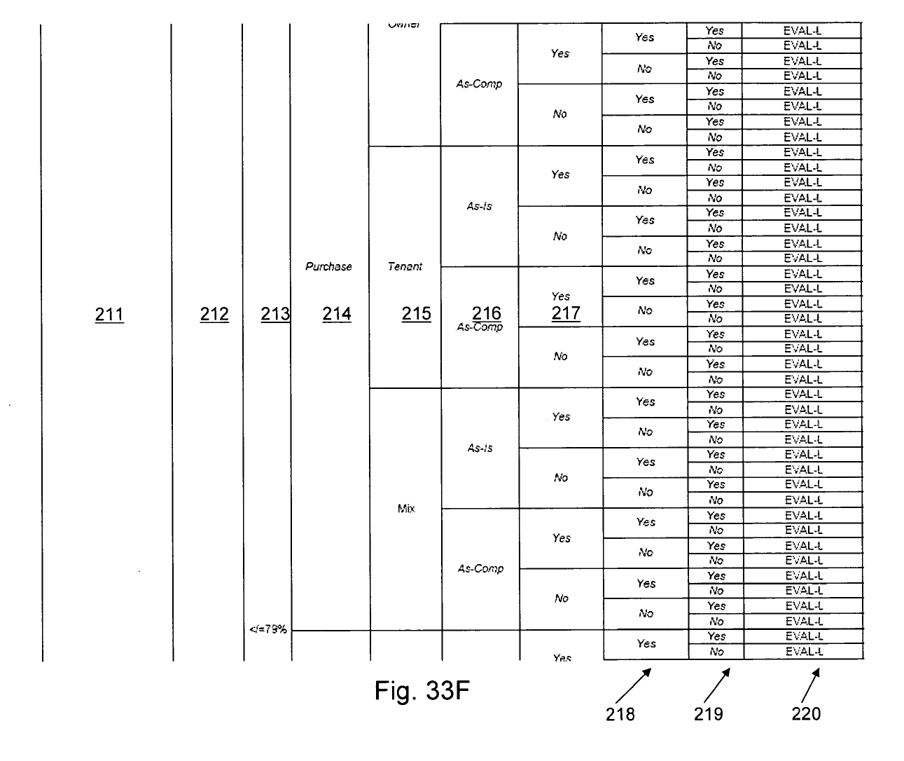

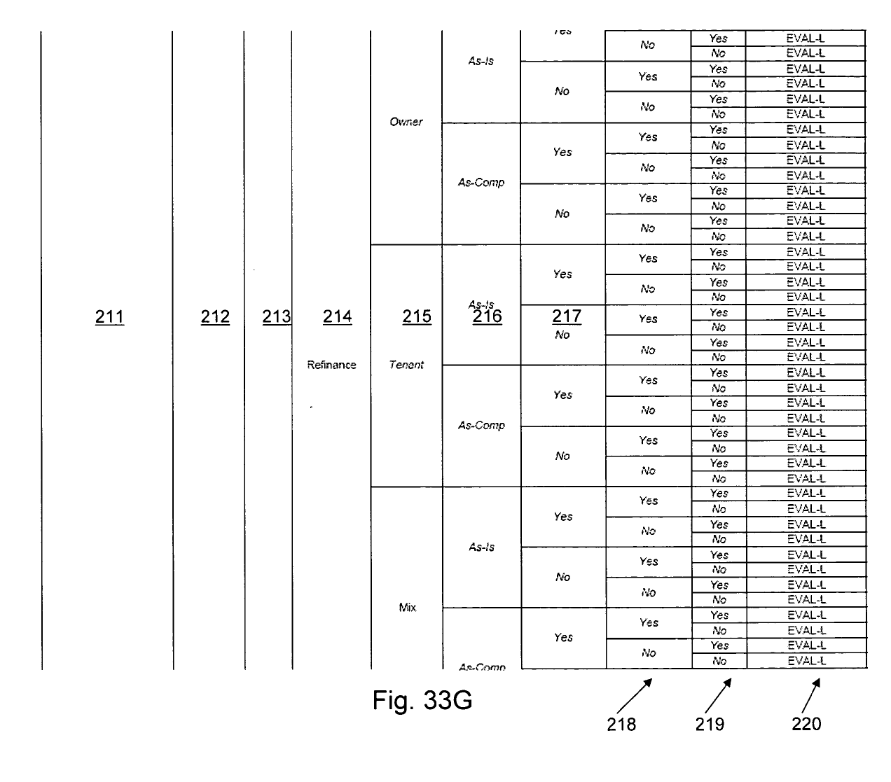

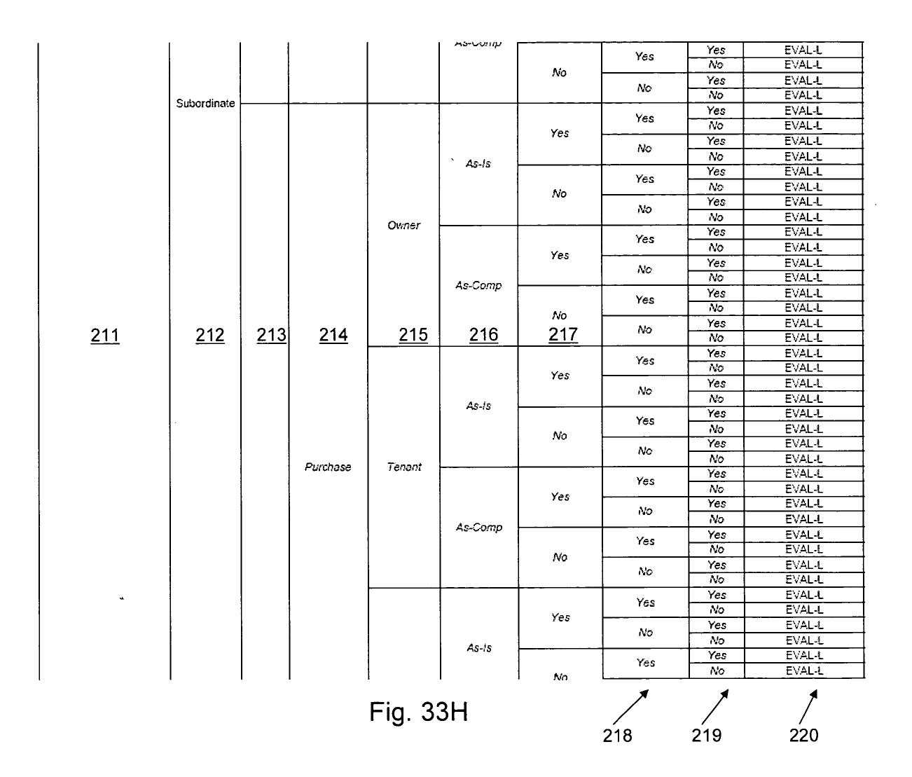

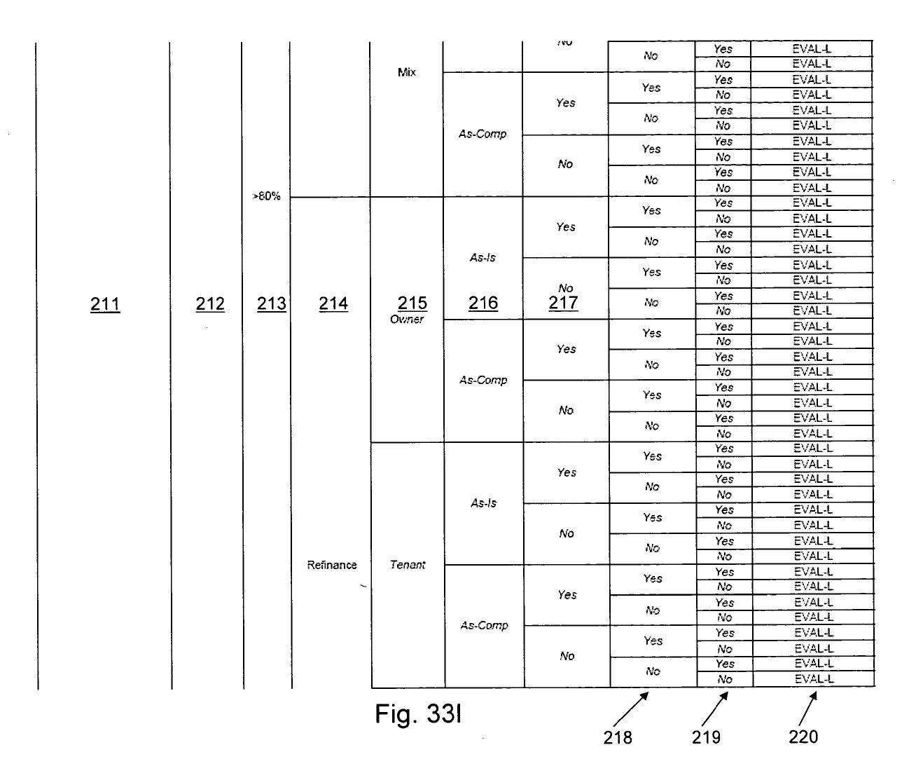

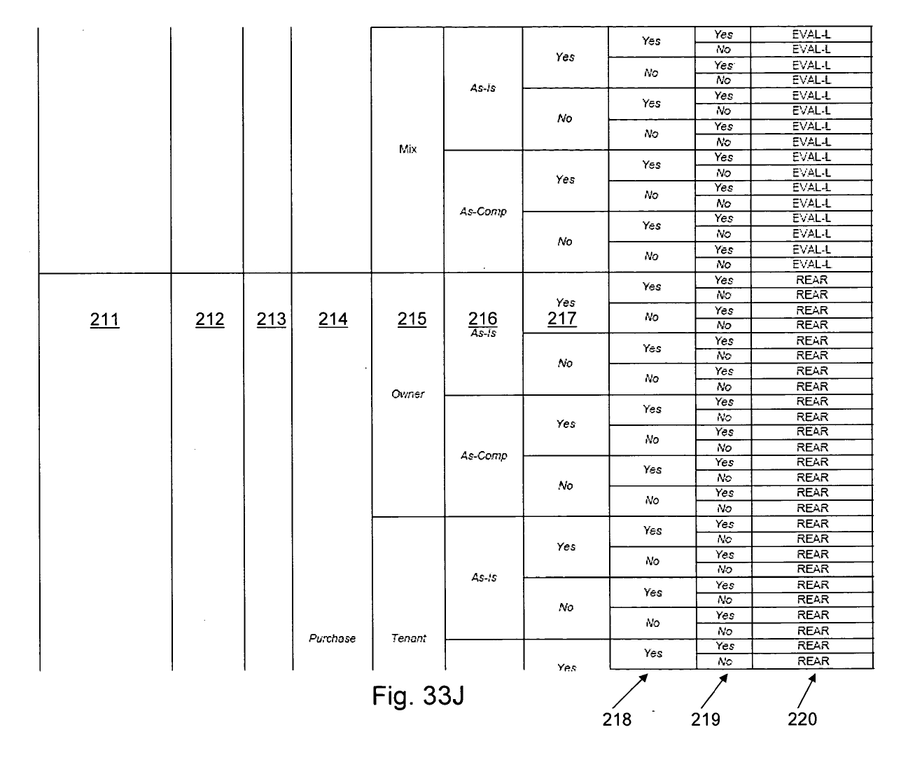

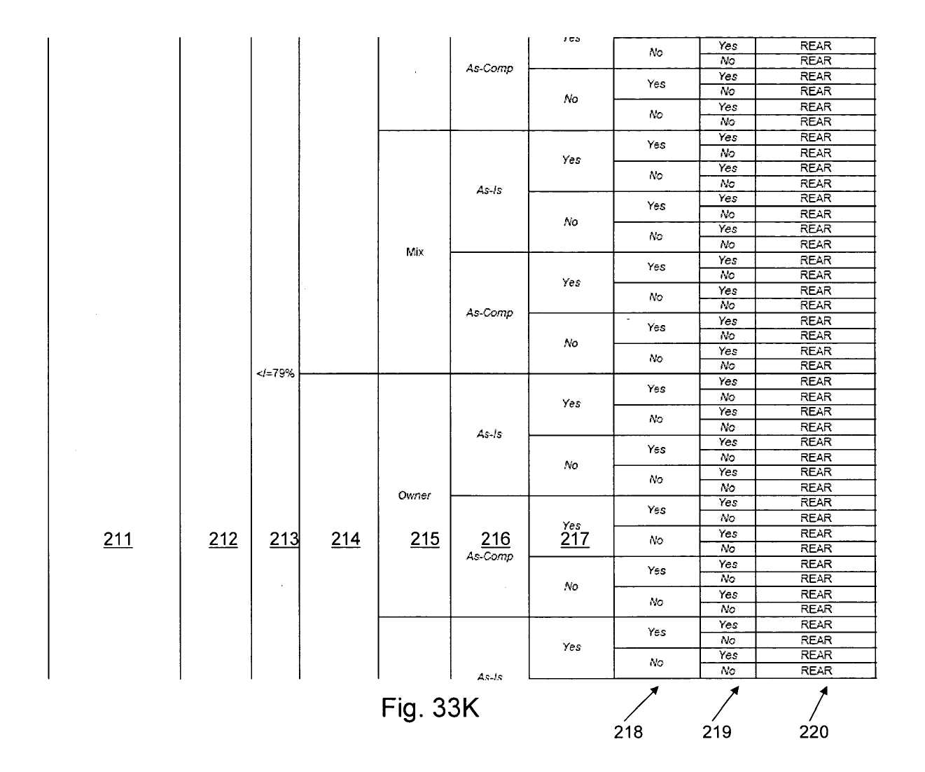

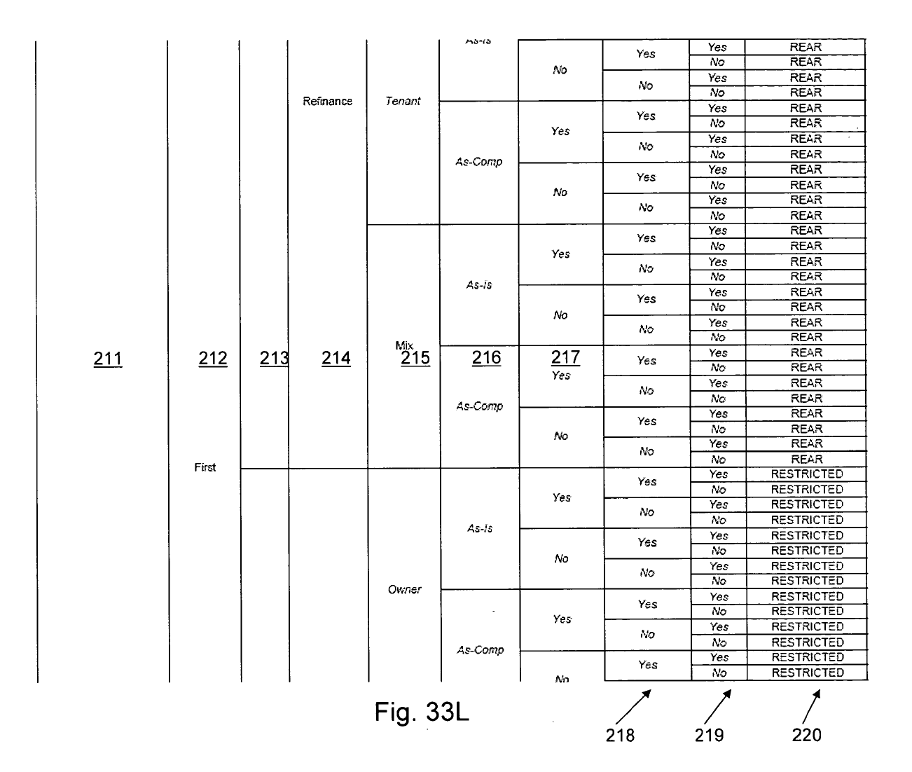

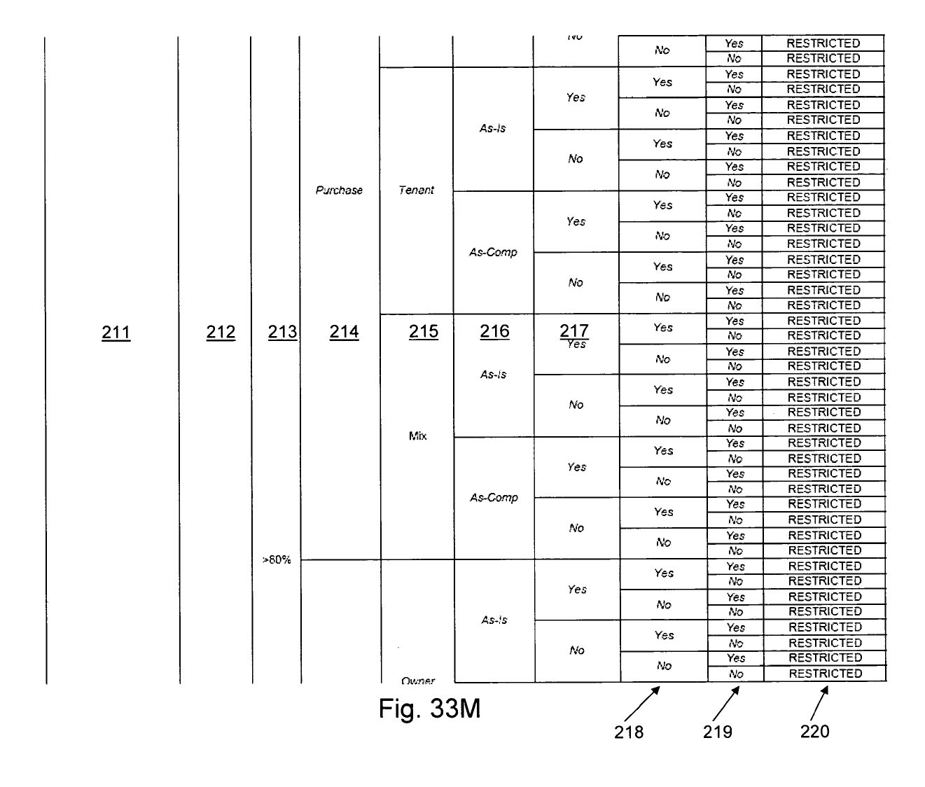

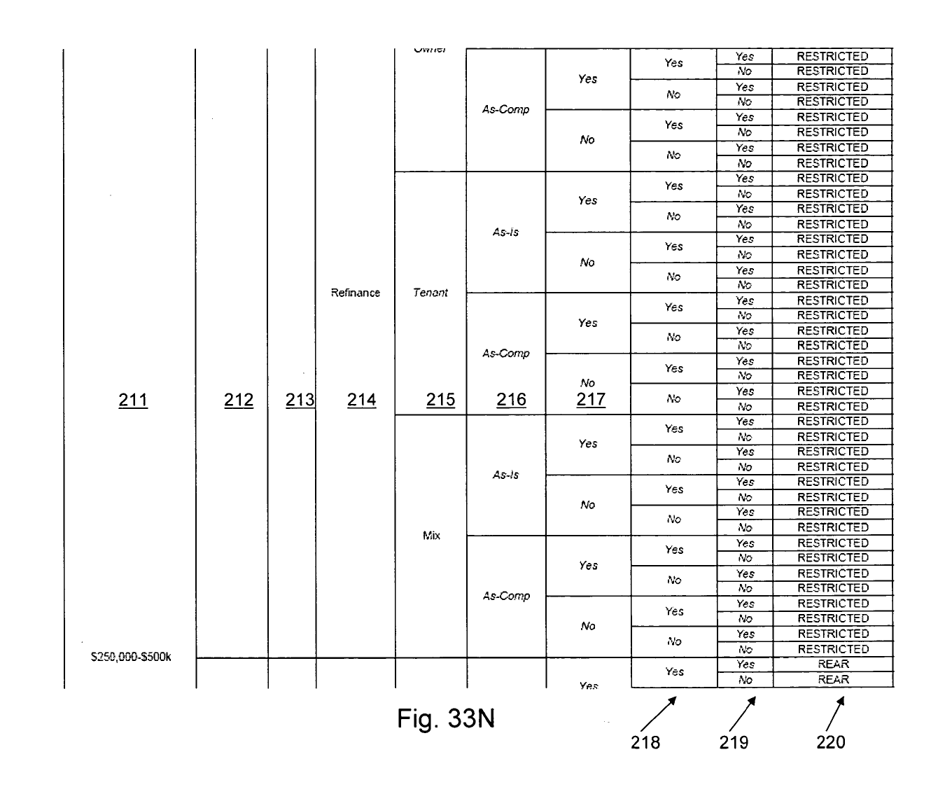

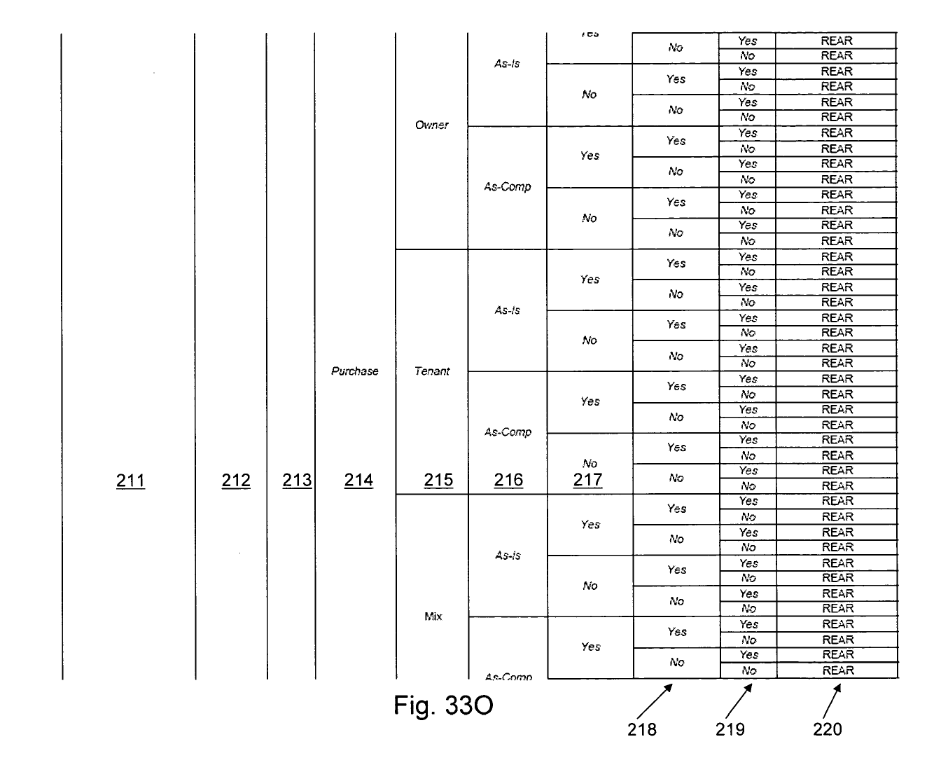

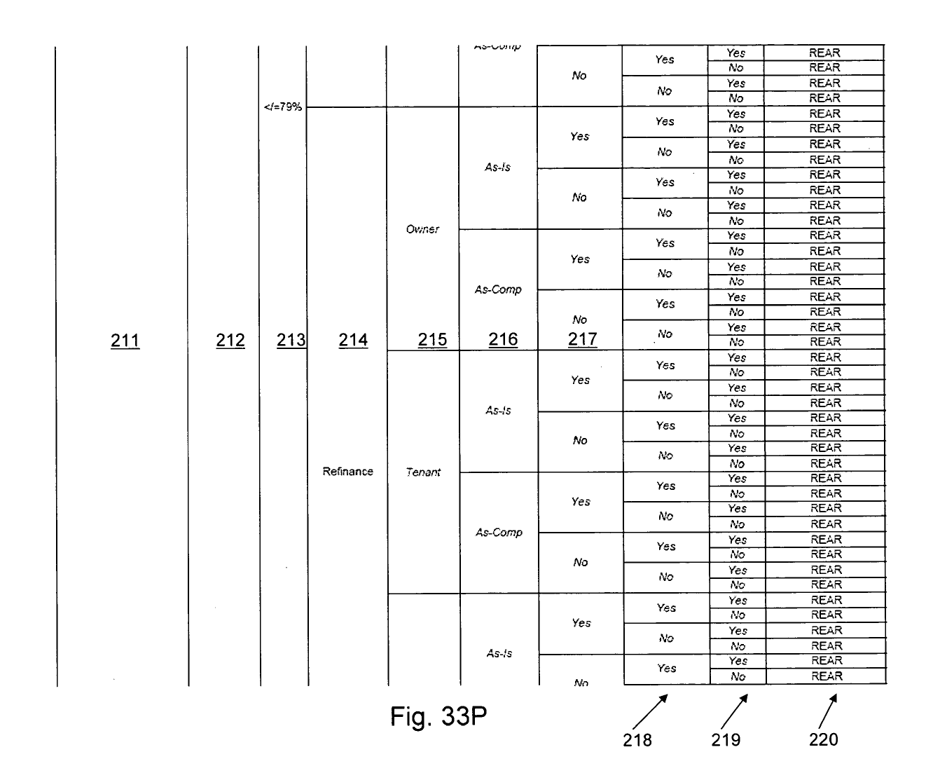

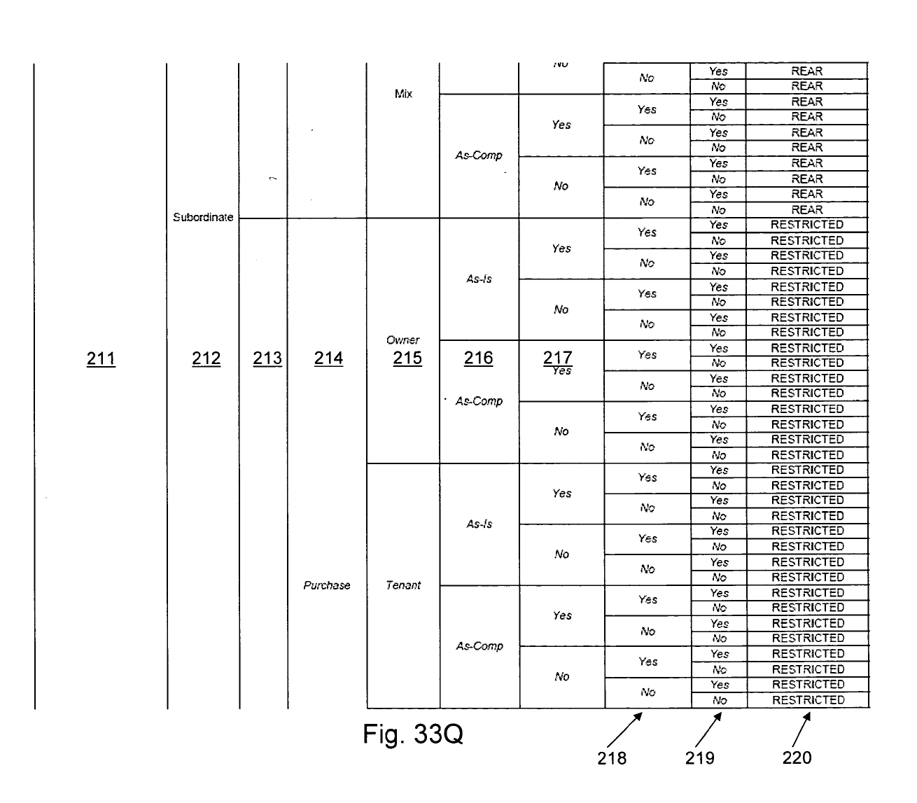

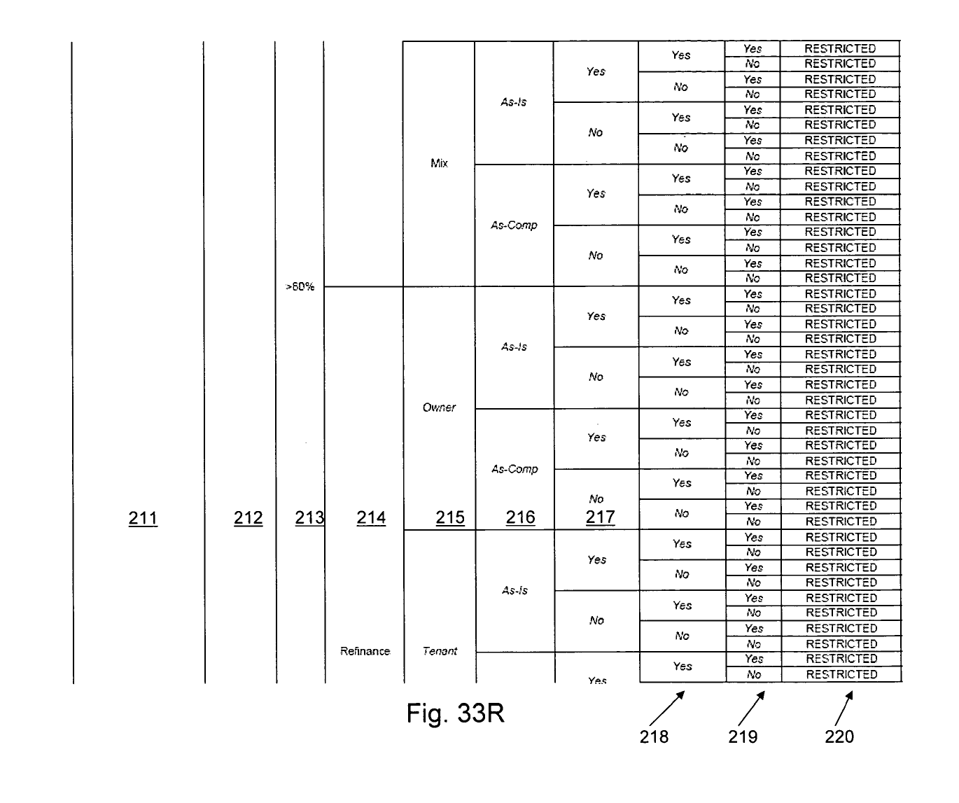

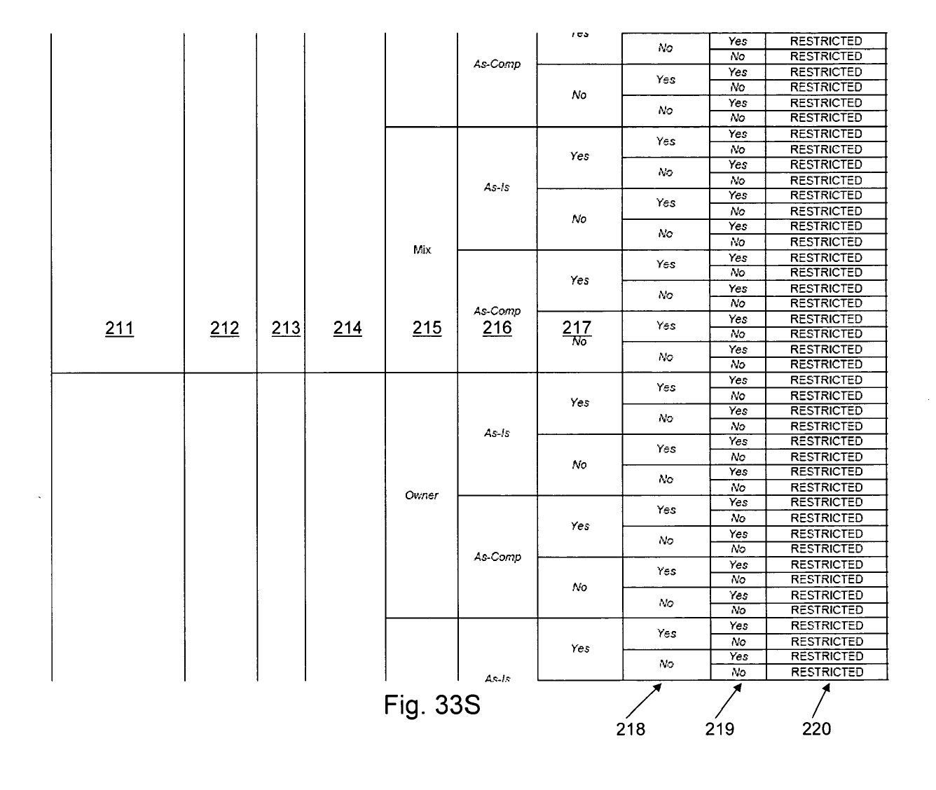

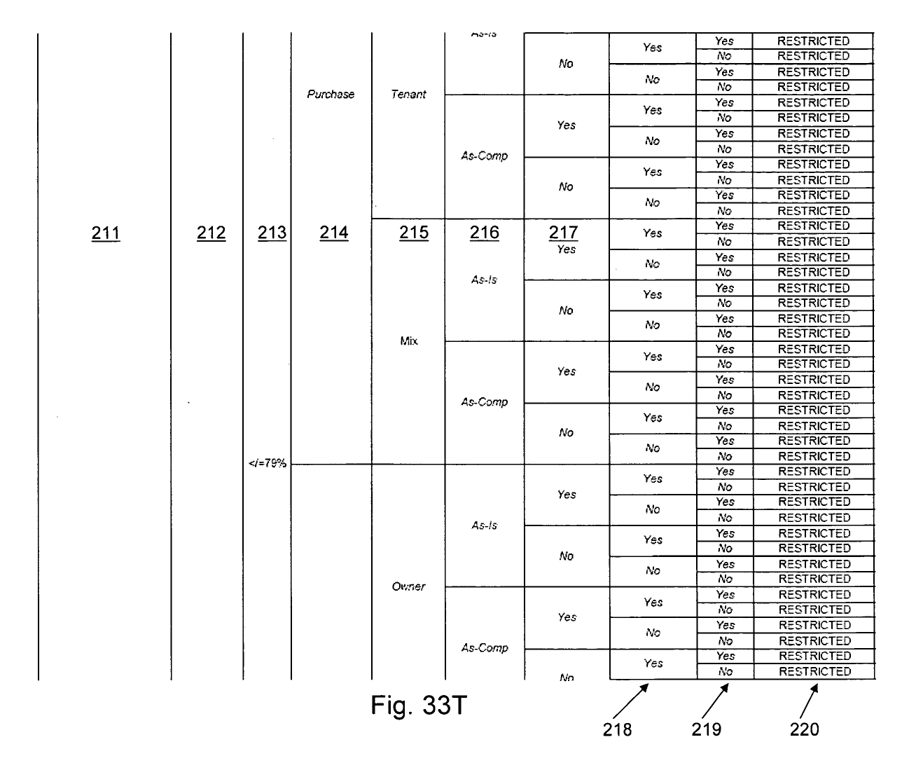

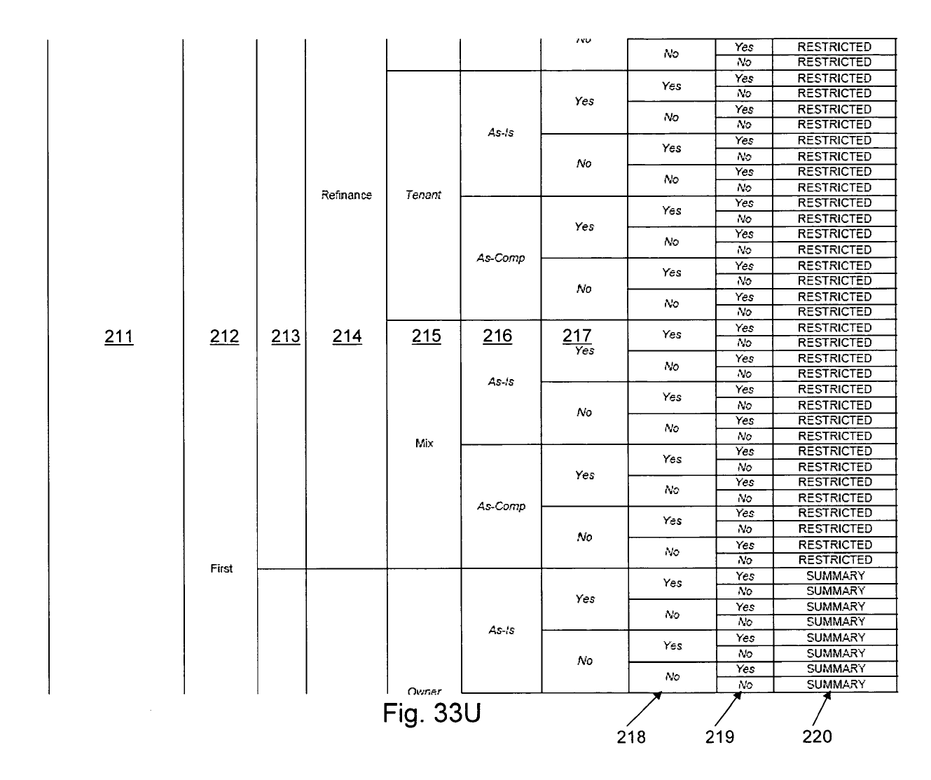

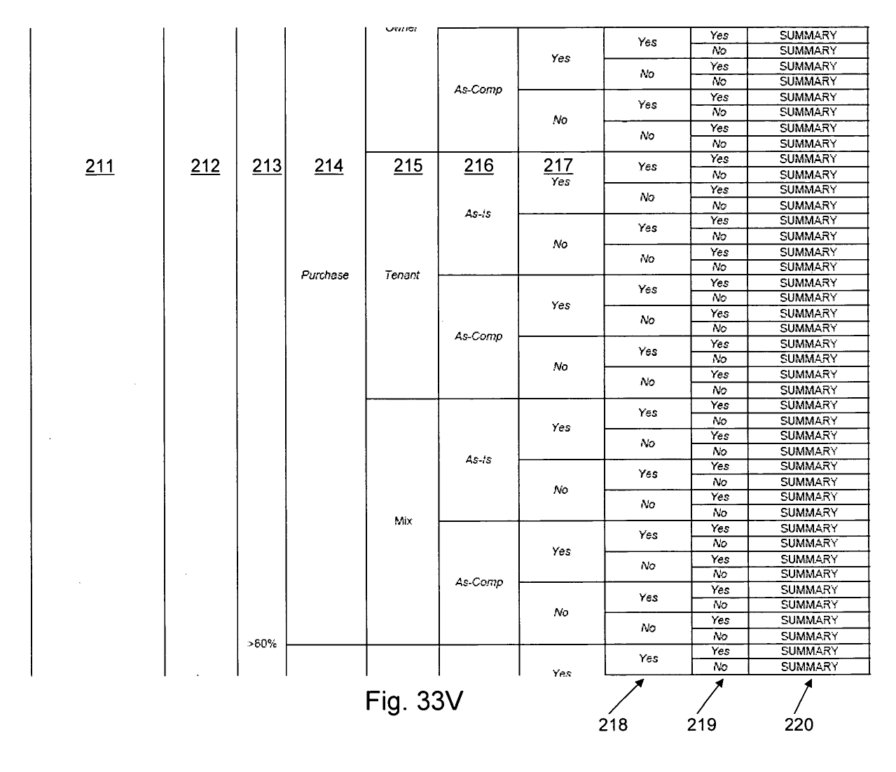

For example, FIGS. 33A-33V show an embodiment decision matrix 210 that may be employed in the selection of a product 131-136 based upon data input by the client 110. The input data may include the loan amount 211, the position of the loan 212 (such as a first loan or a subordinate loan), the LTV ratio 213, the transaction type 214 (such as a purchase or a refinance), whether the property is owner-occupied, tenant-occupied or mixed 215, the valuation type 216, whether the property will be the primary source for repayment of the loan 218, whether the property is being secured for an abundance of caution 218, and whether the loan is an SBA loan 219. Based upon these inputs, a product type 131-136 is provided as output 220. It should be clear that the decision matrix 210 may be configured to have, for example, differing ranges in the loan amount 211 and LTV ratio 213, and differing numbers of potential inputs in the other columns, such as loan position 212 and valuation type 216. Similarly, the respective outputs 220 for each row may be individually tailored as the client 110 may deem fit. The decision matrix 220 may thus be a default matrix, which guarantees that the product 131-136 offered will be the least expensive possible, while being regulatory compliant, but which may be changed from the default configuration by the client 110. User interface, as discussed above, may be provided via the administration module to tailor the decision matrix. It should be noted that the decision matrix 210 is shown only in portion; continuations of the decision matrix 210 beyond FIG. 33V, however, may all yield as the suggested product 220 the Summary product type 136. Indeed, for loan values 211 in excess of, for example, $1,500,000, the decision matrix 210 may suggest a self-contained appraisal report. Self-contained appraisal reports are known in the field, and contain all data needed for any individual to make an analysis of the subject property, and thus confirm the results arrived at in the self-contained report.

It may also be possible to add additional parameters to the decision matrix 200,210. In particular, it is possible to create the host system 120 so that the client 110 may select which parameters are to go into the decision matrix, and the triggering values or ranges of those parameters. Each parameter added would, in effect, insert a column into the decision matrix, thus increasing the number of rows. A user interface may be provided by the administration module 170 that permits the client 110 to select an input parameter for insertion into the decision matrix 200,210, for example in much the same way as parameters may be selected to perform a database query as shown in FIG. 10B. Of course, it is possible that some rows within a column may not have an explicitly defined value; that is, there may be some parameters for which only a subset of all possible values are of interest to the client 110. By way of example, those portions of a column that do not contain an explicit entry or range may, for example, be ignored when parsing the decision matrix.

By permitting the client 110 to augment and edit the decision matrix, and by providing queries of the portfolio database 160, the host system 120 permits the client 110 to exert macro-management control of the appraisal ordering process. For example, after performing a portfolio database query, the client 110 may determine that it has a significant amount of property in a particular zip code, and thus is potentially facing a great deal of exposure in that area. This would create a greater risk for loans in that area. Hence, the client 110 may elect to insert a zip code parameter into the decision matrix 220, and indicate that for certain values of the zip code the appraisal product output 220 should bump up to the next higher product 132-136. All subsequent orders would thus process in this manner, and those that request valuations of properties within that zip code would automatically be presented with a suggestion for a more detailed, and hence more conservative, valuation product 132-136. On the other hand, by permitting the client 110 to also decline a suggested product 220 for another product 131-136, the host system 120 permits the client to micromanage appraisals as well.

It will be appreciated that the host system 120 may be implemented by a suitable computer system, such as a server, running appropriate program code 121. As previously indicated, the NET framework may be used to implement the program code 121, although any other suitable programming language may be employed. When executed by one or more processors on the host system 120, the program code 121 will cause the hosts system 120 to perform the various steps discussed above. The program code 121 may be stored on any suitable computer-readable format and installed on computers, as known in the art. The program code 121 may be designed, for example, so that each client 110 perceives itself as being the only client 110 on the host system 120 interfacing with multiple valuation experts 150. Similarly, each valuation expert 150 may perceive himself or herself as the only such expert 150 on the host system 150 interfacing with a plurality of clients 110. This is but one possible design choice of many. Providing adequate security and compartmentalization between users, such as the valuation experts 150 and clients 110, is, however, a routine matter known in the field of such web interfaces.

It should be further appreciated that the various databases as disclosed are merely exemplary, and that all of the data disclosed herein may be partitioned into any number of databases, in any desired manner, as known in relational database programming. For example, various pieces of information as being disclosed as being within the appraiser database 140 may just as easily be stored in the portfolio database 160, and vice versa. The data partitions disclosed herein are merely those believed to be most easily understood in this context, but other variations are certainly possible.

Finally, it should be understood, as known in the field of web programming, that a server 120 as shown in FIG. 2 may, in fact, be implemented by a plurality of computing platforms. That is, a single logical server 120 may be implemented by a plurality of physical servers that are themselves networked together to provide the desired functionality. Hence, in the above, the host system 120 may be construed as either a single physical machine, or as a logical server comprised of multiple computing platforms.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for obtaining property valuations comprising: accepting order-related data from a client; utilizing the order-related data to generate an order, the order selecting at least a first product from a plurality of products having respective predefined report formats; submitting the order to the client; in response to the client accepting the order, assigning the order to at least one valuation expert; accepting valuation-related data from the valuation expert in accordance with a first report format corresponding to the first product to generate a first report; submitting the first report to the client; and storing data related to the first report in a portfolio database that is accessible to the client and searchable by the client.

2. The method of claim 1 wherein the first report format comprises a plurality of fields to hold data, the method further comprising: identifying at least one field of significance from the plurality of fields; comparing data in the at least one field of interest to at least one tolerance value; and setting a flag viewable by the client according to the comparison.

3. The method of claim 1 wherein each of the predefined report formats comprises a respective predefined scope of work field.

4. The method of claim 3 wherein each of the predefined report formats comprises an intended use field, and the method further comprises populating the intended use field in the first report format according to at least the order-related data.

5. The method of claim 1 further comprising: in response to the client declining the order, presenting the client with at least a portion of the other products; and accepting as the order a second product selected by the client.

6. The method of claim 5 wherein a scope of work field within the second product format is populated according to a predefined format for the second product, and an intended use field within the second product format is populated according to at least the order-related data.

7. The method of claim 1 further comprising accepting status information from the valuation expert and compiling a corresponding status log for the first report.

8. The method of claim 7 wherein the client comprises first users and second users, and the method further comprises: granting first users full read access to the status log; and denying second users read access to information in the status log that identifies the valuation expert.

9. The method of claim 1 further comprising: permitting the client to perform a database query of the portfolio database; permitting the client to modify decision-related data; and utilizing the order-related data and the decision-related data to generate the order.

10. A server for facilitating property valuations, the server capable of networked communications with a plurality of users and comprising program code adapted to perform the following steps: accepting order-related data from a client, the server comprising a plurality of products having respective predefined report formats; utilizing the order-related data and a decision matrix to generate an order, the order selecting at least a first product; submitting the order to the client; in response to the client accepting the order, assigning the order to at least one valuation expert from a database of valuation experts; providing the valuation expert a user interface to populate data into a plurality of fields within a first report format corresponding to the first product; accepting the data from the valuation expert in accordance with the first report format to generate a first report; submitting the first report to the client; and storing the data related to the first report in a portfolio database that is accessible to the client and searchable by the client.

11. The server of claim 10 wherein the program code further performs the following steps: identifying at least one field of significance from the plurality of fields; comparing data in the at least one field of interest to at least one tolerance value; and setting a flag viewable by the client according to the comparison.

12. The server of claim 11 wherein the program code further performs the following step: providing a user interface adapted to permit the client to change the at least one tolerance value.

13. The server of claim 10 wherein each of the predefined report formats comprises a respective predefined scope of work field.

14. The server of claim 13 wherein each of the predefined report formats comprises an intended use field, and the program code further performs the following step: populating the intended use field in the first report format according to at least the order-related data.

15. The server of claim 10 wherein the program code further performs the following steps: in response to the client declining the order, presenting the client with a user interface for selecting at least a portion of the other products; and accepting as the order a second product selected by the client.

16. The server claim 15 wherein the program code further comprises the step of populating a scope of work field within the second product format according to a predefined format for the second product, and populating an intended use field within the second product format according to at least the order-related data.

17. The server of claim 16 wherein the program code further comprises the step of providing a user interface to change the respective predefined formats for the scope of work fields of each product.

18. The server of claim 10 wherein the program code further comprises the step of accepting status information from the valuation expert for the order and storing the status information in a corresponding status log for the first report.

19. The server of claim 18 wherein the client comprises first users and second users, and the program code further comprises the following steps: granting first users full read access to the status log; and
denying second users read access to information in the status log that identifies the valuation expert.

20. The server of claim 10 wherein the program code further comprises the following steps: providing a user interface that enables the client to perform a database query of the portfolio database; and
providing a user interface that enables the client to modify the decision matrix.

21. The server of claim 10 wherein the program code further comprises the following steps: providing a user interface enabling the valuation expert to accept or decline the order; providing a user interface enabling the valuation expert to offer at least a reason for declining the order; and in response to the valuation expert declining the order, submitting the reasons for declining the order to the client.
